(19) United States
(12) Patent Application Publication
(10) Pub. No.: US 2016/0178439 A1
(43) Pub. Date: Jun. 23, 2016

(54) METHODS AND SYSTEMS FOR COHERENT RAMAN SCATTERING

(71) Applicant: INVENIO IMAGING INC., Menlo Park, CA (US)

(72) Inventors: Christian Wilhelm FREUDIGER, San Carlos, CA (US); Jay Kenneth TRAUTMAN, Los Altos, CA (US)

(21) Appl. No.: 14/899,533

(22) PCT Filed: Jun. 17, 2014
(86) PCT No.: PCT/US14/42812

§ 371 Date: Dec. 17, 2015

Related U.S. Application Data
(60) Provisional application No. 61/836,077, filed on Jun. 17, 2013.
(60) Provisional application No. 61/838,109, filed on Jun. 21, 2013.
(60) Provisional application No. 61/908,669, filed on Nov. 25, 2013.
(60) Provisional application No. 61/908,548, filed on Nov. 25, 2013.

(51) Int. Cl. G01J 3/44; G01J 3/02

(52) U.S. Cl. CPC G01J 3/4412; G01J 3/0218; G01J 3/0208

(57) ABSTRACT

Systems and methods employing Coherent Raman Scattering (CRS), e.g., Coherent anti-Stokes Raman Spectroscopy (CARS) and/or Stimulated Raman Scattering (SRS) are provided. Systems and methods for performing flow cytometry, imaging and sensing using low-resolution CRS are also provided.

### RELATED APPLICATIONS

This application claims the benefit of U.S. Provisional Application Nos. 61/836,077, filed Jun. 17, 2013, 61/838,109, filed Jun. 21, 2013, 61/908,548, filed Nov. 25, 2013, and 61/908,669, filed Nov. 25, 2013, which are herein incorporated by reference in their entirety.

### STATEMENT AS TO FEDERALLY SPONSORED RESEARCH

This invention was made with the support of the United States government under SBIR grant number IIP-1248414 from the National Science Foundation. The government may have rights in the invention.

### BACKGROUND OF THE INVENTION

The Raman process involves the scattering of an excitation photon by a molecule while exciting a molecular vibration. Each type of bond has a specific stiffness (e.g., C═C is stiffer than C—C) and associated mass (e.g., C—C is heavier than C—H) and thus a specific vibrational frequency. The dispersed Raman scattering spectrum is determined by the molecular vibrations of the sample and thus derived from the chemical composition. Raman scattering has provided various forms of spectroscopy, including coherent anti-Stokes Raman scattering (CARS).

Raman scattering can be highly specific and allows for single-cell measurements. However, the spontaneous Raman scattering signal is weak and long averaging times are required to obtain high signal-to-noise ratio (SNR) spectra. Current examples in biofuel research involve laser trapping a cell for 10 seconds to generate enough signal, thereby making current spontaneous Raman scattering systems for cell sorting impractical. Further, weak Raman signal can be overwhelmed by auto-fluorescence (e.g. from chlorophyll in plants).

Coherent Raman Scattering (CRS) including coherent anti-Stokes Raman scattering (CARS) and stimulated Raman scattering (SRS) allows amplification of the weak spontaneous Raman signal. SRS is excited under the same illumination conditions as CARS, but differs in the detection. CARS is similar to fluorescence in that emission is detected at a wavelength different from the wavelength of the excitation beams. SRS is similar to absorption in that the absorption of one of the excitation beams (e.g., stimulated Raman loss) is measured in the presence of the second beam. While highly sensitive, SRS detection can include extracting the relatively small signal from the laser background with a high-frequency phase-sensitive detection scheme (e.g., lock-in detection). SRS provides unique capability for chemical specificity as excitation spectra are identical to those of spontaneous Raman and phase-matching is automatic.

Despite current advances in CRS, there is a need for improved CARS and SRS systems and methods for biological and chemical analytical applications, such as flow cytometry, imaging and sensing. For example, there is a need for label-free based detection systems and methods capable of performing analysis with adequate time and signal resolution from detection volumes that are, e.g., commensurate with cells and larger biological particles, with an adequate field of view, and/or with an adequate form factor of the probe.

### SUMMARY OF THE INVENTION

The present invention provides systems and methods employing Coherent Raman Scattering (CRS) such as Coherent anti-Stokes Raman Spectroscopy (CARS)) and/or Stimulated Raman Scattering (SRS). For example, the present invention includes systems and methods for performing flow cytometry using CARS and/or SRS.

In a first aspect, the invention relates to a detection system and methods of use thereof, comprising: a fiber laser system configured to provide; a first train of pulses at a laser repetition rate R₁ and having a first center optical frequency ω₁ and an optical bandwidth of Δω₁; a second train of pulses at a laser repetition rate R₂ and having a second center optical frequency ω₂ and an optical bandwidth of Δω₂, wherein the second train of pulses is synchronized with the first train of pulses; and focusing optics configured to focus spectral elements from the first and the second trains of pulses toward at least one overlapping focal volume, wherein the at least one overlapping focal volume has at least two dimensions that are larger than 3 μm; and a detector system configured to detect a non-linear optical signal from the at least one overlapping focal volume.

In various aspects, the systems and methods of the invention include additional features. In some embodiments, laser duty factors for the first and the second train of pulses are larger than 10,000 and at least one of Δω₁ and Δω₂ is smaller than 50 cm⁻¹. In some embodiments, the non-linear optical signal comprises Coherent Raman Scattering (CRS), wherein the difference in frequency of a first spectral component within Δω₁ and a second spectral component within Δω₂ is resonant with a targeted vibrational frequency of a sample. In some embodiments, the CRS comprises Coherent anti-Stokes Scattering (CARS) and the detector system is further configured to detect radiation at the corresponding anti-Stokes wavelength. In some embodiments, the CRS comprises Stimulated Raman Scattering (SRS) and the detector system is further configured to detect an intensity gain or loss at a wavelength within Δω₁ or Δω₂. In some embodiments, the CRS comprises Raman Induced Kerr Effect (RIKE) and the detector system is further configured to detect a polarization rotation at a wavelength within Δω₁ or Δω₂. In some embodiments, Δω₁ and Δω₂ are smaller than 50 cm⁻¹. In some embodiments, at least one of ω₁ and ω₂ is tunable. In some embodiments, Δω₁ is smaller than 50 cm⁻¹ and Δω₂ is larger than 50 cm⁻¹. In some embodiments, the detector system comprises a detector array that is configured to detect signals from a plurality of vibration frequencies in the at least one overlapping focal volume. In some embodiments, the ratio of the duration of pulses in the first and the second train of pulses is between 1-3. In some embodiments, the second train of pulses is synchronized with the first train of pulses using optical synchronization, electronic feedback or feed forward synchronization. In some embodiments, the first or the second trains of pulses is frequency shifted using a broadband supercontinuum (SC). In some embodiments, the first or second train of pulses is amplified in a gain medium. In some embodiments, the gain medium comprises an Erbium (Er)-, Ytterbium (Yb)-, Thulium (Tm)-, Holmium (Ho)-, or Neodymium (Nd)-doped medium. In some embodiments, systems or methods of the invention further comprise an undoped fiber in a laser cavity of the laser fiber optics system such that the laser repetition rate of the laser cavity is reduced. In some embodiments, the system is configured to broaden the first or the second train of pulses using self-phase modulation (SPM). In some embodiments, systems and methods of the invention further comprise a flow system configured to generate a stream of particles through the at least one overlapping focal volume. In some embodiments, the particles comprise cells. In some embodiments, methods and systems of the invention comprise a high-speed signal processor that is capable of performing spectral analysis. In some embodiments, methods and systems of the invention comprise a sorting device that is configured to sort a particle with the stream of particles according to an output from the high-speed signal processor. In some embodiments, the dimension of the at least one overlapping focal volume along the direction of the stream of particles is less than the dimensions that are perpendicular to the direction of the stream of particles. In some embodiments, the detection system further comprises a scanner that is configured to spatially scan the at least one overlapping focal volume over a field of view larger than 500 μm. In some embodiments, the focusing optics comprise a fiber-optic probe. In some embodiments, methods and systems of the invention comprise at least one of a ball-lens, a GRIN lens, or a micro-optic lens that is configured to focus a beam comprising the first or second train of pulses toward the at least one overlapping focal volume. In some embodiments, the fiber-optic probe further comprises a section of core-less or multi-mode fiber that is configured to expand the beam comprising the first or second trains of pulses before the at least one of a ball-lens, GRIN lens or micro-optic lens. In some embodiments, the fiber-optic probe further comprises a dual-clad fiber that is configured to deliver the first or the second trains of pulses through a fiber core and wherein the fiber-optic probe is configured to couple the non-linear optical signal into an inner cladding for delivery to the detector. In some embodiments, the fiber-optic probe further comprises a section of core-less or multi-mode fiber for expanding the beam comprising the first or second trains of pulses before the at least one of a ball-lens, GRIN lens or micro-optic lens, and wherein the section of multi-mode fiber couples to the inner cladding of the dual-clad fiber. In some embodiments, methods and systems of the invention further comprise a color filter in the fiber-optic probe, wherein the color filter is configured to reduce a background signal from the delivery fiber.

In a second aspect, the invention relates to a method for spectral calibration and systems that are capable to perform the same, comprising: (i) delivering at a first time point a fiber laser generated beam comprising a broadband train of pulses and at least a second train of pulses through a material with a known response to Coherent Raman Spectroscopy (CRS), wherein the broadband train of pulses and the second train of pulses are focused toward at least one overlapping focal volume; (ii) detecting a CRS signal from the material; (iii) delivering at a second time point the fiber laser generated beam comprising the broadband train of pulses through a sample; (iv) detecting a CRS signal from the sample; and (v) manipulating the detected CRS signal from the sample according to the detected CRS signal from the material. In some embodiments the bandwidth of the broadband train of pulses is at least 5 nm. In some embodiments, the material with the known response to CRS is illuminated by shifting the location of the at least one overlapping focal volume thereon. In some embodiments, the material with the known response to CRS comprises the fluid of a flow cell. In some embodiments, the known response to CRS comprises an undetectable CRS signal in a predetermined spectral region. In some embodiments, the known response to CRS comprises a non-resonant response. In some embodiments, the non-resonant signal comprises non-resonant background in Coherent Anti-Stokes Raman Spectroscopy (CARS), or cross-phase modulation, or photo thermal signal in Stimulated Raman Spectroscopy (SRS). In some embodiments, the non-resonant signal is generated by closing an aperture in the detection path of the non-resonant response. In some embodiments, the first and second time points are less than 24 hours. In some embodiments, the material with the known CRS response and the sample flow through the at least one overlapping focal volume. In some embodiments, the sample comprises cells in a stream.

In a third aspect, the invention relates to a detection system and methods of use thereof, comprising: a fiber laser optics system comprising; a first light source for providing a first train of pulses with a first center optical frequency and a first optical bandwidth; a second light source for providing a second train of pulses with a second center optical frequency and a second optical bandwidth, wherein the second train of pulses is synchronized with the first train of pulses and wherein the difference in frequency of a first spectral component within the bandwidth of the first train of pulses and a second spectral component within the bandwidth of the second train of pulses is resonant with a targeted vibrational frequency of a sample; and focusing optics configured to focus spectral elements from the first and the second trains of pulses toward at least one overlapping focal volume, wherein the at least one overlapping focal volume comprises at least two dimensions that are larger than 3 μm; and a detector system configured to acquire a coherent Raman scattering (CRS) signal generated in the at least one overlapping focal volume, at a rate of at least 100 per sec.

In a fourth aspect, the invention relates to a detection system and methods of use thereof, comprising: a fiber laser optics system comprising; a first light source for providing a first train of pulses with a first center optical frequency and a first optical bandwidth; a second light source for providing a second train of pulses with a second center optical frequency and a second optical bandwidth, wherein the second train of pulses is synchronized with the first train of pulses; and focusing optics configured to focus spectral elements from the first and the second trains of pulses toward at least one overlapping focal volume on the stream of cells; and a detector system configured to detect a coherent Raman scattering signal from the at least one overlapping focal volume; wherein the difference in frequency of a first spectral component within the bandwidth of the first train of pulses and a second spectral component within the bandwidth of the second train of pulses is resonant with a targeted vibrational frequency of a sample, wherein the maximum output power of the first or second train of pulses is at least 20 mW, and wherein the first and second train of pulses have a repetition rate of less than 20 MHz.

In various aspects, the methods and systems of the invention include additional features. In some embodiments, the targeted vibrational frequency falls within a Raman shift range selected from the list in Table 1. In some embodiments, the methods and systems of the invention comprise a flow cytometer that is configured to generate a stream of cells through the at least one overlapping focal volume. In some embodiments, the first and second trains of pulses are spatially overlapped. In some embodiments, the FWHM of the first train of pulses is at least 2 ps. In some embodiments, the FWHM of the second train of pulses is at least 5 ps. In some embodiments, the axial resolution of the first or second trains of pulses is at least 50 um. In some embodiments, the first train of pulses and the second train of pulses are synchronized with a timing jitter of less than 50 fs. In some embodiments, the time-bandwidth product of the first or second train of pulses is less than 3 times the transform limit. In some embodiments, the bandwidth of the first train of pulses is at least 10 times the bandwidth of the second train of pulses. In some embodiments, the bandwidth of the first train of pulses is at least 20 nm. In some embodiments, the bandwidth of the second train of pulses is less than 1 nm. In some embodiments, the first train of pulses is centered at about 1555 nm. In some embodiments, the second train of pulses is centered at about 1062 nm. In some embodiments, the pulses in the first train of pulses are about 3 times shorter than the pulses in the second train of pulses. In some embodiments, the detector system has shot-noise limited detection sensitivity. In some embodiments, the detector system comprises a photomultiplier tube array or a lock-in amplifier in combination with a photodiode array. In some embodiments, the focusing optics comprise a low numerical aperture (NA) focusing element that has an NA equal to or less than 0.3. In some embodiments, the detection system is capable of resolving dodecane and propanol signals through a flow cell of 110 um or less, at an integration time of 10 us or less. In some embodiments, the detection system is capable of resolving CRS signals from a pair of samples through a flow cell of 14 um or less, at an integration time of 100 us or less, wherein the pair of samples comprises water and chloroform or methanol and propanol. In some embodiments, the detection system is capable of resolving CRS signals from a pair of samples through a flow cell of 110 um or less, at an integration time of 100 us or less, wherein the pair of samples comprises water and propanol or benzene and propanol. In some embodiments, the system is capable of resolving CRS signals from a pair of samples through a flow cell of 110 um or less, at an integration time of 1 us or less, wherein the pair of samples comprises water and propanol, benzene and chloroform or benzene and propanol. In some embodiments, the focusing optics comprise a cylindrical telescope.

In a fifth aspect, the invention relates to a method of detection and systems that are capable of performing the same, comprising: (a) focusing spectral elements from a first train of pulses with a first center optical frequency and a first optical bandwidth and a second train of pulses with a second center optical frequency and a second optical bandwidth toward at least one overlapping focal volume; and (b) detecting a coherent Raman scattering signal from the focal volume with a detector system; wherein the first and second trains of pulses are generated in a fiber laser optics system, wherein the maximum output power of the first or second train of pulses is at least 20 mW, and wherein the first and second train of pulses have a repetition rate of less than 20 MHz.

In a sixth aspect, the invention relates to a method of cell sorting and systems that are capable of performing the same, comprising, (a) directing cells down a stream at a rate of at least 100 cells per second; (b) focusing toward a focal volume on the stream at least one beam of light comprising a first train of pulses with a first center optical frequency and a first optical bandwidth and a second train of pulses with a second center optical frequency and a second optical bandwidth such that the first and second trains of pulses overlap in the focal volume; (c) detecting a coherent Raman spectrum from a cell in the stream with a detector system; and (d) applying a force on the cell based on the coherent Raman spectrum; wherein the focal volume comprises at least two dimensions that are larger than 3 um, wherein the pulses in the first and second trains are generated in a fiber laser optics system, and wherein the pulses in the first and second trains are synchronized.

In various aspects the methods and systems of the invention comprise additional features. In some embodiments, the methods of the invention comprise passing a stream of particles through the overlapping focal volume. In some embodiments, the difference in frequency of a first spectral component within the bandwidth of the first train of pulses and a second spectral component within the bandwidth of the second train of pulses is resonant with a targeted vibrational frequency that falls within a Raman shift range selected from the list in Table 1. In some embodiments, the detecting is done at an acquisition rate of at least 100 spectra per second. In some embodiments, the first and second trains of pulses are spatially overlapped. In some embodiments, the detecting results in a signal to noise ratio (SNR) of at least 5. In some embodiments, the FWHM of the first train of pulses is at least 2 ps. In some embodiments, the FWHM of the second train of pulses is at least 5 ps. In some embodiments, the axial resolution of the first or second trains of pulses is at least 50 um. In some embodiments, the first train of pulses and the second train of pulses are synchronized with a timing jitter of less than 50 fs. In some embodiments, the time-bandwidth product of the first or second train of pulses is less than 3 times the transform limit. In some embodiments, the bandwidth of the first train of pulses is at least 10 times the bandwidth of the second train of pulses. In some embodiments, the bandwidth of the first train of pulses is at least 20 nm. In some embodiments, the bandwidth of the second train of pulses is less than 1 nm. In some embodiments, the first train of pulses spans about 1525-1585 nm. In some embodiments, the second train of pulses is centered at about 1062 nm. In some embodiments, the pulses in the first train of pulses are about 3 times shorter than the pulses in the second train of pulses. In some embodiments, the detector system has shot-noise limited detection sensitivity. In some embodiments, the detector system comprises a photomultiplier tube array or a lock-in amplifier in combination with a photodiode array. In some embodiments, the focusing optics comprise a low numerical aperture (NA) focusing element that has an NA equal to or less than 0.3. In some embodiments, the method is capable of resolving dodecane and propanol signals through a flow cell of 110 um or less, at an integration time of 10 us or less. In some embodiments, the method is capable of resolving CRS signals from a pair of samples through a flow cell of 14 um or less, at an integration time of 100 us or less, wherein the pair of samples comprises water and chloroform or methanol and propanol. In some embodiments, the method is capable of resolving CRS signals from a pair of samples through a flow cell of 110 um or less, at an integration time of 100 us or less, wherein the pair of samples comprises water and propanol or benzene and propanol. In some embodiments, the method is capable of resolving CRS signals from a pair of samples through a flow cell of 110 um or less, at an integration time of 1 us or less, wherein the pair of samples comprises water and propanol, benzene and chloroform or benzene and propanol.

In a seventh aspect, the invention relates to a flow cytometry system employing coherent Raman scattering (CRS) and methods of use thereof, the system comprising: a first light source for providing a first train of pulses at a laser repetition rate R₁ and having a first center optical frequency ω₁ and an optical bandwidth of Δω₁; a second light source for providing a second train of pulses at a laser repetition rate R₂ and having a second center optical frequency ω₂ and an optical bandwidth of Δω₂, wherein the second train of pulses is synchronized with the first train of pulses and a difference in frequency of at least one pair of spectral components within Δω₁ and Δω₂ is resonant with a targeted vibrational frequency of a sample; focusing optics for directing and focusing the first train of pulses and the second train of pulses toward a common focal volume which has at least two dimensions that are larger than 5 μm; and a detector system for detecting a coherent Raman scattering signal generated in the common focal volume.

In various aspects systems and methods of use thereof comprise additional features. In some embodiments, the system is configured to generate the common focal volume with a low numerical aperture (NA) focusing element that has an NA equal to or less than about 0.2. In some embodiments, the system is configured to generate the common focal volume with a high numerical aperture (NA) focusing element having an NA of greater than 0.4 by under filling a back aperture of the high NA focusing element lens in at least one direction by a factor of at least two times. In some embodiments, R₁ and R₂ are in the frequency range from 200 kHz to 10 MHz. In some embodiments, the first laser pulse train, the second laser pulse train, or both is derived from a fiber oscillator in which the laser repetition rate is lowered into the desired range by splicing an un-doped fiber into a laser cavity of the system. In some embodiments, the system comprises different types of un-doped fibers to control dispersion. In some embodiments, the system is configured to employ coherent anti-Stokes Raman scattering (CARS) as a contrast mechanism and the detector system is configured to detect signal from at least one anti-Stokes frequency. In some embodiments, the system is configured to employ stimulated Raman scattering (SRS) as a contrast mechanism and the detector system is configured to detect signal intensity gain or loss of an optical component of at least one of the first and second laser pulse trains. In some embodiments, wherein the system is configured to employ narrowband CRS and at least of one Δω₁ and Δω₂ is less than 1 nm, 2 nm, or 5 nm. In some embodiments, the system is configured to employ multiplex CRS and at least one of Δω₁ or Δω₂ is greater than 5 nm, 10 nm, 20 nm, 30 nm, 40 nm, or 50 nm. In some embodiments, all spectral components of the second laser pulse train are focused into one focal spot and the detector system comprises a multi-element detector and a dispersion system, wherein the second laser pulse train is broadband. In some embodiments, different spectral components of the second laser pulse train are focused into a plurality of focal spots located along a direction of flow in the flow cytometer system, and the detector system comprises a single-element high-speed detector to temporally resolve a spectral response from the plurality of focal spots along the direction of flow, wherein the second laser pulse train is broadband. In some embodiments, at least the first or second pulse train is generated in a laser comprising a gain media comprising Erbium (Er), Ytterbium (Yb), Thulium (Tm)-, Thalium (Th), Holmium (Ho), Neodymium (Nd)-, or titanium sapphire (Ti:Sa), or by harmonic generation thereof. In some embodiments, the system is configured to generate the second laser pulse train by self phase modulation (SPM) in an optical fiber, wherein the second laser pulse train is broadband. In some embodiments, the system is configured to synchronize the first train of pulses and the second train of pulses using optical synchronization using a broadband super-continuum, electronic synchronization using feed-back, or electronic synchronization using feed-forward.

In an eight aspect, the invention relates to a method for calibrating a broadband CRS cytometry system and systems configured to perform the method, the method comprising using a signal acquired from a material with a known CRS spectral response. In some embodiments, the signal is generated from a material of the flow cell by shifting the common focal volume into the flow cell. In some embodiments, the method is repeated on scheduled time intervals during use of the broadband CRS cytometry system. In some embodiments, the signal is generated from the fluid of the flow system. In some embodiments, a fluid used for a flow system in the CRS cytometry system provides undetectable Raman contribution in a predetermined spectral region. In some embodiments, the calibration is performed where the sample is known to be in a common volume of the system. In some embodiments, the signal is a non-resonant response. In some embodiments, the non-resonant response comprises non-resonant background in CARS or cross-phase modulation or a photo thermal signal in SRS. In some embodiments, the non-resonant signal is generated by closing an aperture in the detection path.

In a ninth aspect, the invention relates to a low-resolution imaging system employing coherent Raman scattering (CRS) as a contrast mechanism and methods of use thereof, the system comprising: a first light source for providing a first train of pulses at a laser repetition rate R₁ and having a first center optical frequency ω₁ and optical bandwidth of Δω₁; a second light source for providing a second train of pulses at a laser repetition rate R₂ and having a second center optical frequency ω₂ and optical bandwidth of Δω₂, wherein the second train of pulses is synchronized with the first train of pulses and the difference frequency of at least one pair of spectral components within Δω₁ and Δω₂ is resonant with a targeted vibrational frequency of a sample; focusing optics for directing and focusing the first train of pulses and the second train of pulses toward at least one common focal volume which has at least two dimensions that are larger than 5 μm; and a beam-scanning system for scanning the input angle of the collinear first and second pulse trains at the focusing optic; and a detector system for detecting a coherent Raman scattering signal generated in the common focal volume.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

A better understanding of the features and advantages of the present invention will be obtained by reference to the following detailed description that sets forth illustrative embodiments, in which the principles of the invention are utilized, and the accompanying drawings of which:

FIG. 1 illustrates an example flow cytometer system and method, in accordance with an embodiment of the present invention.

FIGS. 2A-D relate to a system for Multiplex CRS flow cytometry. FIG. 2A shows a schematic of the all-fiber laser system based on optical synchronization of a broadband erbium (Er) laser and narrowband ytterbium (Yb) laser. Collinear laser beams can be focused into a flow cell with a low-numerical aperture (NA) objective lens and emission detected with a multi-channel spectral detector. The repetition rate of the oscillator can be reduced to maintain peak power density while scaling to low-NA and a custom multi-channel lock-in amplifier can be used to perform multiplexed CRS. FIGS. 2B-2D show that a narrowband CRS laser system can be optimized for high-resolution microscopy. FIGS. 2B and 2C show the tuning range over the entire high-wavenumber region of Raman spectra. The narrowband filter in the Er arm is an embodiment. A preferred embodiment has a multi-stage amplifier to control the output bandwidth via self-phase modulation (SPM) broadening. FIG. 2D shows a CRS image of 1 μm polystyrene beads acquired at 1 frame/second with 512×512 sampling with the fiber-laser system. Inset shows that the SNR is about 25.

FIG. 3 shows example Raman spectra of polystyrene, melamine and polymethylmethacrylate (PMMA) beads.

FIGS. 4A-D show different excitation geometries for CRS. FIG. 4A depicts high-NA excitation that can provide sufficient peak power for CRS but it probes a small portion of the sample. FIG. 4B shows low-NA excitation that can permit sampling the entire specimen evenly, but which can result in decreased signal due to the long focal z-extension, lower peak power and phase-mismatch. FIG. 4C shows excitation with a mixed-NA beam profile (e.g., high-NA in the y-axis and low-NA in the x-axis), such that the entire sample can be probed evenly but the z-extension is contracted so as to be commensurate in extent with a dimension of the sample, and the peak power is increased. FIG. 4D shows that mixed-NA excitation can also be used for temporal multiplexing of the spectral information by focusing different color Stokes beams into different areas along the direction of the flow.

FIGS. 5A-C depict potential approximations of focal spot-sizes for different excitation geometries. FIG. 5A shows a high-NA lens, FIG. 5B shows a low-NA lens, and FIG. 5C shows different NAs on different axes.

FIG. 6 shows example laser excitation spectra for multiplex CRS. Spectral resolution can be determined by the bandwidth of the narrowband pump spectrum. Spectral coverage can be determined by the width of the Stokes spectrum.

FIGS. 7A-C illustrates example methods and system for spectral calibration of a system of the present invention. The spectral output in FIG. 7A of the material of the flow cell or in FIG. 7B of the fluid used for sample loading can be measured. It may be desirable to introduce an aperture in the detection path to create a cross-phase modulation signal for SRS (FIG. 7C).

FIG. 8 shows that the CARS emission spectrum of glass (non-resonant background) reproduces the spectral shape of the broadband excitation spectrum and can be used for spectral calibration.

FIG. 9 provides an example of real-time monitoring of the broadband spectrum by recording the unmodulated direct current (DC) signal.

FIGS. 10A-C provide schematic illustrations of the spontaneous and coherent Raman scattering processes. FIG. 10A illustrates spontaneous Raman scattering. FIG. 10B illustrates coherent Raman scattering. FIG. 10C illustrates narrowband excitation and multiplex excitation modes of Raman scattering.

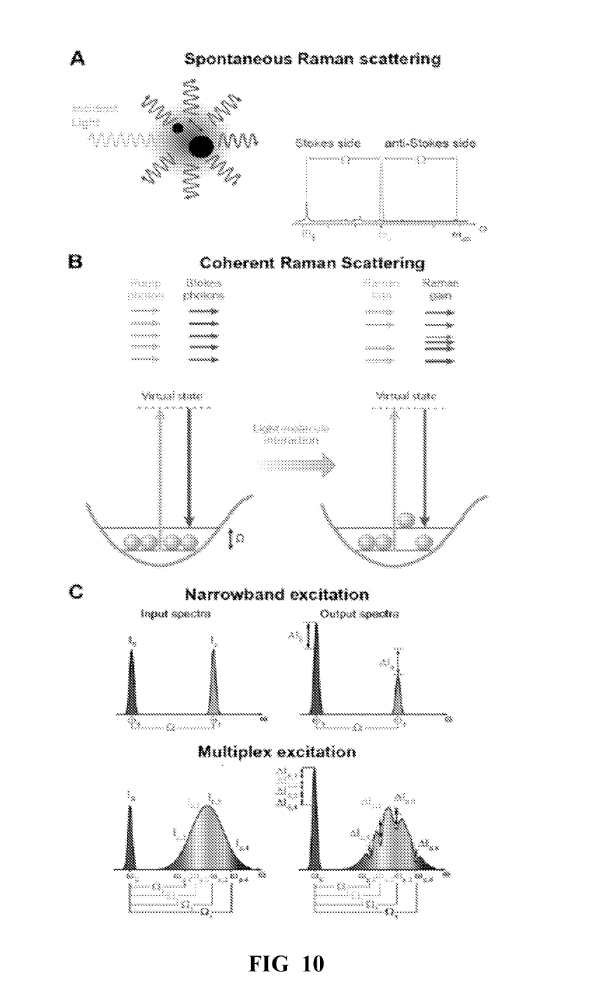

FIG. 11 provides a schematic illustration of the CRS flow-cytometer for high-speed chemical cell-sorting.

FIGS. 12 A-C describe the implementation and characterization of the Er-doped oscillator. FIG. 12A shows a detailed schematic of the oscillator. FIG. 12B shows the RF spectrum of the laser output. FIG. 12C shows the optical spectrum of the oscillator output.

FIGS. 13A-B provide a schematic illustration and characterization data for the Er-doped amplifier for the broadband Stokes beam.

FIGS. 14A-D describe the implementation and characterization of the super-continuum unit (SC) and narrowband Yb-doped amplifier for the pump beam. FIG. 14A shows a schematic of the implementation of the super-continuum unit (SC) and narrowband Yb-doped amplifier. FIG. 14B shows the broadband spectrum of the SC (blue curve) and amplified SC (red curve). FIG. 14C shows the tuning range after the Yb-doped pre-amplifier acquired with a narrowband tunable filter. FIG. 14D shows the amplified output at 1062 nm and 50 mW average power.

FIGS. 15A-C illustrate characterization of the laser system pulse parameters. FIG. 15A demonstrates autocorrelation of the narrowband pump pulses with a FWHM of 11.4 ps (corresponding to a 8.1 ps pulse duration). FIG. 15B demonstrates autocorrelation of the broadband Stokes pulses with a FWHM of 3.4 ps (corresponding to a 2.4 ps pulse duration). FIG. 15C shows the intensity noise at the peak (blue) and half max (red) of the cross-correlation averaged to 100 S/s. (Inset) Cross-correlation of the pump and Stokes pulses.

FIGS. 16A-E shows a schematic illustration and characterization of the detection system. FIG. 16A depicts the detection system based on a 32-channel gated integrator. Different front-ends are connected for CARS (32-channel PMT array) and SRS (16-channel PD array with custom lock-in array). FIG. 16B shows a photograph of the lock-in array. FIG. 16C shows a schematic of a single channel of the lock-in array. FIG. 16D shows electrical characterization data demonstrating linearity of the lock-in amplifier over a large signal range. FIG. 16E shows characterization data for the demodulation bandwidth for 10 μs integration.

FIGS. 17A-C show characterization data for detection sensitivity. FIG. 17A shows the average CARS spectrum of a 10 μm PMMA bead. The error bars are the standard deviation over 1,000 spectra at 10 μs integration time (effective data acquisition rate=100,000 spectra/s). FIG. 17B shows noise data as a function of signal demonstrating the square-root dependence typical for shot-noise limited performance. FIG. 17C shows scaling of the signal and noise of a single detection channel that are also consistent with shot-noise limited performance.

FIGS. 18A-E show characterization data for chemical specificity. FIG. 18A to C show phasor-plots of CARS spectra acquired at 1 μs, 10 μs, and 100 μs integration time, respectively. Different chemical species were exchanged through an 110 μm thick flow cell. FIG. 18D shows a normalized CARS spectra acquired with 10 μs integration time. FIG. 18E shows a phasor plot of CARS spectra acquired in a 14 μm thick flow cell with 100 μs integration time (effective sampling rate of 10,000 spectra/s).

FIG. 19 illustrates a computer system that may be configured to control the operation of the systems disclosed herein.

FIG. 20 is a block diagram illustrating a first example architecture of a computer system that can be used in connection with example embodiments of the present invention.

FIG. 21 is a diagram showing one embodiment of a network with a plurality of computer systems, a plurality of cell phones and personal data assistants, and Network Attached Storage (NAS).

FIG. 22 is a block diagram of a multiprocessor computer system using a shared virtual address memory space in accordance with an example embodiment.

FIG. 23 is a schematic illustration of a low-resolution CRS imaging system according to various embodiments of the invention.

FIG. 24 is a demonstration of large field-of-view CRS imaging.

FIG. 25 is schematic of an all-fiber laser and detection system for high-speed CRS spectroscopy through a miniature fiber-optic probe according to various embodiments of the invention.

FIG. 26 shows a detailed example for the design of a miniaturized CRS needle probe.

FIG. 27 shows an exemplary workflow for biopsy guidance using a miniature fiber-optic CRS probe.

FIG. 28 shows an example CRS microscopy system.

FIG. 29 shows a schematic of an example of a dual-wavelength all-fiber laser source for CRS.

FIG. 30 shows example CARS spectroscopic imaging.

### DETAILED DESCRIPTION OF THE INVENTION

In various embodiments, the methods and systems of the invention relate to the use of coherent Raman scattering on biological detection and imaging. Accordingly, methods and systems described herein may be used in flow-cytometry, microscopy, and sensing applications. Additional imaging and detection applications requiring speed and high sensitivity are within the bounds of the invention. Various embodiments relate to label-free detection and imaging applications. In some embodiments, the invention relates to a flow-cytometry system for chemical phenotyping of cells. Specific embodiments allow quantitative analysis of the molecular species within a cell, have single cell sensitivity, comprise high-throughput analysis, and/or non-destructive to living organisms. In another embodiment, the invention relates to large-area imaging, e.g. for diagnostic or treatment purposes. In yet another embodiment, the invention relates to a fiber-optic probe for high-speed chemical sensing, e.g. to guide a biopsy toward diagnostic tissue areas.

The present invention provides systems and methods employing Coherent Raman Spectroscopy (CRS), e.g., Coherent anti-Stokes Raman Spectroscopy (CARS) and/or Stimulated Raman Scattering (SRS) and/or Raman Induced Kerr Effect (RIKE). For example, the present invention includes systems and methods for performing flow cytometry, large-area imaging, and/or fiber-sensing (e.g., CARS, SRS, and/or RIKE). Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range to the tenth of the unit of the lower limit unless the context clearly dictates otherwise. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual values within that range, for example, 1.1, 2, 2.3, 5, and 5.9. This applies regardless of the breadth of the range. The upper and lower limits of these intervening ranges may independently be included in the smaller ranges, and are also encompassed within the invention, subject to any specifically excluded limit in the stated range. Where the stated range includes one or both of the limits, ranges excluding either or both of those included limits are also included in the invention, unless the context clearly dictates otherwise.

The terms “particles” and “cells,” are used interchangeably and as used herein, encompass samples that are typically of similar sizes to individual cells, including but not limited to vesicles (such as liposomes), cells, virions, and substances bound to small particles such as beads, nanoparticles, or microspheres. Characteristics include, but are not limited to, size; shape; temporal and dynamic changes such as cell movement or multiplication; granularity; whether the cell membrane is intact; internal cell contents, including but not limited to, protein content, protein modifications, nucleic acid content, nucleic acid modifications, organelle content, nucleus structure, nucleus content, internal cell structure, contents of internal vesicles, ion concentrations, and presence of other small molecules such as steroids or drugs; and cell surface (both cellular membrane and cell wall) markers including proteins, lipids, carbohydrates, and modifications thereof.

The methods and systems of the present invention can be used for a variety of applications, such as flow cytometry. Applying CRS for flow cytometry can provide identification and/or quantification of samples using a non-destructive spectroscopic technique. CRS provides, e.g., non-destructive chemical analysis of the sample based on measurements of the vibrations of the chemical bonds. Accordingly, Raman scattering allows for detection of lipids, protein, sugars, and DNA inside a single living cell, analysis of the concentration of lipids, protein, sugars and DNA inside a single living cell, and determination of the degree of unsaturation and transition temperatures of lipids. These markers are important, e.g., for determining engine compatibility and performance metrics of algal biodiesel. For example, general lipid content can be measured using CRS based on the signal from the CH₂ vibration at about 2845 cm⁻¹. Protein and DNA content can be measured from the CH₃ vibrations at about 2945 cm⁻¹ and 2960 cm⁻¹, respectively. For screening applications it is preferable to measure the lipid-to-protein ratio to exclude size effects. Content of unsaturated lipids can be measured specifically based on the CH vibration at about 3015 cm⁻¹, and the ratio of CH-to-CH₂ vibrations can used to measure the degree of saturation. Aromatic compounds can be determined based on the aromatic CH vibration at about 3060 cm⁻¹. More specific spectroscopic analysis of vibrational fingerprints allows determination of the thermal state of lipids (e.g. liquid vs. gel-phase), degree of esterification and identification of specific chemical species (e.g., cholesterol and omega-3 fatty acids) Additional examples of measured or estimated values of Raman shifts for various structural groups are listed in Table 1.

TABLE 1
Examples of Raman Shifts Data for Different Chemical Groups

| Approximate | |
|---|---|
| Wavenumber Range | Group |
| 1610-1740 | Carboxylic acid |
| 1625-1680 | C═C |
| 1630-1665 | C═N |
| 1710-1725 | Aldehyde |
| 1710-1745 | Ester |
| 1730-1750 | Aliphatic ester |
| 2530-2610 | Thiol |
| 2680-2740 | Aldehyde |
| 2750-2800 | N—CH3 |
| 2770-2830 | CH2 |
| 2780-2830 | Aldehyde |
| 2790-2850 | O—CH3 |
| 2810-2960 | C—CH3 |
| 2870-3100 | Aromatic C—H |
| 2880-3530 | OH |
| 2900-2940 | CH2 |
| 2980-3020 | CH═CH |
| 3010-3080 | ═CH2 |
| 3150-3480 | Amide |
| 3150-3480 | Amine |
| 3200-3400 | Phenol |
| 3210-3250 | Alcohol |
| 3250-3300 | Alkyne |

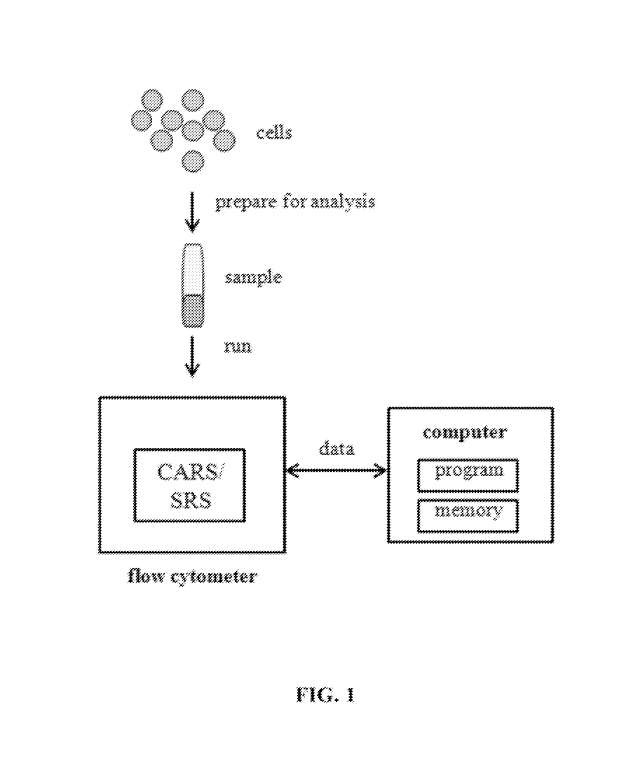

In one aspect, the present invention provides a flow-cytometer based on coherent Raman scattering. The flow cytometer systems of the present invention can be used to analyze a variety of samples and can be integrated with a computer system or micro-processor for analysis of the samples. As shown, e.g., in FIG. 1, the present invention can include methods for using the flow cytometry system to, e.g., analyze cells. A wide variety of other applications are described further herein. To prepare cells for analysis using the methods and systems described herein, cells can be prepared in a single cell suspension. For adherent cells, both mechanical or enzymatic digestion and an appropriate buffer can be used to remove cells from a surface to which they are adhered. Cells and buffer can then be pooled into a sample collection tube. For cells grown in suspension, cells and medium can be pooled into a sample collection tube. Adherent and suspension cells can be washed by centrifugation in a suitable buffer. The cell pellet can be re-suspended in an appropriate volume of suitable buffer and passed through a cell strainer to ensure a suspension of single cells in suitable buffer. The sample can then be vortexed prior to performing a method using the flow cytometry system on the prepared sample.

For analysis, the flow cytometry system can be configured to conduct CARS and/or SRS as described further herein. In some aspects, the system can include a multichannel detection system for multiplex CARS and/or SRS. The components for multiplex CARS and/or SRS are described in the specification and can be partially contained within a housing of the system. A computer with readable and executable memory and a program with a user-interactive interface can be connected to the flow cytometer. The computer may be enabled by the program and the memory to control some or all components of the CARS and/or SRS flow cytometer to perform a desired method. The program can also be used to direct the computer to control the CARS and/or SRS flow cytometer to acquire the data of the desired method. The program can be further used to perform analysis of the data and output the data analysis.

In some embodiments, Raman-induced Kerr effect (RIKE) is utilized for detection using the methods and systems described herein. In RIKE, the polarization of at least a portion of a spectrum of the first train of pulses is rotated by the sample in response to the second train of pulses if the difference frequency matches a Raman-active vibration. It can be detected by placing cross-polarizers in front of the detector system, e.g. in response to the first train of pulses. The transmission can be zeroed when no sample is present. Such a filter can help reduce the strength of the local oscillator compared to SRS and improve detection sensitivity. Linear birefringence can, however, be a limitation for employing the contrast to heterogeneous samples. A related technique is optical-heterodyne (OHD) RIKE, in which a portion of the first train of pulses is adjusted to leak through the polarizers such that it serves as a local oscillator and boosts the signal over the electronic noise floor of the detectors. By adjusting the optical phase of the leak-through, different temporal portions of the Raman response can be probes. Such OHD is typically combined with a high-frequency detection scheme also used in SRS.

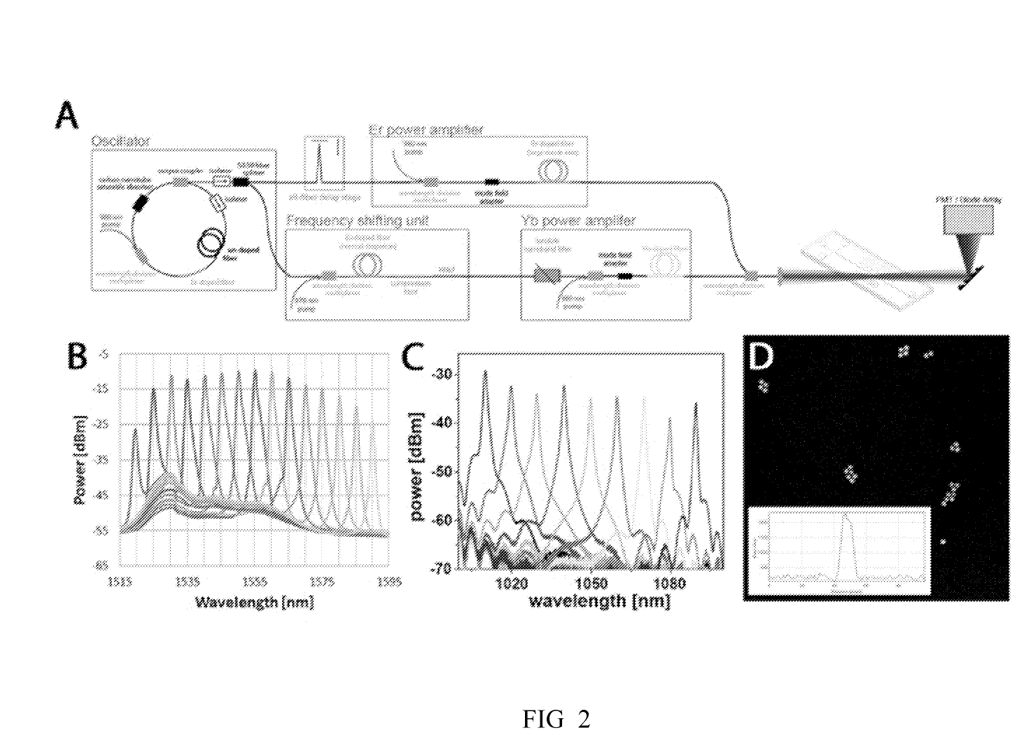

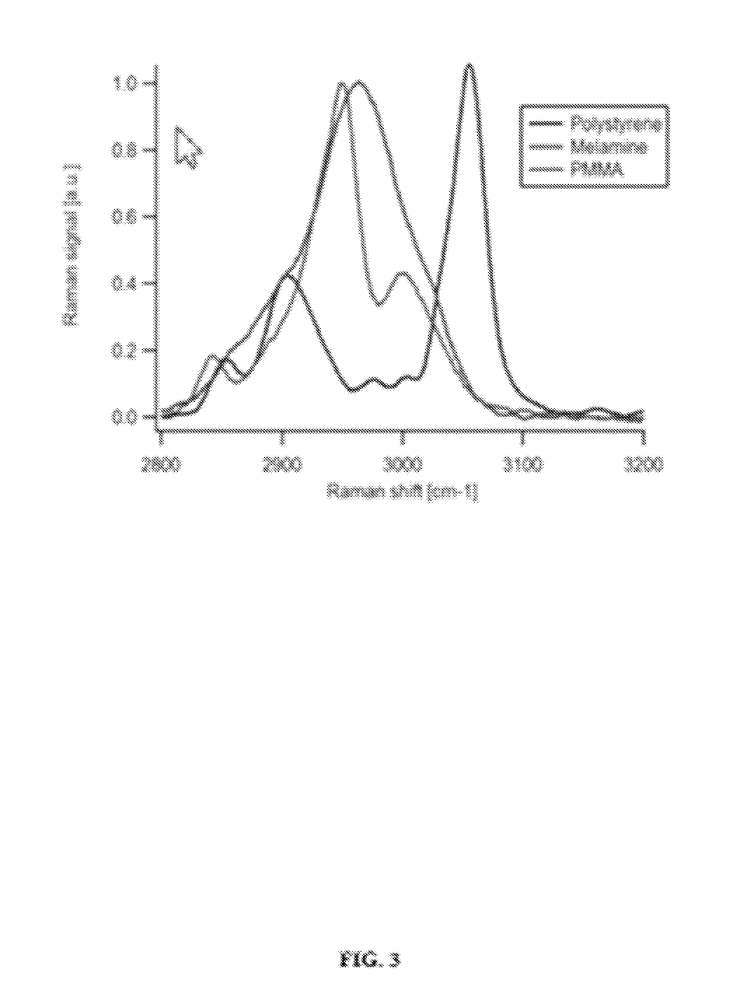

In some aspects, the CRS flow-cytometer systems of the present invention (e.g., in FIG. 2A) can have, e.g., three components: (1) a laser illumination system, (2) a flow system, and (3) a detection system. FIG. 2 provides an example of a laser illumination system. A schematic of the all-fiber laser system based on optical synchronization of a broadband Er laser and narrowband Yb laser is diagrammed in FIG. 2A. Collinear pulsed laser beams can be focused into a flow cell with a lens (e.g., a low-NA objective lens) and emission collected and directed to a multi-channel spectral detector. The repetition rate of the oscillator can be reduced to maintain peak power density while scaling to low-NA, and a custom multi-channel lock-in amplifier to perform multiplexed CRS could be developed. Further, in FIGS. 2B-2D, a narrowband CRS laser system optimized for high-resolution microscopy is depicted. FIGS. 2B and 2C show the tuning range over the entire high-wavenumber region of Raman spectra. Instead of a narrowband filter in the Er arm to generate a synchronized broadband output, a multi-stage amplifier to control the output bandwidth via SPM broadening can be used. Finally, FIG. 2D depicts a CRS image of 1 μm polystyrene beads acquired at 1 frame/sec with 512×512 sampling with the fiber-laser system. Inset shows that the SNR is about 25. FIG. 3 shows example Raman spectra of polystyrene, melamine and polymethylmethacrylate (PMMA) beads.

Ultra-short laser pulse-trains are typically characterized by the pulse duration τ and repetition rate R. As optical pulses are not square pulses, the pulse duration normally refers to their FWHM. The laser duty factor D=1/(τ·R) is a unit-less number that is proportional to the ratio of the laser peak power over the laser average power, wherein the proportionality constant depends on the exact temporal profile.

The first and second input pulse trains [used for the pump and Stokes beams] may originate from one or more separate pulse trains (e.g., pulse trains generated by one or more fiber oscillators and/or pulse generators). In some implementations, the temporally synchronized first and second input trains of pulses can be generated by splitting a pulse train, and the first and/or second fiber systems can include a step of wavelength conversion. In other implementations, the temporally synchronized first and second input trains can be generated by dividing a broadband pulse train by wavelength. Examples of methods and systems for generating the temporally synchronized first and second input trains are described elsewhere herein.

In one example, the first and second input train of pulses that are temporally synchronized are provided by frequency shifting or by broadening an output of an oscillator. The first input train of pulses is generated from a fiber oscillator and the second input pulse train is generated by frequency broadening/shifting a portion of the first input pulse train to a new wavelength. Such frequency shifting can be achieved, for example, with a super-continuum (SC) unit including a photonic crystal fiber (PCF) or a highly nonlinear fiber (HNLF). In some cases, this configuration can provide stringent optical synchronization. In some cases, fixed or tunable filters can be used to select a specific wavelength with a specific bandwidth.

In another example, the first and second input train of pulses that are temporally synchronized are provided by optical synchronization of two oscillators with a common mode-locker. The first and second input trains of pulses are generated from two fiber oscillators that share a common mode-locker to achieve the temporal synchronization. Examples of mode-lockers include semiconductor saturable absorbers (SESAMs) and saturable absorbers based on carbon nanotubes (CNT-SA), which can have a broad absorption wavelength range.

In another example, the first and second input train of pulses that are temporally synchronized are provided by electrical synchronization of two oscillators via feedback. The first and second input trains of pulses are generated from two independent fiber oscillators and temporal synchronization is achieved via feedback (e.g., cavity length feedback). In some cases, this approach can eliminate the need for a delay stage as the delay can be compensated electronically. The first and second input trains of pulses can by monitored by one or more photo-diodes (PDs), the signal from which provides the input to the feedback electronics. In some cases, such electronic synchronization can be environmentally sensitive.

In yet another example, the first and second input train of pulses that are temporally synchronized are provided by electronic synchronization of an oscillator and a pulse on-demand source. The first input train of pulses is generated from a fiber oscillator and the second input train of pulses is generated from a pulse on-demand laser source in response to an electrical signal derived from the first oscillator (also “feed-forward” herein). As an example, the second input train of pulses may be generated from a continuous-wave (CW) laser source by at least one high-speed modulator that is in response to a photodiode measuring the first pulse train. Such second laser can be a time-lens laser. In another example, first and second input train of pulses are generated by on-demand lasers sources in response to an electronic signal.

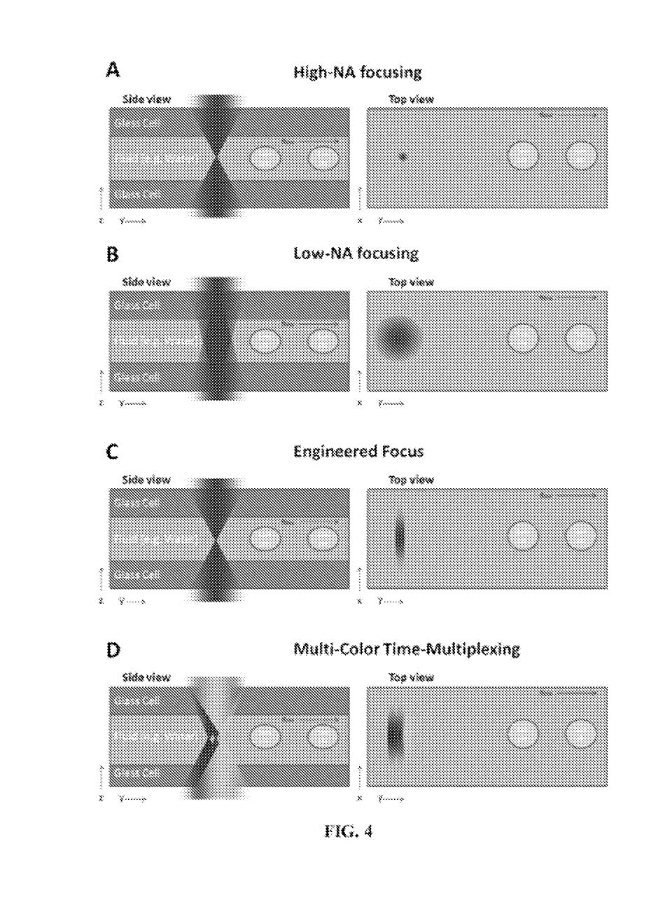

In certain aspects, high-speed coherent Raman scattering (CRS) can be performed with high-NA lenses to provide high peak power so as to generate adequate signal from the nonlinear CRS signal at moderate average powers. As shown in FIG. 4A, when applied to flow-cytometry such high-NA excitation may not allow for complete analysis of a sample, as the static laser focus would only sample a small portion of the specimen. Low-NA excitation (FIG. 4B) can be used, but may have reduced peak-power and CRS signal. Reduced signal can be challenging for applications that require high sensitivity. As described herein, systems and methods of the invention in various embodiments provide useful applications of CRS to imaging modalities that need fast time resolution, such as, e.g., flow cytometry.

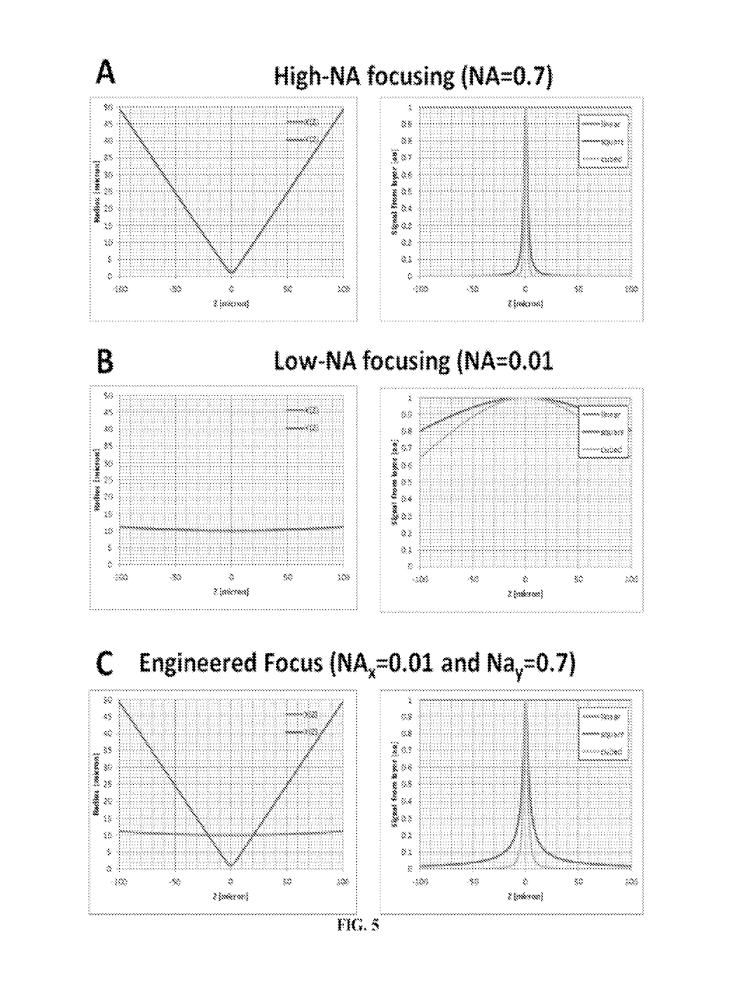

In some embodiments, the peak power and the focal spot of the laser can be tuned to provide ample signal while also detecting signal from a large volume. Tuning of the focal spot can be conducted by modifying the shape and dimensions of the focal spot. For example, lateral and axial focal extensions can have a different dependence on the excitation NA (ΔX∝0.61*λ/NA vs. ΔZ∝1.4*λ/NA²). This can result in different spot sizes in the x-axis and z-axis for low-NA excitation (e.g. NA=0.01). The NA could be chosen to match the sample size laterally, which can result in an axial extension of more than 10× longer than the sample. This can sacrifice the signal by the same ratio. Examples of results that can be obtained using high and low NA focusing are shown in FIGS. 5A & 5B.

In yet other embodiments, better sampling of specimens in flow systems or other applications may be achieved even when using high-NA objectives by under-filling the entrance aperture of the high-NA objective to create a larger focal spot and/or shaping the incident pump and Stokes beams to create an elliptical focal volume.

Background signals (e.g., non-resonant background in CARS, cross-phase modulation or thermal lensing in SRS) may also be generated from the entire focal extension, which may reduce the signal-to-background ratio for low-NA excitation. For CARS, high-NA excitation can simplify the phase matching conditions perhaps due to the presence of many spatial frequencies in the excitation beams. High-NA excitation for CARS can also allow for convenient co-linear excitation. Here, reducing the laser repetition rate from high repetition rates (e.g., 80 MHz) to low repetition rates (e.g., a few MHz) might maintain peak power in the focal spot while reducing NA. Acquisition speed may be limited using a similar approach as the sampling rate can be smaller than laser repetition rate.

In some aspects, CRS signal strength can be maintained with low-NA excitation. For example, CRS signal strength may be maintained by breaking the symmetry between the two lateral components and use of different excitation NA's. FIG. 4C shows an example of an engineered focus as provided by the present invention. This approach can allow, e.g., for homogeneous sampling of the entire specimen while maintaining the higher peak-power desirable for CRS. By adjusting the excitation-NA ratios, it could be possible to increase the z-resolution to match the x-resolution, which might reduce out-of-focus background (See, e.g., FIG. 5C). High-NA along one of the excitation axes could be used to maintain phase matching in CARS under co-linear excitation. This result may be achieved by excitation with a high-NA lens, reducing the beam-size, and thus the effective NA along the x-axis (e.g. with a cylindrical telescope). More sophisticated approaches can adjust beam-size and divergence with another beam-shaping element (e.g. adaptive mirror or spatial light modulators). Combing repetition-rate scaling and focal engineering may make CRS cytometry possible at peak powers comparable to those typically used in high-NA imaging, while achieving sampling volumes suited to flow cytometry.

The systems of the present invention can be optimized for high-sensitivity detection. A laser platform for multiplex CRS can be used by optically synchronizing a picosecond laser to a broadband laser, which can allow the use of emission spectroscopy to obtain CRS data across the CH Raman bands with speed sufficient for use in flow cytometry. In addition, detection in a flow cytometer uses a low NA lens such that the observation time of each cell is sufficient to obtain full spectral information. Because CRS is a nonlinear optical technique that benefits from high peak power in a tightly focused spot, transitioning to low NA sacrifices signal. To overcome the sacrificed signal, the present invention in various embodiments contemplates maintaining the peak power at a desired range despite the less tight focusing. The methods and systems described herein, address this especially challenging function for picosecond lasers with high spectral resolution that already have a much reduced peak power.

In some embodiments of the present invention, CRS signals are monitored within a narrowband spectral range using single-element or single-channel detectors. In other aspects of the invention, CRS spectral data are acquired over a broadband spectral range using multi-element or multi-channel detectors. Single-channel or single-element detectors include, but are not limited to photodiodes, avalanche photodiodes, and photomultipliers. Multi-channel or multi-element detectors include, but are not limited to photodiode arrays, photomultiplier arrays, CMOS sensors, and CCD sensors and cameras.

In an alternative embodiment, the systems of the present invention (e.g., the above-described excitation geometries) may also provide the ability to obtain multi-spectral data with a single-element detector. For example, by dispersing different Raman-shift foci into different areas along the direction of the flow (FIG. 4D), the spectral information can be mapped into time-domain as the sample flows through the focal region. This could allow for spectral acquisition with a single-element high-speed detector (e.g. photomultiplier tube, avalanche photodiode or a photodiode). In an exemplary implementation, this can be achieved by placing a diffraction grating in one or both of the excitation paths of the pump and/or Stokes beams, such that different frequency components could have different angles at the back-aperture of the excitation lens.

In some aspects, the present invention can include using CRS for flow cytometry for high-throughput quantitative chemical analysis of single cells. The overall chemical content of a cell, rather than sub-cellular distributions, might also be determined by use of low-magnification, low-NA lenses, e.g. Nikon Plan Apo 2× objective lens used in CRS. The objective lens could, e.g., have a maximum lateral and an axial resolution of 5 μm and 110 μm, respectively. The input beam size can be adjusted to optimize sensitivity, specificity and compatibility with the focused flow. Emission can be collected in transmission with a condenser lens and can be aligned into a spectrograph. The optical resolution can be 10 cm⁻¹ and the sampled range can be 250 cm⁻¹. One aspect of the invention provides a system that has a common focal volume that has at least two dimensions that are larger than 5 μm, allowing homogeneous sampling of the entire specimen (e.g. prokaryotic or eukaryotic cell). Another aspect of the invention provides methods and systems for increasing the CRS signal in the above large-area geometry by reducing the laser repetition rate below 10 MHz.

In some aspects, the present invention includes methods for system calibration and correction of CRS spectral data. Broadband beams generated using the methods and systems described herein, may differ in spectral distribution from more standardized sources of light and hence produce CRS signals that need to be compared to known Raman spectra of various chemicals. Calibration methods may include acquiring a signal from a material with a known CRS spectral response, for example, by shifting the common focal volume into the wall of a sample compartment or flow cell to collect CRS spectral data from the material of which the sample compartment or flow cell is formed, or by flowing a fluid of known CRS spectral response through the focal volume in a flow system. In some cases, the fluid used for calibration provides undetectable Raman contributions in a predetermined spectral region, which can be used for calibration. In yet other cases, the signal acquired for calibration may comprise a non-resonant response, for example, a non-resonant background in CARS, or cross-phase modulation or a photo thermal signal in SRS. In some cases, the non-resonant response signal is acquired by closing an aperture in the detection path. Calibration methods may be performed one, or repeated at random time intervals or on scheduled time intervals during the use of the CRS system. In some aspects, the calibration signals or spectra may be used to correct the CARS or SRS spectra for drift in the spectral output of the Stokes beam, for example through the use of spectral processing algorithms.

The systems of the present invention can be useful, e.g., as research tools and/or commercial flow cytometers. One aspect for a commercially viable high-speed CRS-based flow cytometer is a robust and low-cost laser system that can be used to produce pulses sufficient for carrying out CRS. The all-fiber laser for multiplex CRS and a detection apparatus for a CRS-based cell sorter can be used. The all-fiber laser system of the present invention can be used for CRS and could be based on optical synchronization of erbium (Er) and ytterbium (Yb) fiber amplifiers, the two most common gain media in telecommunications. Because light is guided within the optical fiber, misalignment is impossible. Parts are robust and low-priced due to the economy of scale of the telecommunications industry.

In some embodiments, the systems and methods of the present invention can include recording CARS and SRS signals simultaneously. For example, CARS emission at the anti-Stokes wavelength can be separated from excitation beams in the system using, e.g., a dichroic mirror. The system can include separate electronics and detectors for the CARS emission. SRS emission can be detected using, e.g., different electronics and detectors in the system. In other embodiment only one of CARS, SRS or RIKE are detected.

In one aspect, the methods and systems described herein can be used to analyze living cells. Cells may not be labeled with any chemical or biological reagent, thereby allowing better cellular viability and minimal manipulation of cells to prepare the sample for analysis. In another aspect, the methods and systems can be used to analyze cellular contents that can include, e.g., detection and analysis of lipid content, deoxyribonucleic acid content, ribonucleic acid content, sugar content amino acid content, protein content and chemical species.

In yet another aspect, the methods and systems may also include detection and analysis of the degree of lipid unsaturation and transition temperatures, modifications to deoxyribonucleic acids or ribonucleic acids, modifications to sugars, modifications to amino as well as post-translational modifications to proteins.

In another aspect of the methods and systems disclosed herein, a real-time detection system for improving the yield of needle biopsies of cancerous lesions is described. Clinical diagnosis of cancer is increasingly performed using molecular diagnostic techniques that require biopsy specimens that are comprised primarily of malignant cells, and existing biopsy guidance techniques (such as ultrasound, MRI, PET, or CT) do not achieve the required positioning accuracy. A fiber-optic probe for coherent Raman scattering (CRS) spectroscopy that can be inserted into a standard biopsy needle may provide a means for simple chemical detection of malignancy in adjacent tissue in real-time. Dual-wavelength fiber laser systems such as those disclosed herein may provide a robust and low-cost system for clinical applications, including, for example, hand-held devices.

A fiber-based CRS probe would require a highly miniaturized design compared to the delivery optics and large, high NA objectives used in conventional CRS microscopy. In one approach, the beam from a dual-wavelength fiber laser system would propagate down a single-mode double-clad delivery fiber core, and the back-scattered emission would be collected with the multimode inner cladding. By choosing a large mode area (LMA) fiber and a large, high-NA inner cladding, it should be possible to minimize nonlinearities of the delivery fiber, such as spectral changes due to self-phase modulation or signal generation in the fiber, and maximize collection efficiency. Prior to reaching a focusing element at the distal end of the fiber, the beam would be expanded by splicing to a short section of core-less or large-core multi-mode fiber. Use of a (6+1)×1 pump-signal combiner in the reverse direction would allow alignment of the CRS signal propagating in the inner cladding with a PMT array spectrometer.

The focusing element or lens at the distal end of the fiber could be manufactured by melting the fiber tip into a ball (or spherical) lens. The dimensions and focusing properties of the lens can be controlled by the amount of fiber tip that is melted. For a given sphere radius, working distance and numerical aperture could be controlled by adjusting the length of coreless fiber proximal to the ball lens, which allows the mode field to expand prior to entering the ball lens. A multimode fiber that is matched to the inner cladding of the double-clad fiber can be used and can allow signal collection at the interface of the ball-lens. This will require careful adjustment of the length of each of the fiber elements.

Different lens geometries can be used to implement side-viewing capabilities. A simple approach would be to polish the fiber ball-lens at approximately 45°, such that total internal reflection redirects the excitation light to the side. A forward viewing ball-lens and a 45° degree mirror can also be used, which would allow adjustment of the working distance into the tissue by varying the distance from the fiber tip to the mirror. Once optimized, the distance can be fixed.

In order to eliminate or minimize aberrations, for example, astigmatism if a rounded optical shield is used, the properties of the ball-lens could be modified. Alternatively, a geometry can be chosen where the excitation fiber and the 45° mirror are held in place by a square glass tube which fits into the needle probe tightly.

Various methods and systems disclosed herein comprise laser, optical, and detection system designs that are adaptable to variations in design parameters, including but not limited to laser, optical, and detection system parameters, such as laser pulse repetition rate, laser pulse duration, narrowband laser pulse wavelength, narrowband laser pulse bandwidth, broadband laser pulse wavelength, broadband laser pulse bandwidth, average and maximum laser output power, laser pulse synchronization or timing jitter, lateral focal resolution or diameter of focal spot, axial focal resolution or depth of field, detection wavelength range, detection resolution, and data acquisition rate. It will be recognized by those of skill in the art that in some embodiments of the invention, the pump laser pulse will be narrowband while the probe or Stokes laser pulse will be broadband, while in other embodiments of the invention, the pump laser pulse will be broadband and the probe or Stokes laser pulse will be narrowband.

The methods and systems disclosed herein may be configured with various laser pulse repetition rates for one or more trains of laser pulses. Lower repetition rates may be advantageous in terms of increasing peak output powers. In one embodiment of the invention, the laser pulse repetition rate is between 1 MHz and 200 MHz. In other embodiments of the invention, the laser pulse repetition rate is at least 1 MHz, 5 MHz, at least 10 MHz, at least 15 MHz, at least 20 MHz, at least 25 MHz, at least 30 MHz, at least 35 MHz, at least 40 MHz, at least 45 MHz, at least 50 MHz, at least 55 MHz, at least 60 MHz, at least 65 MHz, at least 70 MHz, at least 75 MHz, at least 80 MHz, at least 90 MHz, at least 100 MHz, at least 125 MHz, at least 150 MHz, at least 175 MHz, or at least 200 MHz. In yet other embodiments of the invention, the laser pulse repetition rate is at most 200 MHz, at most 175 MHz, at most 150 MHz, at most 125 MHz, at most 100 MHz, at most 90 MHz, at most 85 MHz, 80 MHz, at most 75 MHz, at most 70 MHz, at most 65 MHz, at most 60 MHz, at most 55 MHz, at most 50 MHz, at most 45 MHz, at most 40 MHz, at most 35 MHz, at most 30 MHz, at most 25 MHz, at most 20 MHz, at most 15 MHz, at most 10 MHz, or at most 5 MHz. In one embodiment of the invention, the laser pulse repetition rate is about 8 MHz. Those of skill in the art will appreciate that the laser pulse repetition rate may fall within any range bounded by any of these values (e.g. from about 10% to about 90% of 80 MHz).

The methods and systems disclosed herein may be configured with different laser pulse durations for one or more trains of laser pulses, which may alternatively be specified in terms of the corresponding full width at half maximum (FWHM) for the one or more trains of laser pulses. In one embodiment of the invention, the laser pulse durations are between 100 femtoseconds and 100 picoseconds. In other embodiments of the invention, the laser pulse durations are at least 100 femtoseconds, at least 500 femtoseconds, at least 1 picosecond, at least 5 picoseconds, at least 10 picoseconds, at least 20 picoseconds, at least 30 picoseconds, at least 40 picoseconds, at least 50 picoseconds, at least 60 picoseconds, at least 70 picoseconds, at least 80 picoseconds, at least 90 picoseconds, or at least 100 picoseconds. In yet other embodiments of the invention, the laser pulse durations are at most 100 picoseconds, at most 90 picoseconds, at most 80 picoseconds, at most 70 picoseconds, at most 60 picoseconds, at most 50 picoseconds, at most 40 picoseconds, at most 30 picoseconds, at most 20 picoseconds, at most 10 picoseconds, at most 5 picoseconds, at most 1 picosecond, at most 500 femtoseconds, or at most 100 femtoseconds. In one embodiment of the invention, the laser pulse durations are between about 2 and 10 picoseconds. In yet another embodiment of the invention, the broadband laser pulse is about 5 times shorter, or about 4 times shorter, or about 3 times shorter, or about 2 times shorter than the narrowband laser pulse to ensure approximately uniform sampling of all spectral components despite the temporal profile of the laser pulses. Those of skill in the art will appreciate that the laser pulse duration may fall within any range bounded by any of these values (e.g. from about 0.001% to about 90% of 100 picoseconds).

The methods and systems disclosed herein may be configured with different narrowband laser pulse wavelengths which, in combination with the wavelength and bandwidth of the broadband laser pulse wavelength, determines the Raman coverage achieved. In one embodiment of the invention, the narrowband laser pulse wavelength is between 1000 nm and 1500 nm. In other embodiments of the invention, the narrowband laser pulse wavelength is at least 1000 nm, at least 1100 nm, at least 1200 nm, at least 1300 nm, at least 1400 nm, or at least 1500 nm. In yet other embodiments of the invention, the narrowband laser pulse wavelength is at most 1500 nm, at most 1400 nm, at most 1300 nm, at most 1200 nm, at most 1100 nm, or at most 1000 nm. In one embodiment of the invention, the narrowband laser pulse wavelength is between 1010 nm and 1080 nm. In yet another embodiment of the invention, the narrowband laser pulse wavelength is about 1062 nm. Those of skill in the art will appreciate that the narrowband laser pulse wavelength may fall within any range bounded by any of these values (e.g. from about 1010 nm to about 1100 nm).

The methods and systems disclosed herein may be configured with different broadband laser pulse wavelengths which, in combination with the bandwidth of the broadband laser pulse and the wavelength of the narrowband laser pulse, determines the Raman coverage achieved. In one embodiment of the invention, the broadband laser pulse wavelength is between 750 nm and 1700 nm. In other embodiments of the invention, the broadband laser pulse wavelength is at least 750, at least 800 nm, at least 900 nm, at least 1000 nm, at least 1100 nm, at least 1200 nm, at least 1300 nm, at least 1400 nm, at least 1500 nm, at least 1600 nm, or at least 1700 nm. In yet other embodiments of the invention, the broadband laser pulse wavelength is at most 1700 nm, at most 1600 nm, at most 1500 nm, at most 1400 nm, at most 1300 nm, at most 1200 nm, at most 1100 nm, or at most 1000 nm. In a one embodiment of the invention, the Stokes (probe) laser pulse wavelength is between 1520 nm and 1590 nm. In yet another embodiment of the invention, the broadband laser pulse wavelength is about 1557 nm. Those of skill in the art will appreciate that the broadband laser pulse wavelength may fall within any range bounded by any of these values (e.g. from about 1550 nm to about 1560 nm).

The methods and systems disclosed herein may be configured with different narrowband laser pulse bandwidths which, in combination with the broadband laser pulse wavelength and broadband laser pulse wavelength, determines the Raman coverage achieved. In one embodiment of the invention, the narrowband laser pulse bandwidth is between 0.2 nm and 5 nm. In other embodiments of the invention, the narrowband laser pulse bandwidth is at least 0.2 nm, at least 0.3 nm, at least 0.4 nm, at least 0.5 nm, at least 1 nm, at least 2 nm, at least 3 nm, at least 4 nm, or at least 5 nm. In yet other embodiments of the invention, the narrowband laser pulse bandwidth is at most 5 nm, at most 4 nm, at most 3 nm, at most 2 nm, at most 1 nm, at most 0.5 nm, at most 0.4 nm, at most 0.3 nm, or at most 0.2 nm. In a one embodiment of the invention, the narrowband laser pulse bandwidth is between 0.3 nm and 0.8 nm. In yet another embodiment of the invention, the broadband laser pulse bandwidth is about 0.5 nm. Those of skill in the art will appreciate that the narrowband laser pulse bandwidth may fall within any range bounded by any of these values (e.g. from about 0.25 nm to about 0.75 nm).

The methods and systems disclosed herein may be configured with different broadband laser pulse bandwidths which, in combination with the broadband laser pulse wavelength and narrowband laser pulse wavelength, determines the Raman coverage achieved. In one embodiment of the invention, the broadband laser pulse bandwidth is between 10 nm and 200 nm. In other embodiments of the invention, the broadband laser pulse bandwidth is at least 10 nm, at least 20 nm, at least 30 nm, at least 40 nm, at least 50 nm, at least 60 nm, at least 70 nm, at least 80 nm, at least 90 nm, at least 100 nm, at least 110 nm, at least 120 nm, at least 130 nm, at least 140 nm, at least 150 nm, at least 160 nm, at least 170 nm, at least 180 nm, at least 190 nm, or at least 200 nm. In yet other embodiments of the invention, the broadband laser pulse bandwidth is at most 200 nm, at most 190 nm, at most 180 nm, at most 170 nm, at most 160 nm, at most 150 nm, at most 140 nm, at most 130 nm, at most 120 nm, at most 110 nm, at most 100, at most 90 nm, at most 80 nm, at most 70 nm, at most 60 nm, at most 50 nm, at most 40 nm, at most 30 nm, at most 20 nm, or at most 10 nm. In a one embodiment of the invention, the broadband laser pulse bandwidth is between 50 nm and 80 nm. In yet another embodiment of the invention, the broadband laser pulse bandwidth is about 60 nm. Those of skill in the art will appreciate that the broadband laser pulse bandwidth may fall within any range bounded by any of these values (e.g. from about 55 nm to about 65 nm).

The methods and systems disclosed herein may be configured with different average or maximum laser output powers for one or more trains of laser pulses delivered to the sample. Higher average and maximum laser output powers may be advantageous in terms of increasing sensitivity and signal-to-noise ratio of spectral measurements. In one embodiment of the invention, average laser output powers delivered to the sample are between 10 mW and 500 mW. In other embodiments of the invention, average laser output powers are at least 10 mW, at least 20 mW, at least 30 mW, at least 40 mW, at least 50 mW, at least 60 mW, at least 70 mW, at least 80 mW, at least 90 mW, at least 100 mW, at least 110 mW, at least 120 mW, at least 130 mW, at least 140 mW, at least 150 mW, at least 160 mW, at least 170 mW, at least 180 mW, at least 190 mW, at least 200 mW, at least 225 mW, at least 250 mW, at least 275 mW, at least 300 mW, at least 350 mW, at least 400 mW, at least 450 mW, or at least 500 mW. In one embodiment of the invention, average laser output powers delivered to the sample are between 50 mW and 100 mW. Those of skill in the art will appreciate that average laser output power delivered to the sample may fall within any range bounded by any of these values (e.g. from about 15 mW to about 95 mW).

The methods and systems disclosed herein may be configured with varying degrees of laser pulse synchronization or levels of timing jitter. More closely synchronized laser pulses may be advantageous in terms of achieving improved signal-to-noise ratios and faster data acquisition times in spectral measurements. In one embodiment of the invention, laser pulse synchronization or timing jitter is between 10 femtoseconds and 100 femtoseconds. In other embodiments of the invention, laser pulse synchronization or timing jitter is at most 100 femtoseconds, at most 90 femtoseconds, at most 80 femtoseconds, at most 70 femtoseconds, at most 60 femtoseconds, at most 50 femtoseconds, at most 45 femtoseconds, at most 40 femtoseconds, at most 35 femtoseconds, at most 30 femtoseconds, at most 25 femtoseconds, at most 20 femtoseconds, at most 15 femtoseconds, or at most 10 femtoseconds. In one embodiment of the invention, laser synchronization is less than 40 femtoseconds. Those of skill in the art will appreciate that laser synchronization or timing jitter may fall within any range bounded by any of these values (e.g. from about 25 femtoseconds to about 45 femtoseconds).

The methods and systems disclosed herein may be configured with varying levels of lateral focal resolution or diameters of focal spot. Lateral focal resolution, as used herein, determines the area of the focal spot, which in turn impacts the intensity of laser light reaching the sample and the area of the sample from which signal is collected. In one embodiment of the invention, lateral focal resolution is between [symbol] 0.5 um and 20 um [symbol] . In other embodiments of the invention, lateral focal resolution is at least 0.5 um, at least 1 um, at least 2 um, at least 3 um, at least 4 um, at least 5 um, at least 6 um, at least 7 um, at least 8 um, at least 9 um, at least 10 um, at least 15 um, or at least 20 um. In yet other embodiments of the invention, the lateral focal resolution is at most 20 um, at most 15 um, at most 10 um, at most 9 um, at most 8 um, at most 7 um, at most 6 um, at most 5 um, at most 4 um, at most 3 um, at most 2 um, at most 1 um, or at most 0.5 um. In one embodiment of the invention, the lateral focal resolution is between 5 um and 10 um. In yet another embodiment of the invention, the lateral focal resolution is about 8 um. Those of skill in the art will appreciate that the lateral focal resolution may fall within any range bounded by any of these values (e.g. from about to about 3% to about 95% of 20 um).

The methods and systems disclosed herein may be configured with varying levels of axial focal resolution or depths of field. Axial focal resolution or depth-of-field, in combination with focal spot size, determines the focal volume. Smaller focal volumes may be advantageous in achieving higher laser light intensities and improved signal-to-noise ratios in spectral measurements. In one embodiment of the invention, axial focal resolution is between 3 um and 120 um. In other embodiments of the invention, axial focal resolution is at least 3 um, at least 4 um, at least 5 um, at least 6 um, at least 7 um, at least 8 um, at least 9 um, at least 10 um, at least 15 um, at least 20 um, at least 25 um, at least 30 um, at least 35 um, at least 40 um, at least 45 um, at least 50 um, at least 60 um, at least 70 um, at least 80 um, at least 90 um, at least 100 um, at least 110 um, or at least 120 um. In yet other embodiments of the invention, the axial focal resolution is at most 120 um, at most 110 um, at most 100 um, at most 90 um, at most 80 um, at most 70 um, at most 60 um, at most 50 um, at most 45 um, at most 40 um, at most 35 um, at most 30 um, at most 25 um, at most 20 um, at most 15 um, at most 10 um, at most 9 um, at most 8 um, at most 7 um, at most 6 um, at most 5 um, at most 4 um, or at most 3 um. In one embodiment of the invention, the axial focal resolution is between 45 um and 50 um. In yet another embodiment of the invention, the lateral focal resolution is about 47 um. Those of skill in the art will appreciate that the lateral focal resolution may fall within any range bounded by any of these values (e.g. from about to about 3% to about 95% of 120 um). In some embodiments of the invention, it may be advantageous to further shape the focal volume through the use of additional optical components to shape the incident laser beams, thereby further restricting the depth-of-field while maintaining a suitable focal spot diameter.

The methods and systems disclosed herein may be configured with various ranges of spectral detection, that is, the spectral range over which spectral data is collected. Broader spectral detection ranges may be advantageous in achieving better selectivity between spectra for different chemical species. In one embodiment of the invention, the spectral detection range covers a span of between 100 cm-1 and 3000 cm-1. In other embodiments of the invention, the spectral detection range spans at least 100 cm-1, at least 125 cm-1, at least 150 cm-1, at least 200 cm-1, at least 250 cm-1, at least 300 cm-1, at least 350 cm-1, at least 400 cm-1, at least 450 cm-1, at least 500 cm-1, at least 550 cm-1, at least 600 cm-1, at least 650 cm-1, at least 700 cm-1, at least 750 cm-1, at least 800 cm-1, at least 900 cm-1, at least 1000 cm-1, at least 1100 cm-1, at least 1200 cm-1, at least 1300 cm-1, at least 1400 cm-1, at least 1500 cm-1, at least 1750 cm-1, at least 2000 cm-1, at least 2250 cm-1, at least 2500 cm-1, at least 2750 cm-1, or at least 3000 cm-1. In yet other embodiments of the invention, the spectral detection range spans at most 3000 cm-1, at most 2750 cm-1, at most 2500 cm-1, at most 2250 cm-1, at most 2000 cm-1, at most 1750 cm-1, at most 1500 cm-1, at most 1400 cm-1, at most 1300 cm-1, at most 1200 cm-1, at most 1100 cm-1, at most 1000 cm-1, at most 900 cm-1, at most at 800 cm-1, at most 750 cm-1, at most 700 cm-1, at most 650 cm-1, at most 600 cm-1, at most 550 cm-1, at most 500 cm-1, at most 450 cm-1, at most 400 cm-1, at most 350 cm-1, at most 300 cm-1, at most 250 cm-1, at most 200 cm-1, or at most 150 cm-1. In one embodiment of the invention, the spectral detection range spans about 250 cm-1. Those of skill in the art will appreciate that the spectral detection range may fall anywhere within any range bounded by any of these values (e.g. from a range of about 200 cm-1 to a range of about 760 cm-1).

The methods and systems disclosed herein may be configured with various levels of spectral detection resolution. Narrower spectral detection resolution may be advantageous in achieving better selectivity between spectra for different chemical species. In one embodiment of the invention, the spectral detection resolution is between 2.5 cm-1 and 30 cm-1. In other embodiments of the invention, the spectral detection resolution is at least 2.5 cm-1, 5 cm-1, at least 10 cm-1, at least 15 cm-1, at least 20 cm-1, at least 25 cm-1, or at least 30 cm-1. In yet other embodiments of the invention, the spectral detection resolution is at most 30 cm-1, at most 25 cm-1, at most 20 cm-1, at most 15 cm-1, at most 10 cm-1, at most 5 cm-1, or at most 2.5 cm-1. In one embodiment of the invention, the spectral detection resolution is about 10 cm-1. Those of skill in the art will appreciate that the spectral detection resolution may fall anywhere within any range bounded by any of these values (e.g. from about 3 cm-1 to about 18 cm-1).

The methods and systems disclosed herein may be configured with various levels of spectral data acquisition rates. In one embodiment of the invention, the spectral data acquisition rate is between 10 spectra/second and 1,000,000 spectra/second. In other embodiments of the invention, the spectral data acquisition rate is at least 10 spectra/second, at least 25 spectra/second, at least 50 spectra/second, at least 75 spectra/second, at least 100 spectra/second, at least 150 spectra/second, at least 200 spectra/second, at least 300 spectra/second, at least 500 spectra/second, at least 750 spectra/second, 1,000 spectra/second, at least 5,000 spectra/second, at least 10,000 spectra/second, at least 25,000 spectra/second, at least 50,000 spectra/second, at least 75,000 spectra/second, at least 100,000 spectra/second, at least 250,000 spectra/second, at least 500,000 spectra/second, at least 750,000 spectra/second, or at least 1,000,000 spectra/second. In yet other embodiments of the invention, the spectral data acquisition rate is at most 1,000,000 spectra/second, at most 750,000 spectra/second, at most 500,000 spectra/second, at most 250,000 spectra/second, at most 100,000 spectra/second, at most 75,000 spectra/second, at most 50,000 spectra/second, at most 25,000 spectra/second, at most 10,000 spectra/second, at most 5,000 spectra/second, or at most 1,000 spectra/second. In one embodiment of the invention, the spectral data acquisition rate is about 10,000 spectra/second. Those of skill in the art will appreciate that the pump laser pulse wavelength may fall within any range bounded by any of these values (e.g. from about 2,500 spectra/second to about 200,000 spectra/second).

### Computer Systems

In various embodiments, the methods and systems of the invention may further comprise software programs on computer systems and use thereof. Accordingly, computerized control for the synchronization of system functions such as laser system operation, fluid control function, and/or data acquisition steps are within the bounds of the invention. The computer systems may be programmed to control the timing and coordination of delivery of sample to a detection system, and to control mechanisms for diverting selected samples into a different flow path. In some embodiments of the invention, the computer may also be programmed to store the data received from a detection system and/or process the data for subsequent analysis and display.

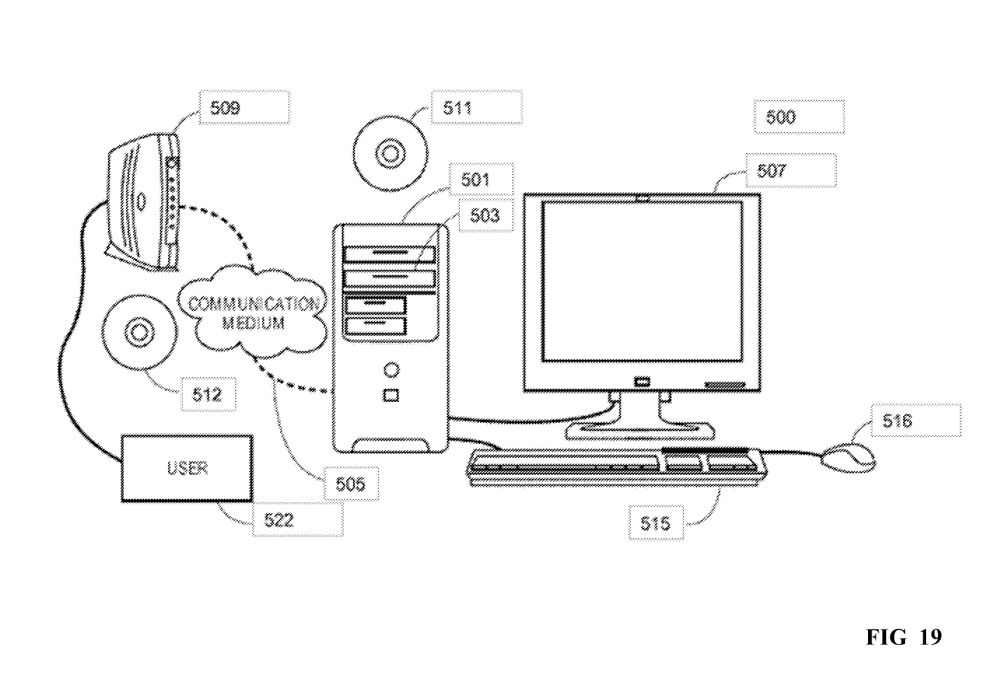

The computer system 500 illustrated in FIG. 19 may be understood as a logical apparatus that can read instructions from media 511 and/or a network port 505, which can optionally be connected to server 509 having fixed media 512. The system, such as shown in FIG. 19 can include a CPU 501, disk drives 503, optional input devices such as keyboard 515 and/or mouse 516 and optional monitor 507. Data communication can be achieved through the indicated communication medium to a server at a local or a remote location. The communication medium can include any means of transmitting and/or receiving data. For example, the communication medium can be a network connection, a wireless connection or an internet connection. Such a connection can provide for communication over the World Wide Web. It is envisioned that data relating to the present disclosure can be transmitted over such networks or connections for reception and/or review by a party 522 as illustrated in FIG. 19.

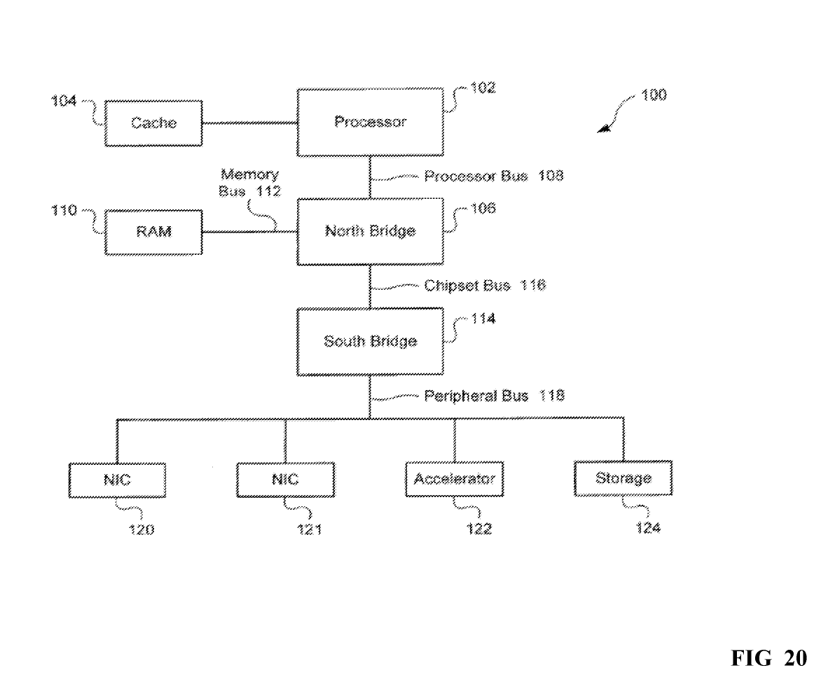

FIG. 20 is a block diagram illustrating a first example architecture of a computer system 100 that can be used in connection with example embodiments of the present invention. As depicted in FIG. 20, the example computer system can include a processor 102 for processing instructions. Non-limiting examples of processors include: Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can also be used, whether in a single computer system, in a cluster, or distributed across systems over a network comprising a plurality of computers, cell phones, and/or personal data assistant devices.

As illustrated in FIG. 20, a high speed cache 104 can be connected to, or incorporated in, the processor 102 to provide a high speed memory for instructions or data that have been recently, or are frequently, used by processor 102. The processor 102 is connected to a north bridge 106 by a processor bus 108. The north bridge 106 is connected to random access memory (RAM) 110 by a memory bus 112 and manages access to the RAM 110 by the processor 102. The north bridge 106 is also connected to a south bridge 114 by a chipset bus 116. The south bridge 114 is, in turn, connected to a peripheral bus 118. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 118. In some alternative architectures, the functionality of the north bridge can be incorporated into the processor instead of using a separate north bridge chip.

In some embodiments, system 100 can include an accelerator card 122 attached to the peripheral bus 118. The accelerator can include field programmable gate arrays (FPGAs) or other hardware for accelerating certain processing. For example, an accelerator can be used for adaptive data restructuring or to evaluate algebraic expressions used in extended set processing.

Software and data are stored in external storage 124 and can be loaded into RAM 110 and/or cache 104 for use by the processor. The system 100 includes an operating system for managing system resources; non-limiting examples of operating systems include: Linux, Windows™, MACOS™, BlackBerry OS™, iOS™, and other functionally-equivalent operating systems, as well as application software running on top of the operating system for managing data storage and optimization in accordance with example embodiments of the present invention.

In this example, system 100 also includes network interface cards (NICs) 120 and 121 connected to the peripheral bus for providing network interfaces to external storage, such as Network Attached Storage (NAS) and other computer systems that can be used for distributed parallel processing.

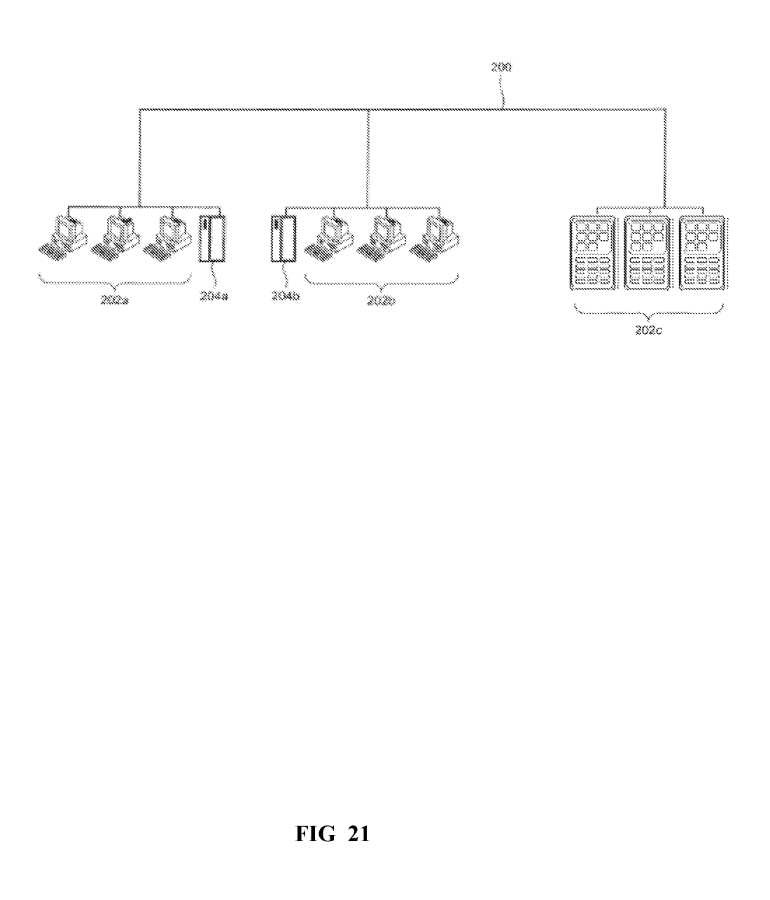

FIG. 21 is a diagram showing a network 200 with a plurality of computer systems 202a, and 202b, a plurality of cell phones and personal data assistants 202c, and Network Attached Storage (NAS) 204a, and 2104b. In example embodiments, systems 202a, 202b, and 202c can manage data storage and optimize data access for data stored in Network Attached Storage (NAS) 2104a and 2104b. A mathematical model can be used for the data and be evaluated using distributed parallel processing across computer systems 202a, and 202b, and cell phone and personal data assistant systems 202c. Computer systems 202a, and 202b, and cell phone and personal data assistant systems 202c can also provide parallel processing for adaptive data restructuring of the data stored in Network Attached Storage (NAS) 204a and 204b. FIG. 21 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some example embodiments, processors can maintain separate memory spaces and transmit data through network interfaces, back plane or other connectors for parallel processing by other processors. In other embodiments, some or all of the processors can use a shared virtual address memory space.

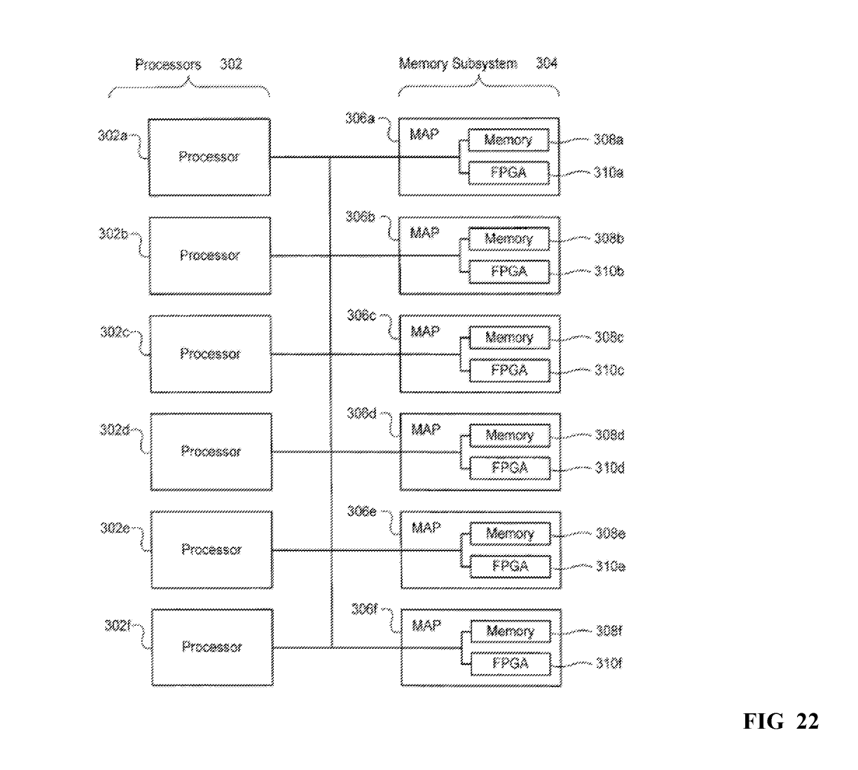

FIG. 22 is a block diagram of a multiprocessor computer system 302 using a shared virtual address memory space in accordance with an example embodiment. The system includes a plurality of processors 302a-f that can access a shared memory subsystem 304. The system incorporates a plurality of programmable hardware memory algorithm processors (MAPs) 306a-f in the memory subsystem 304. Each MAP 306a-f can comprise a memory 308a-f and one or more field programmable gate arrays (FPGAs) 310a-f. The MAP provides a configurable functional unit and particular algorithms or portions of algorithms can be provided to the FPGAs 310a-f for processing in close coordination with a respective processor. For example, the MAPs can be used to evaluate algebraic expressions regarding the data model and to perform adaptive data restructuring in example embodiments. In this example, each MAP is globally accessible by all of the processors for these purposes. In one configuration, each MAP can use Direct Memory Access (DMA) to access an associated memory 308a-f, allowing it to execute tasks independently of, and asynchronously from, the respective microprocessor 302a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. In some embodiments, all or part of the computer system can be implemented in software or hardware. Any variety of data storage media can be used in connection with example embodiments, including random access memory, hard drives, flash memory, tape drives, disk arrays, Network Attached Storage (NAS) and other local or distributed data storage devices and systems.

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 22, system on chips (SOCs), application specific integrated circuits (ASICs), or other processing and logic elements. For example, the Set Processor and Optimizer can be implemented with hardware acceleration through the use of a hardware accelerator card, such as accelerator card 122 illustrated in FIG. 20.

### Methods

### Cytometry

In some embodiments, the systems and methods of the invention described herein are configured to perform cytometry assays. Cytometry assays are typically used to optically, electrically, or acoustically measure characteristics of individual cells. For the purposes of this disclosure, “cells” may encompass non-cellular samples that are generally of similar sizes to individual cells, including but not limited to vesicles (such as liposomes), small groups of cells, virions, bacteria, protozoa, crystals, bodies formed by aggregation of lipids and/or proteins, and substances bound to small particles such as beads or microspheres. Such characteristics include but are not limited to size; shape; granularity; light scattering pattern (or optical indicatrix); whether the cell membrane is intact; concentration, morphology and spatio-temporal distribution of internal cell contents, including but not limited to protein content, protein modifications, nucleic acid content, nucleic acid modifications, organelle content, nucleus structure, nucleus content, internal cell structure, contents of internal vesicles (including pH), ion concentrations, and presence of other small molecules such as steroids or drugs; and cell surface (both cellular membrane and cell wall) markers including proteins, lipids, carbohydrates, and modifications thereof. The methods and systems of the invention described herein allow for label-free cytometry assays. Alternatively, by using appropriate dyes, stains, or other labeling molecules either in pure form, conjugated with other molecules or immobilized in, or bound to nano- or micro-particles, cytometry may be used to determine the presence, quantity, and/or modifications of specific proteins, nucleic acids, lipids, carbohydrates, or other molecules, alone or in combination with label-free assays. Properties that may be measured by cytometry also include measures of cellular function or activity, including but not limited to phagocytosis, antigen presentation, cytokine secretion, changes in expression of internal and surface molecules, binding to other molecules or cells or substrates, active transport of small molecules, mitosis or meiosis; protein translation, gene transcription, DNA replication, DNA repair, protein secretion, apoptosis, chemotaxis, mobility, adhesion, antioxidizing activity, RNAi, protein or nucleic acid degradation, drug responses, infectiousness, and the activity of specific pathways or enzymes. Cytometry may also be used to determine information about a population of cells, including but not limited to cell counts, percent of total population, and variation in the sample population for any of the characteristics described above. The assays described herein may be used to measure one or more of the above characteristics for each cell, which may be advantageous to determine correlations or other relationships between different characteristics. The assays described herein may also be used to independently measure multiple populations of cells, for example by labeling a mixed cell population with antibodies specific for different cell lines. A microscopy module may permit the performance of histology, pathology, and/or morphological analysis with the device, and also facilitates the evaluation of objects based on both physical and chemical characteristics. Tissues can be homogenized, washed, deposited on a cuvette or slide, dried, stained (such as with antibodies), incubated and then imaged. The interpretation of cellular assays may be automated by gating of one or more measurements; the gating thresholds may be set by an expert and/or learned based on statistical methods from training data; gating rules can be specific for individual subjects and/or populations of subjects.

In some embodiments, the incorporation of a cytometer module into a point of service device provides the measurement of cellular attributes typically measured by common laboratory devices and laboratories for interpretation and review by classically-trained medical personnel, improving the speed and/or quality of clinical decision-making. A point of service device may, therefore, be configured for cytometric analysis.

Cytometric analysis may, for example, be by flow cytometry or by microscopy. Flow cytometry typically uses a mobile liquid medium that sequentially carries individual cells to an optical, electrical or acoustic detector. Microscopy typically uses optical or acoustic means to detect stationary cells, generally by recording at least one magnified image. It should be understood that flow cytometry and microscopy are not entirely exclusive. As one example, flow cytometry assays may use microscopy to record images of cells passing by the detector. Many of the targets, reagents, assays, and detection methods may be the same for flow cytometry and microscopy. As such, unless otherwise specified, the descriptions herein should be taken to apply to these and other forms of cytometric analyses known in the art.

The microscopic objective can be finely positioned to focus the image via an actuator, such as by a cam connected to a motor. The objective may be focused on one or more planes of the sample. Focusing may be automated by image analysis procedures by computing the image sharpness of digital images among other methods.

### Flow Cytometry

Flow cytometry may be used to measure, for example, cell size (forward scatter, conductivity), cell granularity (side scatter at various angles), DNA content, dye staining, and quantitation of fluorescence from labeled markers. Flow cytometry may be used to perform cell counting, such as by marking the sample with fluorescent markers and flowing past a sensing device. Cell counting may be performed on unlabeled samples as well. The systems and methods described herein allow for label-free applications of flow cytometry alone or in combination with those that use labeled samples.

Preferably up to 1000000 cells of any given type may be measured. In other embodiments, various numbers of cells of any given type may be measured, including but not limited to more than or equal to about 10 cells, 30 cells, 50 cells, 100 cells, 150 cells, 200 cells, 300 cells, 500 cells, 700 cells, 1000 cells, 1500 cells, 2000 cells, 3000 cells, 5000 cells, 6000 cells, 7000 cells, 8000 cells, 9000 cells, 10000 cells, 100000 cells, 1000000 cells.

In some embodiments, flow cytometry may be performed in microfluidic channels. Flow cytometry analysis may be performed in a single channel or in parallel in multiple channels. In some embodiments, flow cytometry may sequentially or simultaneously measure multiple cell characteristics. Flow cytometry may be combined with cell sorting, where detection of cells that fulfill a specific set of characteristics are diverted from the flow stream and collected for storage, additional analysis, and/or processing. It should be noted that such sorting may separate out multiple populations of cells based on different sets of characteristics, such as 3 or 4-way sorting.

### Microscopy

The systems and methods described herein are suited for large-view imaging using microscopy techniques. Multiple microscopy images may be recorded for the same sample to generate time-resolved data, including videos. Individual or multiple cells may be imaged simultaneously, by parallel imaging or by recording one image that encompasses multiple cells. A microscopic objective may be immersed in media to change its optical properties, such as through oil immersion. A microscopic objective may be moved relative to the sample by means of a rotating CAM to change the focus. Cytometry data may be processed automatically or manually, and may further include analyses of cell or tissue morphology, such as by a pathologist for diagnostic purposes.

Cell counting can be performed using imaging and cytometry. In situations where the subjects may be bright-field illuminated, subjects may be illuminated from the front with a white light and the cells may be sensed with an imaging sensor. Subsequent digital processing will count the cells. Specific or non-specific fluorescent markers may be used. Confocal scanning imaging is contemplated within the embodiments of the invention. Preferably up to 1000 cells of any given type may be counted. In other embodiments, various numbers of cells of any given type may be counted, including but not limited to more than or equal to about 1 cell, 5 cells, 10 cells, 30 cells, 50 cells, 100 cells, 150 cells, 200 cells, 300 cells, 500 cells, 700 cells, 1000 cells, 1500 cells, 2000 cells, 3000 cells, 5000 cells. Cells may be counted using available counting algorithms. Cells can be recognized by their characteristic fluorescence, size and shape.

### CRS Imaging System

In various embodiments of the invention, microscope hardware and software can be configured and enabled for Coherent Raman Scattering (CRS) microscopy. CRS microscopy allows label-free chemical imaging and enables applications in biology, material science and medicine. Despite imaging speeds that are orders of magnitude higher than conventional Raman, instrument cost and technical complexity have limited wide adoption of the technology.

To overcome current limitations, the methods and systems of the invention, in some embodiments, contemplate the use of a CRS laser source based on fiber laser technology that has a greatly reduced cost compared to currently used solid-state systems can be used. Fiber lasers, which are more robust than free-space lasers, can be used successfully in CRS microscopy herein at an uncompromised signal-to-noise ratio compared to current solid-state systems.

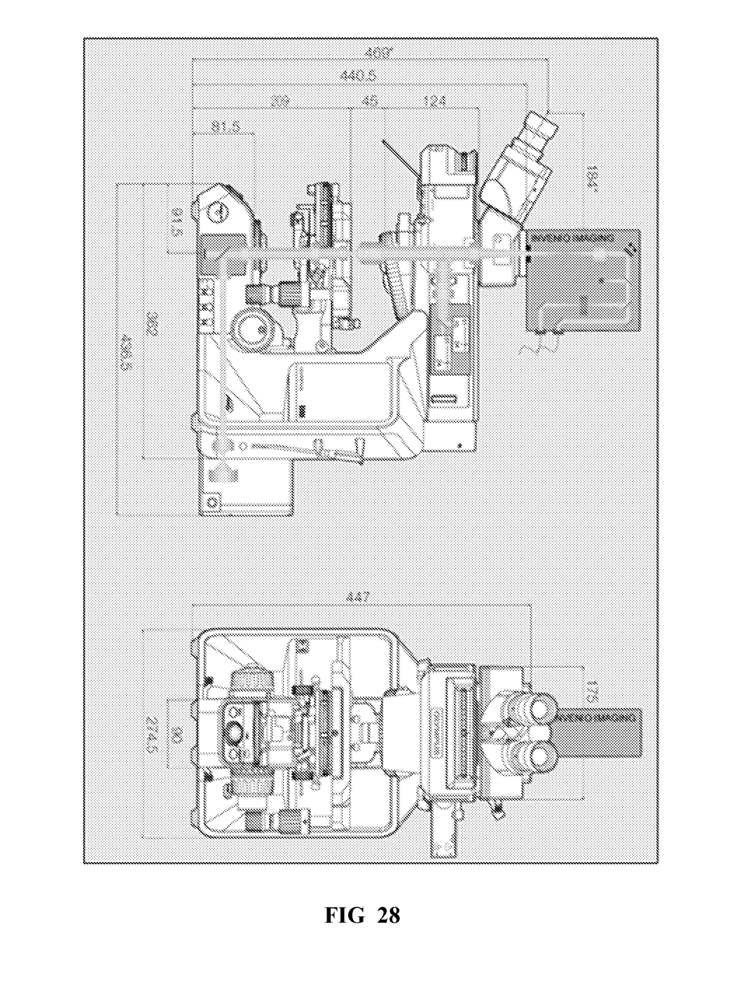

As described herein, a fully integrated and easy to use CRS microscopy system (e.g., FIG. 28) based on the fiber laser source of the present disclosure can be used. An integrated microscope or an upgrade unit to an existing microscope (e.g., to include the laser, beam-scanner, and/or detectors), or a hand-held scanner can be assembled. Such a hand-held scanner can utilize faster imaging to minimize motion blur and also might benefit from video-rate imaging. The integrated microscope (FIG. 28) can be created, in part, using commercial microscopes (e.g., Olympus). In some embodiments, the microscope is designed as an upgrade unit to existing microscope stands (e.g., Olympus).

A fully integrated CRS system, such as a CRS microscope, based on a standard supplier microscope frame may be assembled which might include as an example an all-PM version of the laser system, with improved spectral tuning capability. A laser-scanning unit based on galvo scan mirrors with fiber inputs and beam routing for frequency doubling, combining the laser outputs and beam sampling might also be designed. In general, frequency multiplying, such as frequency doubling, can be achieved by harmonic generators, such as SHG, Third Harmonic Generator (THG), Sum Frequency Generators (SFG), Difference Frequency Generators (DFG) etc. Multi-modal CARS microcopy can be implemented through design of a two-channel non-descanned detection unit for epi CARS and other nonlinear signals (TPEF and/or SHG). A transmission SRS detector can be implemented as a second-generation technology. The scanning software can be based on the open-source microscopy platform μ-Manager and simple-to-use graphical user interface (GUI) targeted to spectroscopic imaging as required by Raman customers may be built and fully integrated as a system. In one aspect, a fully integrated multi-modal CRS microscope based on a commercial microscope (e.g., an OEM Olympus microscope frame) by combining the all-fiber laser source with a beam-routing/scanning unit can be constructed. A laser scanning unit and the dual-channel epi detector module for back-scattered CARS and other multi-photon signals (e.g. TPEF and SHG or others) that can be detected simultaneously may be designed and built. The SRS transmission detector can be implemented as second generation technology.

In some embodiments, the integrated microscope can access the high-wavenumber region of Raman spectra (e.g., 2700-3200 cm⁻¹), which encompasses most of the validated applications. Another embodiment of a microscope application includes upgrade options for other regions (e.g., C-D or fingerprint regions) based on the similar core fiber-laser technology but using other gain media.

In some embodiments, two detection schemes can be utilized for CRS microscopy: Coherent anti-Stokes Raman scattering (CARS) microscopy and stimulated Raman scattering (SRS) microscopy. SRS microscopy can provide improved sensitivity and spectroscopic specificity compared to the older CARS. In the integrated microscope example, a CARS system with added SRS capability can be constructed.

Specific imaging properties, such as numerical aperture (NA) and field of view (FOV), can be application specific. Different objective options, automation and other microscope features can be created with existing Raman microscope equipment (e.g. Olympus). Software can be based on an open-source platform, e.g., μ-Manager that currently supports most Olympus functions.

Multimodality can also be used to supplement image information from CRS label-free imaging with that of other imaging modalities, such as two-photon excited fluorescence (TPEF) and second harmonic generation (SHG), especially for biology research that routinely use TPEF. Simultaneous multi-color TPEF is also contemplated as an application with dual-wavelength sources.

In CRS, sensitivity and spectral resolution critically depend on properties of the laser source. New sources can be integrated into a microscope, which builds on established technology (e.g., beam-scanning), but include additional features (e.g., fast spectral tuning and SRS).

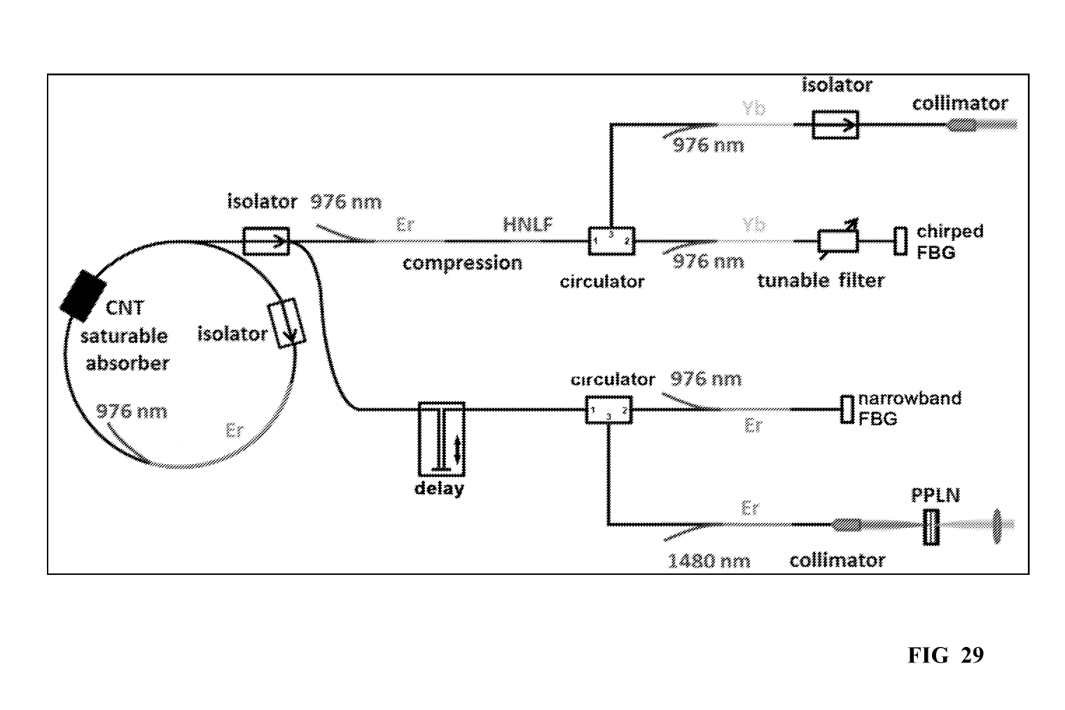

In contrast to spontaneous Raman scattering, with CRS the sample is excited with two laser beams, one of which can be tunable (to the precision of ˜0.1 nm) such that their difference frequency matches a targeted vibrational frequency Ω of the sample. Pulsed lasers with high peak power at moderate average power can be used to boost the nonlinear signal. A CRS light source can be made to provide two synchronized pulse trains with a timing jitter that can be lower than the pulse duration. An all-fiber dual-wavelength laser system can be used as described herein. The systems and methods described herein allow for imaging and characterization experiments to be performed on simple wooden tables in a room without tight temperature control, similar to conditions in a biology lab or hospital setting amongst other locations with space suitable to house necessary equipment. A dual-wavelength fiber laser system for CRS microscopy as shown in FIG. 29, can provide optical synchronization (rather than electrical synchronization which has high timing jitter) of two power amplifiers using a broadband super-continuum (SC).

The dual-wavelength fiber laser system for CRS microscopy can be engineered for precise tunability. To access the high-wavenumber region (e.g., 2800 cm⁻¹ to 3200 cm⁻¹) in this first-generation product, Erbium (Er)- and Ytterbium (Yb)-doped fiber amplifies can be synchronized. As most multi-photon microscope anti-reflection coatings are optimized in the Ti:Sapphire range (e.g., 750 nm-1000 nm), the Er-output can be frequency doubled at 1580 nm to produce a pump beam at 790 nm. Tunability of the Stokes beam from 1015 nm to 1055 nm with as little as 0.1 nm precision can be achieved by filtering the broadband SC before amplification with a precisely tunable filter. In one example, the autocorrelation widths can be 5.7 ps and 1.4 ps, which correspond to pulse durations of 4.0 ps and 1.0 ps, respectively. This is consistent with a 1.2 nm bandwidth of the Stokes pulses and corresponds to spectral resolution of 11 cm⁻¹, which is narrower than the typical Raman line width. Better matching of pump and Stokes pulse durations might be achieved with a different narrowband filter, which may further increase single-to-noise.

The dual-wavelength fiber laser system for CRS microscopy can be engineered for low timing jitter. The timing jitter can be less than 24 fs, using the intensity noise of the of the sum frequency signal at the half maximum of the optical cross-correlation. This jitter may be approximately 200× smaller than the FWHM of the cross-correlation (4.4 ps) and may be insignificant. Non-quantitatively, low timing jitter may be evident by the acquisition of the imaging data without intensity “striping” or long-term drift.

The dual-wavelength fiber laser system for CRS microscopy can be engineered to achieve high sensitivity for various species that can be detected. CRS narrowband amplifiers can be optimized to achieve pulse durations of 1-2 ps, a repetition rate of 50 MHz, and average powers of 50 mW and 100 mW for the pump and Stokes beams, respectively. According to the ANSI standard for medical devices, the maximum permissible exposure of skin is limited to 40 mW at 800 nm, independent of the specific pulse parameters: The microscope optics can have 30% throughput where 150 mW of average power can be sufficient. A laser can be created with 77 mW of 790 nm pump light and 145 mW of 1030 nm Stokes light. Additional appropriate power levels and wavelengths can be combined from respective values described throughout the specification.

High-speed chemical imaging can be achieved with the dual-wavelength fiber laser system for CRS microscopy. CRS imaging performance can be obtained with a device based on a simple board-mounted CARS microscope using galvo scanning mirrors controlled by a DAQ-card and Labview scanning software. With this set-up, a signal-to-noise of 32 (data not shown here) for the imaging of a 0.75-micron polystyrene bead sample at an imaging speed of 1 frame/s with 500×500 sampling and 50 mW total in-focus power can be obtained. Use of the solid-state system (e.g., picoEmerald, APE Berlin) at the same average power for imaging can result in a lack of bead detection due to noise. Tripling the laser power to 110 mW of pump and 45 mW of Stokes in the laser focus may be performed to achieve similar quality images, which is consistent with the shorter pulse duration and lower repetition rate of the optimized light source. Such a setting can be especially suitable for a medical device.

One possible limitation of the non-polarization maintaining (PM) implementation is long-term stability. Adjustment of the polarization state can be done every 30 min to maintain maximum signal. An all-PM system can be designed and built based according to various embodiments of the invention.

Reliable spectral tuning can be affected by time delay and polarization state changes at different wavelengths. This may be solved by a combination of a PM-design and dispersion management with a chirped fiber Bragg grating (FBG). Spectral imaging using the PM system can be achieved manually. The tunable filter can also be controlled from the DAQ card in synchronization with the imaging and might adjust the tuning speed to 10 kHz's for line-by-line spectral tuning, e.g. to minimize spectral artifacts due to motion of in vivo samples.

At maximum power of, e.g., 100 mW (with 59 MHz repetition rate and 1 ps pulse duration) signs of spectral broadening due to self phase modulation (SPM) might be observed for the Stokes pulses. Power amplifiers based on large-mode-area (LMA) gain fiber, which have 9× lower nonlinearities (30-micron vs. 10-micron core size) can be implemented as an offset strategy. The bandwidth of the filters and SHG crystal can be selected to match the pulse durations of pump and Stokes pulses.

A beam-routing/scanning unit for combination of the pump and Stokes beams in free-space is contemplated according to the various embodiments of the invention. The system can be developed based on a PM-version of the tunable filter described above and might utilize additional improvements to increase tuning speed. Both CARS microscopy and SRS technology can be developed. Throughout the integration process (e.g., software & electronics), an example of the system in this example can be based on off-the-shelf components and Labview software to quickly explore the parameter space. In another example of the example, a fully integrated version of the system is provided.

The all-PM version of the dual-wavelength laser system can be designed and fully characterized. FIG. 29 shows an example schematic of a laser system of the present disclosure. In some embodiments, all components, e.g., in PM versions, and a PM core-aligning fusion splicer (e.g., Fujikura, FSM-100P) are used. Variations from the drawing are contemplated and include the use of double-pass geometry of the Yb-doped pre-amplifier, addition of a chirped fiber Bragg grating (FBG) to compensate for dispersion, and better matched filters to ensure the same pulse duration of pump and Stokes pulses.

In some embodiments, the system is based on a mode-locked Er-doped fiber oscillator with a repetition rate of 50-MHz. For example, the system can be based upon a PM-version of an OEM oscillator (e.g., Calmar Laser Inc., FPL-M2CFFPM). A robust oscillator can be built based on the CNT saturable absorber design. The output of the oscillator can be split into two arms, one arm feeding directly into the Er-doped pre- and power-amplifiers and being frequency doubled in a PPLN crystal to produce the narrowband 790 nm pump beam, the other arm being used to generate a broadband SC that extends to approximately 1000 nm and allows optical synchronization of the Yb-doped amplifier to produce a tunable Stokes beam. The all-fiber implementation can include a stable SC that can be generated with only a few cm of HNLF. The pre-amplified input can be temporally compressed in un-doped anomalous dispersion fiber to produce high peak-power pulses. PM-HNLF (e.g., OFS, Inc.) can be purchased with the same parameters as the non-PM version.

The PM Er- and Yb-doped amplifiers can be designed and optimized for high spectral fidelity and minimal nonlinear broadening. The pulse conditioning can be performed in the low-power pre-amplifiers and increase the power only at the final amplification stage. The narrowband tunable filter and fixed-frequency FBG in the pre-amplifiers might determine the spectral resolution and tunability. Double-pass geometry can be implemented to increase the pre-amplified power to 10 mW (see above). This saturates the power-amplifiers but can be propagated from the laser to the microscope without SPM broadening. The power amplifiers can be incorporated in the beam-routing unit.

Different geometries for the power amplifiers can be implemented. In one aspect, single mode PM fibers and 1480 nm pumping of the Er-doped amplifier can be implemented using CRS spectroscopic imaging. In certain aspects, the spectral fidelity may be further increased by using large mode area (LMA) fibers, which reduces the power density and minimizes residual nonlinear pulse broadening. Use of different gain fibers e.g., PLMA-EYDF-25P/300-HE (e.g., Nufern) and e.g., YB1200-30/250DC-PM (e.g., Liekki) is contemplated within the embodiments. The mode-field diameters can be increased by 3× compared to Er80-8 and e.g., Yb2000-10/125DC (e.g., Liekki). The peak power density may consequently be decreased by about 9× and can result in much reduced SPM. PM mode-field adapters (MFA) can be used to connect the single-mode pre-amplifiers to the LMA power amplifiers, which have lower numerical aperture (NA). Third, cladding pumping can be explored as a means to scale the average power to Watt-level. While more average power may not be needed for bio-imaging, cladding pumping might be a less expensive implementation as a cheaper multi-mode pump laser can be used.

Options for beam routing can be developed and are discussed as part of the scanning unit section below. The time delay between pump and Stokes pulses can be adjusted as part of the laser system with a motorized fiber delay stage (e.g., OZ Optics, ODL-650), which can be spliced into the Er-arm before the power amplifier to reduce insertion loss and power handling requirements. The tuning precision can be 2.8 fs<<1 ps pulse duration. The maximum delay can be 350 ps, and the rough delay can be adjusted by splicing un-doped fiber in either of the two arms to a precision of a 5-10 cms, while monitoring the temporal overlap with a high-speed Si photodiode. The fine delay can be adjusted with the delay stage, while monitoring the cross-correlation.

Spectral tunability of the Stokes beam can be achieved with a motorized narrowband filter. To minimize risk, the system can be based on the PM version of the filter used as described above (e.g., Agiltron, FOTF). A driver that can be called from the scanning software and may allow automated frame-by-frame spectral imaging. Line-by-line spectral imaging may be achieved through high-speed tuning on the fly-back of the fast axis scan mirror, which can minimize spectral artifacts due to sample motion. This requires tuning speeds of >5 kHz, which may be available commercially (e.g. Micron Optics or LambdaQuest). Both polarization state and time delay are wavelength dependent due to dispersion. The all-PM design might eliminate polarization changes. To eliminate dispersion, the Yb-doped pre-amplifier in a double-pass geometry using a chirped fiber Bragg grating (FBG) might be used. A Faraday mirror can be used and allow to map out the exact dispersion of the design and specify a custom chirped FBG (e.g., O-ELand Inc.).

The laser system can be designed such that it can be fully controlled and monitored via software located at a computer system as described elsewhere herein. The laser system might provide independent control of the drive current of the CW pump lasers for each stage in the system (e.g., oscillator, SC unit, pre- and power amplifiers) and monitor the CW powers with internal photo-diodes (PD). The laser drive can be positioned on the main board and connected through a cable to the laser diode in the laser housing. Every stage can also have about a 5% pick-off at the input (e.g., by using integrated WDM-isolator-coupler components) that feeds into a fiber-coupled PD. The output of the PD can be split into DC and AC components to independently monitor the average and mode-locked intensities of the inputs, which can be used to warn the user of malfunctions. The temperature of the SHG can also be controlled.

The fiber laser system can be packaged to increase long-term stability. Fibers can be coiled and components fixed with clamps. All pulse conditioning can be performed at low power and the power amplifiers might be integrated in the beam-routing/scanning unit to avoid propagating the high-power output over long distances. The packaging can be designed to be modular and connected with SMA connectors of improve ease of service. For example, the prototype was milled from a single block of aluminum with dedicated areas to mount the CW pump laser and driver boards. Heating can affect stability, therefore the driver and laser system can be separated. After the laser is fully packaged and the laser is given some “burn-in” time, long-term stability testing can be performed over a period of 3 months. Stability can be recorded of the average power as well as the spectral calibration.

In one embodiments, the present disclosure includes an all-PM dual-color CRS laser system with a fixed wavelength pump beam (˜790 nm) and tunable Stokes beam (1015 to 1050 nm) with a spectral bandwidth of <1.2 nm, timing jitter <100 fs, average power of 50 mW and 100 mW for pump and Stokes beams, 50 MHz repetition rate and matched, with nearly transform limited pulses. LMA fibers may further increase spectra fidelity. System monitoring, spectral calibration and time delay systems with 1 cm⁻¹ spectral and 10 fs temporal resolution as well as high speed tuning (10 kHz rate for a 5 nm step) and dispersion management (<100 fs time delay variation for a 35 nm tuning range) can be developed. Finally, the long-term stability of average power (>80% of the original power) and spectral calibration (5 cm⁻¹) of the packaged laser system over 3 months may be demonstrated. The system may or may not include high speed tuning as frame-by-frame spectral tuning is sufficient for most applications, dispersion management as the cross-correlation function can be used to develop a look-up-table prior to imaging. In addition, an alternative to a chirped FBG may be dispersion shifted photonic crystal fibers.

Beam combination to produce collinear pump and Stokes beams and beam sampling can be performed in the scanner unit. The combining of the pump and Stokes beams can be to use a wavelength division multiplexer (WDM), so that there can be a single fiber output from the laser system. There can be increased CRS signal generated in the combined fiber due to the long interaction length. While this is not a problem for CARS, as the anti-Stokes radiation from the fiber can be blocked with a 700 nm long pass filter at the fiber output, it can be problematic for SRS, as the signal is a polarization modulation that is detected with the lock-in detection scheme and is not easily blocked with a filter. Specially designed PCF fibers may be used as a solution. In certain aspects, the two beam can be delivered in separate fibers and combine them in free-space. The frequency doubling unit in the beam-routing/scanning unit can be included and which can remain in free space after its output (see, e.g., FIG. 28). CRS may be performed with the un-doubled 1550 nm output, which can provide a simple path to an all-fiber CARS system. While 1550 nm imaging is not yet sufficiently validated, this can be considered when designing the beam-routing unit as it can be straightforward to remove the dichroic and doubling crystal from the dual beam design. The sampling arm for the GaAsP diode can also be included.

The beam-scanning unit can be designed to interface with the camera port of the Olympus microscope frame (see, e.g., FIG. 28). The tube lens can be part of the microscope frame and the position of the intermediary image plane with respect to the C-mount is provided by a microscope manufacturer as part of the OEM support (e.g., Olympus). Cameras can be placed in this plane. An IR coated achromatic flat-field scan lens may be selected to create a planar scanning field from the galvo scan mirrors (e.g., Cambridge Technology, Inc.). The scanning field can coincide with the intermediary image plane. The implementation might be based on closely spaced scan mirrors that are positioned such that the conjugate telecentric plane coincides with the center point of the two mirrors. Residual beam movement at the back-aperture of the objective can largely be negligible and this simple implementation is chosen by multiple vendors of beam-scanning microscopes.

In one embodiment, the approximate dimensions of the optical train are chosen as follows: The focal length (FL) of the Olympus tube lens is 180 mm; the field of view (FOV) of the preferred CRS objective lens (e.g., Olympus, UPlanSApo 60XW) is 300 μm, i.e. the intermediary image plane has a dimension of 60×300 μm=18 mm; and the FL of the scan lens can determine the magnification of the beams size and might be chosen to be short to reduce the size of the scan mirrors and improve scan speed. The lower boundary of FL may be limited by beam-movement from the simplified scanning geometry, e.g. where approximately 60 mm is typical. In this geometry the optical scan angle α=±arctan (9 mm/60 mm)≈±8.5°, i.e. the mechanical scan angle β=α/2≈±4.3° β=α/2≈±4.3°. To fill the 7.2 mm back-aperture of the UPlanSApo 60XW lens, the input beam diameter 2.4 mm as determined by the fiber collimators (e.g., OZ Optics, HUCO). The tube lens and/or the CRS objective lens may be supplied with other FL and FOV values, e.g. as determined according to a manufacturer's specifications. As most other objectives typically have larger back apertures, this geometry can underfill them resulting in reduced resolution. In this example, maximizing transmission and thus sensitivity for the 60× lens can be a design criterion.

Scan mirrors can be categorized as resonant or non-resonant. While resonant mirrors can be about 15× faster and can allow imaging speeds up to video rate (30 fps), their image quality can be compromised and high-speed data acquisition can be more challenging to implement. Given the signal to noise measured with the previously described system, video-rate imaging speeds may be supported, and may implement a system based on non-resonant scanners. For this, 4 mm scan mirrors (e.g., Cambridge Technology, 6210H) may be used and of note, the specifications predict an imaging speed of 1.3 s/frame with 512×512 sampling, unidirectional imaging and optimized cycloid waveforms. A fast-scanning feature based on bi-directional scanning with a sine waveform may also be implemented for the “Live” modus of the microscope software.

For spectral imaging, the fast axis may be scanned at 400 lines/s. The retrace time between 2 lines can be 20%, e.g., 0.5 ms. The data acquisition can be triggered accordingly. The sampling speed of the DAQ is 1 MS/s and may oversample the pixel dwell time, e.g. 80%·2.5 ms/512=4 μs for 512 pixels/line. The Stokes wavelength can be scanned on a line-by-line basis to reduce spectral artifacts due to motion, e.g. one line can be scanned multiple times at different Raman shifts before the slow axis galvo is changed. This may require improving the tuning speed to greater than 1/0.·5 ms=2 kHz. The Raman shift between imaging frames may also be tuned as described above.

The detector unit for the epi CARS can be designed to fit a standard manufacturer frame based on the CAD models provided as part of the OEM support (e.g., Olympus). Non-descanned detectors can be implemented so as no confocal pinhole is required in nonlinear optical microscopy and might place the detectors in close proximity to the objective lens to optimize sensitivity. A 750 nm longpass dichroic (e.g., Chroma) can be used to separate the excitation from the emission beam. The housing may hold a 750 nm shortpass filter (e.g., Chroma) to block the residual excitation light. CARS signal (630-650 nm) can be separated from other nonlinear multimodal signals such as TPEF or SHG (400-600 nm) with a dichroic mirror and detected with two high-sensitivity photomultiplier tubes (PMT; e.g., Hamamatsu, H10723). Narrowband filters can be used to minimize cross-talk.

A transmission detector for SRS might be assembled. The transmitted pump and Stokes beams may be collected with a high-NA condenser and relayed onto a large area (1 cm×1 cm) PD using an additional lens in the detector unit. A 790 nm bandpass filter (e.g., Chroma) might be placed to block the modulated Stokes beam (see below). The unit may also include a 700 nm long-pass dichroic to reflect the visible light from the transmission lamp for bright field observation with the eye-pieces.

A beam-scanning system for the microscope frame (e.g., Olympus, BX53) that allows imaging at 1.3 s/frame with 512×512 sample and unidirectional scanning and includes elements for beam combining, frequency doubling and beam sampling can also be developed. In addition, a dual-channel non-descanned detector for epi CARS and other multimodal signals and a transmission detector for SRS can also be developed. System integration may require design of consolidated electronics to (1) control and monitor the laser and diagnostic instrumentation, (2) drive the beam-scanners and (3) read the detectors.

Various degrees of device integration might be possible. While fully custom electronics based on DSPs or FPGAs can provide much reduced cost of goods, for the first 10-20 systems it can be more advantageous to choose a more flexible architecture based on an off-the-shelf DAQ card. In another example of the example, the core of the instrument can be an OEM card (e.g., USB-6356-OEM, National Instruments) and AdvancedMEMS can provide a daughter board that interfaces directly through the generic 34- and 50-pin connectors. The DAQ can provide eight 16-bit analog input (AI) channels with 1.25 MS/s/ch simultaneous sampling to read the various detector channels, two 16-bit 3.33 MS/s analog outputs (AO) to drive the galvo scan mirrors, as well as 24 digital I/O lines (of which 8 are hardware-timed up to 1 MHz) for the communication with the daughter board. The daughter board can be designed and fully tested by AdvancedMEMS.

The system may include the following functionalities; digital control of the drive currents for the pump lasers with 1 mA precision and is 1.5 A maximum (e.g., Wavelength Electronics, WLD3343-2L), digital readout of the power pump laser power from the integrated PDs, temperature feedback with digitally adjustable set point e.g., Wavelength Electronics, WHY5640) and the pump lasers are soldered on a separate circuit board inside the laser modules and will be connected to the drivers with cables. Further, digital readout of the PD at the input of each laser module (see above) for monitoring operation and advanced functions (see above). PD may be mounted on the same circuit board as the pump lasers. Each PD output might be split into AC and DC components with a bias-T (e.g., Minicircuits). The AC signals represent the mode-locked powers and may be measured with RF-power detectors (e.g., Texas Instruments). An option for synchronizing the laser repetition rate with the DAQ clock might be provided. Digital control of the laser parameters may include; (1) Stepper motor driver for the delay stage (e.g., OZ Optics, ODL-650); (2) Driver for the electro-optic modulator that might be derived from the 10 MHz DAQ clock and may provide digitally adjustable offset and amplitude (see above). If the DAQ clock is synchronized to the laser repetition rate, the modulation rate can automatically be synchronized to the laser as well; (3) Driver for the tunable filter optimized for a tuning speed up to 10 kHz; (4) Temperature controller for the oven for the PPLN crystal (e.g., Covesion). Digital read-out of the GaAsP diode for measuring the cross-correlation signals, feed-throughs for the AOs of the DAQ to the galvo mirror driver (e.g., CamTech, MicroMax 67300), digital control of the PMT and lock-in amplifier gain (see above); feed-throughs for the signal to the AIs of the DAQ may also be included.

A fully integrated supply, control and monitoring electronics for the laser and microscope system may be built. Software which creates a user friendly user interface can further improve an integrated microscope, as it can contain integrated spectral imaging capability, with the addition of chemometric analysis routines.

In order to provide flexibility for additional hardware options that may be required, the imaging software may be based on an open source microscopy platform (e.g., μ-Manager), although other types of software or software developers may be used to create the user interface. μ-Manager is a complete image acquisition and microscope control package, with built-in functionality for use in life science laboratories. It is also a software framework for implementing advanced and novel imaging procedures, extending functionality, customization and rapid development of specialized imaging applications. For example, g-Manager can be structured in three independent layers: the graphical user interface (GUI), core services (e.g., MMCore) and device adapters. The foundation of the software might be the MMCore, which exposes a generalized command set of the automated microscope that can be accessed from many different programming environments and allows controlling and synchronizing various devices using plug-in adapter modules. As part of the software development, the device adapter for our instrument control electronics can be developed (see above) and an easy-to-use GUI including a spectral library and integrated chemometric analysis methods.

The software may be designed to support a variety of (1) scan modes (such as line-scanning (X), two- and three-dimensional imaging (XYZ), spectral imaging (XYλZ or XλYZ) and time-lapsed imaging XYλZt), (2) visualization features (such as look-up-tables and multi-dimensional image viewing), (3) analysis features (such as a spectral database to which newly acquired point spectra can be added, linear spectral unmixing, spectral fitting, phasor plotting, line profile and histogram analysis), (4) instrumentation calibration procedures (such as monitoring instrument function, optimizing modulation and temporal overlap, and maintaining spectral calibration).

In summary, an intuitive GUI for CRS spectral imaging based on the open source microscopy platform μ-Manager can be developed. This software can build on the established functionally of the MMCore of μ-Manager, which provides the fastest, most flexible and lowest risk approach to microscopy software. Device adaptors for major manufactured microscopes (e.g., Olympus), scanning mirrors and DAQ cards (e.g., National Instrument) already exist and can be used.

### Multi-Photon Methods

The disclosure provides systems and methods for microscopy and spectroscopy and tomography techniques that depend on spatial and temporal overlap of multiple optical pulses also “pulse trains” herein) at different wavelengths on a target. Such techniques are collectively referred to herein as multi-photon methods. As used herein, any aspects of the disclosure described in relation to microscopy may equally apply to spectroscopy or tomography at least in some configurations. In some cases, such techniques can include nonlinear optical techniques (e.g., coherent anti-Stokes Raman scattering (CARS) or stimulated Raman scattering (SRS), multi-photon excitation, second harmonic generation microscopy or other sum/difference frequency generation, etc.). In some cases, the techniques can include multi-photon techniques (e.g., multi-photon excitation, etc.). In some cases, the techniques can include pump-probe techniques used for probing reflection, transmission, absorption, and other characteristics of a sample (e.g., by measuring a temporal response of the sample after the pump beam reaches the sample while the delay time of the probe beam is adjusted). Further examples of techniques benefiting from fiber laser-based systems and methods herein include, but are not limited to, for example, terahertz imaging and sensing (e.g., difference frequency mixing of two lasers at wavelengths that are very close together) and optical coherence tomography (OCT). In some cases, the systems and methods herein can be configured to provide hyperspectral imaging.

Systems and methods herein can be used to enable various multi-photon microscopy techniques. For example, laser system configurations of the present disclosure can be used for any detection methods described herein, including multi-photon microscopy (MPM) methods, Detection methods that can be used with the methods and systems described herein include non-linear optical detection methods. In various embodiments, the methods and the systems described herein can be used with detection methods, such as coherent Raman scattering (CRS; e.g., coherent anti-Stokes Raman spectroscopy (CARS), stimulated Raman scattering (SRS), Raman Induced Kerr Effect (RIKE), second harmonic generation (SHG), third harmonic generation (THG), sum frequency generation (SFG), difference frequency generation (DFG), two-photon absorption (TPA), transient absorption (TA), ground state depletion (GD), stimulated emission (SE), and so on. Detection methods described herein can be used in microscopy imaging applications as well. Any aspects of the disclosure described in relation to, for example, CRS may apply to other multi-photon techniques at least in some configurations, including microscopy configurations. Further examples include using the laser system configurations herein for multi-photon excitation, such as, for example, multi-photon fluorescence excitation (e.g., two-photon excited fluorescence (TPEF), or two-color two-photon excited fluorescence (TCTPEF)).

Techniques such as GD, TA and SE can rely on modified transmission properties of the sample induced by a first beam (e.g., pump beam) and probed by a second beam (e.g., probe beam). In contrast, TPA microscopy can rely on the combined absorption of two photons by the sample that results in exciting the molecules into an excited electronic state. Chemical contrast can be achieved by tuning the sum energy of the two photons into the energy of the electronic excited state. Femtosecond (fs)-pulse-width lasers can be used for maximal signal, but excitation with picoseconds (ps)-pulse-width lasers is also possible. In the SE process, one beam excites molecules in the sample into an excited state, and when these molecules interact with the other beam, they emit light into that beam with matched polarization and phase, increasing the brightness of that beam. In GD, one beam removes molecules from the ground state by promoting them to an excited state, so that fewer molecules are in the ground state and thus the absorption of the other beam is reduced. In order to modify the populations of molecules in the sample, the beams are typically chosen to match the one or two-photon electronic absorption resonances of the molecule in the ground or excited state. Femtosecond (fs)-pulse-width lasers may in some cases be used to maximize signal. The probe pulse can also be delayed to maximize the signal.

A common feature of many of these techniques is that a small intensity gain/loss of one laser beam is measured as a result of its interaction with a second beam and the sample. To achieve high sensitivity, a high-frequency modulation/detection scheme can be used. This process can be carried out by modulating the second beam at a known modulation frequency and extracting the modulation transfer onto the first beam with electronics that sensitively detect the modulation frequency. As such, a stable signal amplification of the small signal can be achieved. By choosing the modulation frequency to be distinct from the characteristic frequencies of laser noise of the excitation lasers, this laser noise can be suppressed.

One or more of these techniques can be implemented in a multi-modal system. For example, one or more of CRS, SHG, TPA, TPA, TA, GD and SE techniques can be used in conjunction with various TPEF in a multi-modal system. These techniques can have different requirements on the laser system, but each may use pulsed lasers (e.g., excitation with pulsed lasers) that have high peak power at moderate average power. For example, TCPEF, SFG and TPA share the common feature of two-color laser input/excitation with a pulsed laser used in CARS and SRS. Pulse durations can be optimized by, for example, using one or more desired narrowband filters before the amplifiers. In some examples, repetition rate can be lowered to achieve the same peak power for picosecond lasers as compared to femtosecond lasers (e.g., lasers operating at 80 MHz repetition rate). The laser platforms described herein can be modified accordingly for, imaging techniques, such as multi-photon microscopy and multi-modal imaging.

Due in part to differences in optical contrast of the various multi-photon techniques, the present disclosure includes laser systems with the capability of performing multiple multi-photon methods. The laser platforms described herein can be modified accordingly for MPM microscopy and multi-modal imaging. In some cases, multi-modality can be used to supplement image information from one imaging modality with that of other imaging modalities (e.g., without or with minimal reconfiguration of the system).

Imaging applications using the systems and methods herein include imaging associated with various in vitro or in vivo assays, such as, for example, in vitro cellular assays, in vivo animal models (e.g., whole animals or animal organs).

### EXAMPLES

### Example 1

### A CRS Flow Cytometer

This example includes building and characterizing the laser source for the high-throughput CRS-based cell sorter, building the detection system, and demonstrating the performance of the complete system which includes the laser source, CRS-based cell sorter and the detection system. This example includes an all-fiber laser source for a high throughput multiplexed CRS flow cytometer. A dual-wavelength laser platform (e.g., FIG. 2A) can be used for optical synchronization of Er- and Yb-doped power amplifiers, which may have a difference in center wavelengths that might allow access to the high wavenumber region (2750 cm⁻¹ to 3400 cm⁻¹) of Raman spectra where most of CRS can be performed. Accessing the fingerprint region of Raman spectra may also be possible (e.g., by utilizing Thulium (Tm) and Holmium (Ho) co-doped amplifiers).

The laser illumination system (1) and the detection system (2) can be arranged for CRS applications. For the flow system (2), custom or off-the-shelf glass microfluidic cells (e.g., Micronit, Inc) or polydimethylsiloxane (PDMS) chips can be used. A variety of channel dimensions (e.g. FC-X3550CH.2) and flow velocities can be used to optimize the flow parameters and stability. Glass rather than PDMS can be used, e.g., to avoid interference from the PDMS Raman signal. Flow cells can be rated up to 100 bar pressure and can be used, e.g., for flow-rates up to 10,000 particles/s. Higher SNR levels can allow for faster flow velocities, and more advanced flow systems could be developed.

Laser Systems. The laser system for narrowband CRS microscopy can include a Er-doped master oscillator, the output of which is split into two arms: The first arm is narrowband filtered around 1580 nm (FIG. 2C) and seeds an Er-doped power amplifier which is then frequency doubled to 790 nm as shorter wavelength provides better spatial resolution to provide the pump beam; the second arm is launched into a highly nonlinear fiber (HNLF) to generate an octave spanning supercontinuum (SC). A tunable filter can be used to provide a precisely tunable narrowband seed to an Yb-doped power amplifier to produce a narrowband Stokes beam for CRS that could be tunable over the entire high-wavenumber region (FIG. 2C). High-quality spectroscopic CRS images at high imaging speed of 1 frame/s (about 4 μs/pixel, FIG. 2D) can be obtained.

The laser system can also use a femtosecond Er-oscillator which could be split into two arms. A narrowband filter with the Er-arm may not be used, but a broadband output for multiplexed CRS could be provided. A two-stage amplifier could be implemented wherein the first stage can be based on a small core, normal dispersion Er-doped gain fiber that could generate increasing bandwidth with higher pump power based on spectral broadening via self-phase modulation (SPM). Broadening of >100 nm is straightforward. The second stage can be based on large-mode area to generate power without broadening (see below). The overall output power can be determined by the second amplifier and can be independent on how the gain is distributed. Such a design can allow tuning the bandwidth of the broadband beam to optimize sensitivity (e.g. improves with lower bandwidth) and specificity (e.g. improves with larger bandwidth, for the specific application). The broadband output may not be transform limited but chirped to picosecond pulse duration as desirable for multiplex CRS to avoid nonlinear photodamage of the sample. It can be matched to the pulse duration of the narrowband pulse train using un-doped dispersion shifted fiber to maximize sensitivity. A 1550 nm fundamental output as the Stokes beam can be used rather than the second harmonic, because high spatial resolution is not required. A bandwidth from 1530 nm to 1590 nm can be used, which corresponds to about 250 cm⁻¹.

The second arm of the laser system can contain the SC unit and narrowband Yb-amplifier. This could be similar to the laser system for CRS microscopy. A normal dispersion Er-doped amplifier could be used to increase average power after the splitter and un-doped anomalous dispersion fiber (e.g. SMF28) and could further be used for temporal compression. Despite the large core-size mismatch between the compression fiber and the HLNF, a low loss splice (<1 dB) can be achieved. To reduce noise of the SC due to nonlinear pulse break-up, a very short piece of HLNF and length adjusted SMF28 (e.g., 1 cm) can be used to produce a SC below 1000 nm. A Yb-doped pre-amplifier can be spliced behind the HLNF output to produce an amplified broadband output. A tunable narrowband filter (e.g., Agilton) can be used to produce a narrowband seed where the bandwidth can determine the spectral resolution of CRS. A target bandwidth could be approximately 10 cm⁻¹, which is narrower than typical Raman lines in the high wavenumber region and could correspond to about 1.2 nm. The center frequency could be tuned to 1070 nm to access Raman shifts from 2800 cm⁻¹ to 3050 cm⁻¹.

The Er-doped all-fiber oscillator can be mode-locked with a fiber-taper CNT saturable absorber. Robust operation can occur with ˜200 fs pulse duration and ˜0.2 nJ pulse energy at the oscillator output. In fiber-lasers, repetition rates as low as 300 kHz can be achieved by incorporating un-doped fiber in the oscillator cavity. The spectral acquisition rate can be lower than in the high-speed imaging system. Different Raman shifts can be measured simultaneously rather than consecutively. The repetition rate can be reduced without synchronizing the laser repletion rate to the acquisition clock. At or close to 8 MHz, a 10× sensitivity improvement may be achieved and can compensate for the signal loss (e.g. due to less tight focusing (see below)). Laser oscillators in the MHz repletion rates can be difficult to obtain with solid-state laser technology due to long cavity length. Similar high peak power can be achieved in solid-state lasers using ultra-short pulses but may not be used for CRS due to sacrifice of spectral resolution.

The suggested power scaling can assume that the laser parameters, such as average power, could remain unchanged and might involve a special design of the power amplifiers. For fiber-based power amplifiers, maximum pulse energies of the output could be limited by pulse broadening due to SPM and can be estimated, e.g. Eₘₐₓ=π·λ·τ·D_{eff}²/4·n₂·L with wavelength λ, pulse duration τ, mode filed diameter D_{eff}, and nonlinear refractive index of silica n2=2.6·10⁻¹⁶ cm2/W. 80 MHz systems can be designed to operate at or near the SPM limit of standard single-mode fibers. To reduce the repetition rate at or close to 8 MHz while maintaining average power (e.g., increase the pulse energy by 10×), the amplifiers can be designed to be similar to recently developed large mode area (LMA) gain fibers which may allow single-mode operation at larger D_{eff} (e.g., LIEKKI Er60-40/250DC). In this configuration, a pulse energy of 25 nJ or average power >100 mW can be achieved. Similarly, a power amplifier based on LMA Yb-doped gain fiber (e.g. LIEKKI, Yb1200-30/250DC) can be used in an aspect of this example.

The laser illumination system could also be based on a non-polarization-maintaining (PM) component. Every element in the system can also exist as a PM version. In yet another aspect of this example, an environmentally more robust system can be designed. Beams can also be overlapped in space and time with free-space optics and routed into the cytometer system. In yet another aspect of this example, an all-fiber design can be used.

Spectral bandwidth of the laser system can be measured with an optical spectrum analyzer (similar to or the HP 70004A) with a spectral resolution of at or close to 0.1 nm and wavelength can be between 800-1800 nm. Temporal properties of the outputs can be measured with an optical autocorrelator with less than 100 fs of resolution. Average power can be determined using a thermal power meter, and repetition rate can be measured using an RF spectrum analyzer (e.g., Signal Hound).

In one aspect, scaling to higher peak power by reducing the repetition rate while maintaining the average power could achieve a plurality of sampling rates lower than 10,000 particles/s. For example, an optically synchronized dual-color multiplex CRS laser system with a narrowband pump beam (e.g. 1070 nm center frequency and 1.2 nm bandwidth) and broadband Stokes beam (e.g. 1530 nm to 1590 nm frequency range) could be used to cover the high wavenumber region of Raman spectra (e.g. 2800 cm⁻¹ to 3050 cm⁻¹) with greater than 50 mW average power of in each beam at or close to 8 MHz repetition rate. With a fiber laser system for narrowband CRS microscopy, an SNR of 25 with 4 μs integration time can be achieved (FIG. 2D).

Detection Systems.

An example flow cytometer system can include a multichannel detection system for multiplex CARS and SRS. This system could be setup to detect both CARS and SRS which could allow for a quantitative comparison of the two techniques in sensitivity, specificity and ease of data interpretation. A data acquisition electronics system with 32 high-speed, high dynamic range input channels, 16 for CARS and 16 for SRS, could be used. In the 32-channel system, the spectrograph might oversample the optical resolution as can be defined by the lasers. In the 16-channel system, the spectrograph might under sample the optical resolution and the transmission grating can be modified accordingly.

CARS and SRS can be recorded simultaneously. CARS emission at the anti-Stokes wavelength could be separated from the excitation beams with a dichroic mirror (e.g., Chroma Technology), could be filtered with a high OD filter (e.g., Chroma Technology), and could be detected with a 16-channel photo multiplier tube (PMT) array with enhanced near IR responsivity (e.g., Hamamatsu H5900-20-L16). Each channel of the detection electronics can be designed with an individual charge integrating amplifier with a programmable trigger and integration time. Single-photon sensitivity can be achieved at sampling speeds up to 150 kS/s/channel and 96 dB dynamic range (Vertilon).

For SRS, the spectrally resolved stimulated Raman gain (SRG) of the Stokes beam with a 16-channel InGaAs photodiode array (e.g., the Hamamatsu, G7150-16) may be measured. As discussed above, sensitive detection of SRS requires extracting the relatively small signal from the intensity fluctuations of the spectral components of the Stokes beam due to laser noise and varying sample transmission. Because such noise primarily occurs at low frequency (e.g. l/f noise), a modulation transfer scheme might be used in which the pump beam can be modulated at a frequency higher than the typical laser noise (e.g. 2 MHz) with a fiber-based electro-optic modulator (e.g., EM4, EM416). The modulation transfer to the Stokes beam can be measured with a lock-in amplifier. With this approach, close to shot-noise limited sensitivity in narrowband SRS microscopy can be achieved. Multiplex detection might not occur without use of a multi-channel lock-in. A 16 channel, high-frequency lock-in array (e.g., chip AD8333 Analog Devices) can be included. Various gain and filtering stages for each channel can also be used. The phase with respect to the modulation and gain could be adjusted for all channels simultaneously and the output could be read with the 16 remaining channels of the DAQ. The output bandwidth of the final low-pass filter could be matched to the maximal acquisition rate to maximize sensitivity and avoid blur. Finally to minimize electronic noise, each channel of the photodiode could be amplified with a trans-impedance amplifier (e.g., National Devices, LMH6624) with a 500 Ohm resistor. With 5 mW optical power on each diode element, the minimal noise (e.g. shot-noise for long averaging times) could be at or close to −163 dBc/Hz or at or close to −112 dBm for (e.g., 1 kHz) RBW. Shot-noise limited sensitivity could also be achievable with such a circuit as has been achieved using a single element InGaAs diode (e.g., Thorlabs, FGA10).

The performance of the multichannel lock-in amplifier in acquisition speed, linearity and dynamic range can be measured with a two-channel function generator and RF attenuation filters. Single-photon sensitivity of the PMT's and close to shot-noise limited performance of the photodiode array can be measured with a thermal light source and optical band pass filters. In another aspect of this example, high-speed sorting can be performed in the absence of the multichannel lock-in amplifier and would be based on multiplex CARS and the performance of the system could be determined.

In this aspect of the example, a 16-channel lock-in detector array can be interfaced with a trans-impedance amplified InGaAs photodiode array for high-frequency demodulation (e.g., greater than 1 MHz), high-speed output (e.g., greater than 100 kS/s), and high sensitivity (e.g. within a range of 10 dB of theoretical shot noise) and could demonstrate 16-channel PMT acquisition with single photon sensitivity.

The acquisition speed, sensitivity and specificity of the CRS flow cytometer system could also be characterized. The performance of the assembled CRS flow-cytometer can be quantified in sample solutions of beads (e.g., 10 μm), which can be compared to the size of a cell (e.g., a prokaryotic or eukaryotic). SNR at various sampling speeds can be determined for polystyrene for both CARS and SRS. FIG. 2 shows chemical selectivity mixtures of beads of the three typically used materials polystyrene, melamine and PMMA (e.g., Microspheres Nanospheres, Inc.), which have overlapping Raman spectra in the CH-region. Measured populations can be compared with the concentration ratios of the mixture. Spectral unmixing can be performed and might be used to determine whether CARS or SRS should form the basis of the detection system.

### Example 2

### CRS Flow Cytometry—Spectral Calibration

This example describes a protocol for spectral calibration for systems and methods of the present invention. For example, the calibration protocol can be used for calibrating a CRS flow cytometer system described herein. Example calibration protocols are described below.

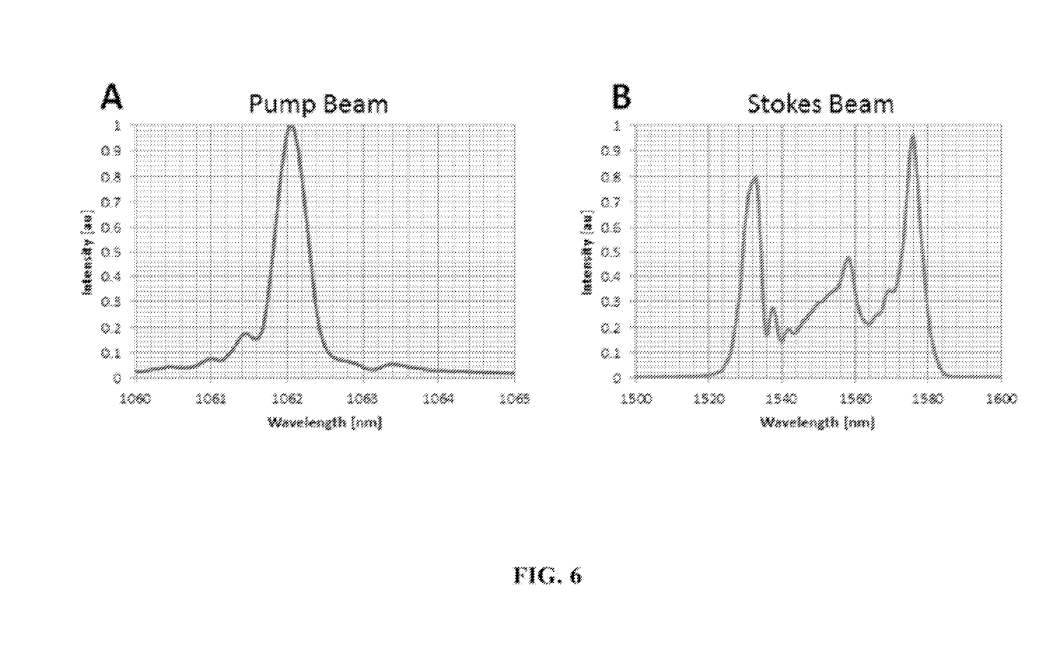

FIGS. 6A & 6B show the spectra of the excitation lasers for multiplex CRS. In some aspects of the present invention, the bandwidth of the Stokes beam can be generated by spectral broadening of a femtosecond input beam due to SPM during amplification. SPM may result in a non-uniform spectral coverage (I_{Stokes}(λ)≠const.). A strong signal in the wings can be desirable as the SPM-broadened output is usually chirped (e.g., different wavelengths are present in the focus at different times). The narrowband beam can be unchirped and can be close to Gaussian. To maximize the signal and minimize sample damage, it may be desirable to match the pulse duration of the two excitation beams. The spectral components of the broadband spectrum interact differently with the narrowband pulse. In particular, the red and blue edges might have a weaker interaction than the center of the broadband spectrum, as the narrowband pulse energy is rising and decaying during the overlap of the two beams. It can be advantageous to produce a broadband spectrum with higher intensity and relatively higher intensity on the spectral edges than in the middle (e.g., in the wings). SPM broadening may provide a means to produce such a spectrum.

Another aspect of this example could be to amplify the beam with minimal broadening and then launch it into an undoped non-linear fiber to create the bandwidth by the same mechanism. For multiplex CRS, one of the pump and the Stokes beams may need to be broadband and the other narrowband, but the order can be reversed.

Overall this can result in non-uniform excitation of different Raman signals σ(Δλ=λₚᵤₘₚ−λ_{Stokes}) and thus the CRS signal (I_{Stokes}(λ_{Stokes})·σ(Δλ)). To extract only the Raman information, σ(Δλ), which carries the desired chemical information, calibration for the excitation spectra could be required. A further challenge is that the excitation spectrum can change over time due to stress and heat induced birefringence in the fiber. Regular updating of the spectral calibration may be desired.

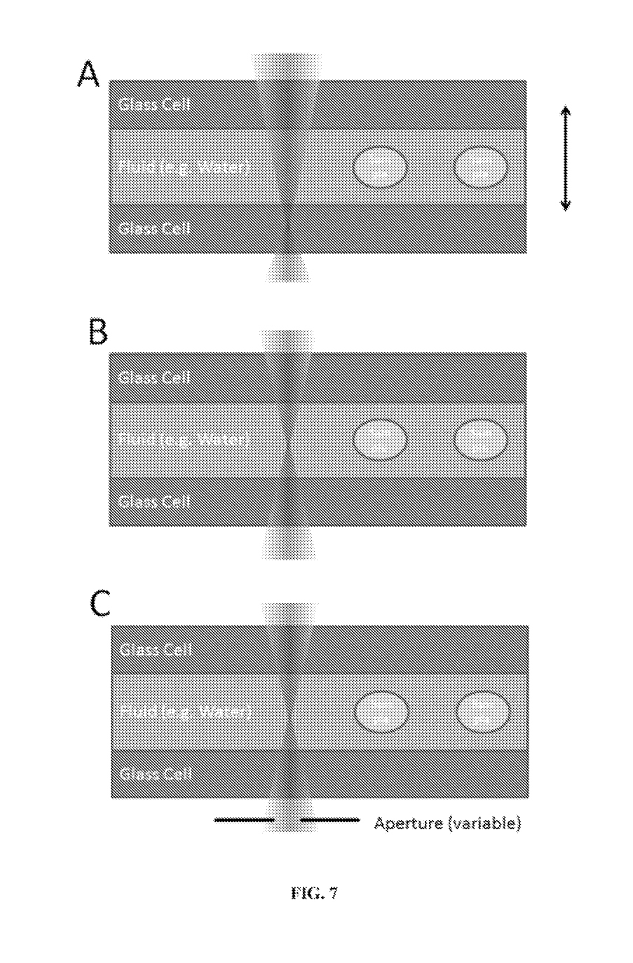

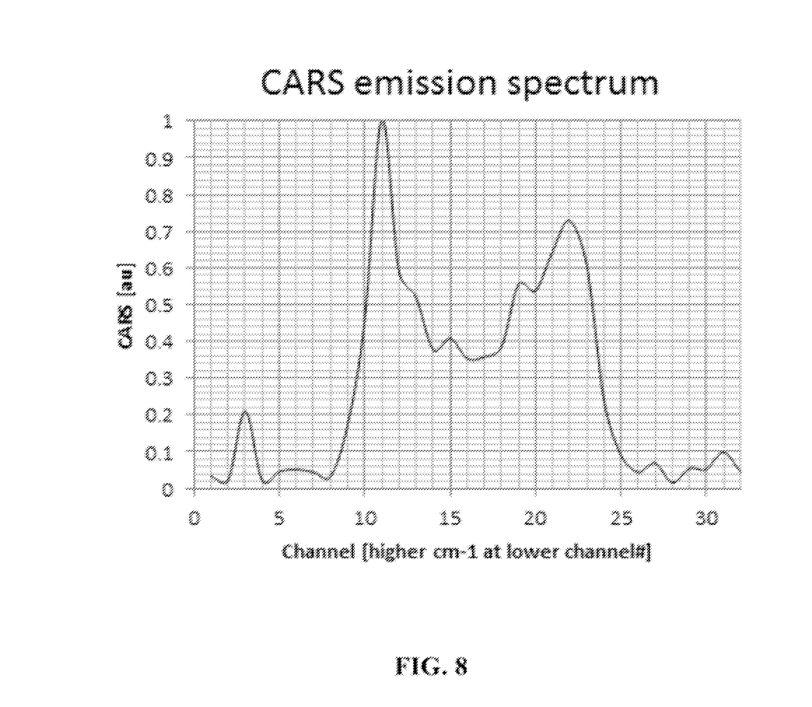

One example calibration protocol can use material in the flow cell of a flow cytometer system. Instead of focusing into the flow channel of a flow cytometer system, the focus can be moved into the material of the flow cell (e.g. glass) by (a) a motorized objective, (b) a motorized sample holder, or (c) changing the input divergence into the objective lens (FIG. 7A). The generated spectral output can be used as a static calibration. Measurements can be repeated as often as needed to provide a dynamic calibration. The material may or may not be Raman active in the desired spectral region (e.g. glass has no Raman signal in the high-wavenumber region). Materials that are not Raman active may still generate a non-resonant background signal, which is typically spectrally flat as desired for calibration. FIG. 8 shows the experimental results of a CARS spectrum recorded from the glass for the flow cell, which can be used for spectral calibration.

Alternatively, the fluid in-between the samples (e.g. water) can be used for spectral calibration (FIG. 7B). This provides a continuous calibration as the sample loading density is <100%. It may be desirable to use a fluid that is not Raman active in the desired spectral region (e.g. deuterated water) and use the spectrally flat non-resonant background for calibration.

In addition, SRS does not have a non-resonant background signal and materials that are not Raman active would not provide sufficient signal. It is however possible to introduce such a system by closing an aperture on the detection arm. This allows generation of a cross-phase modulation (XPM) or a thermal lensing (TL) signal in materials that are not Raman active. Such signals can also be used for calibration.

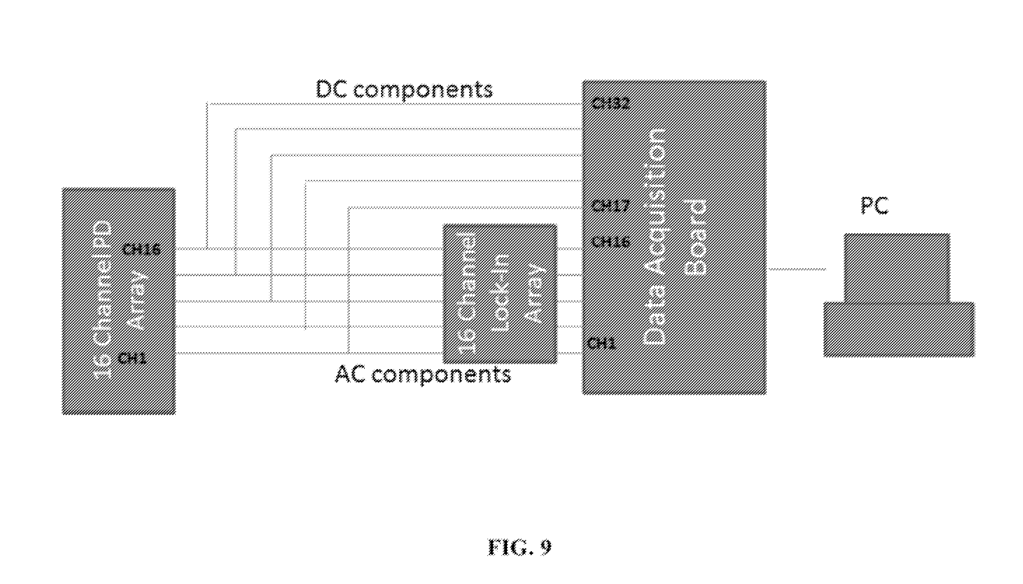

For SRS is it also possible to provide real-time spectral calibration by recording the unmodulated DC signal of the dispersed broadband light (FIG. 9). Typically the SRS signal is generated and detected at high-frequency (e.g. 10 MHz), where the laser noise is low. The AC and DC signals can be separated and detected simultaneously to provide real-time calibration.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### Example 3

### CRS Flow Cytometry—Prototype System & Results

A prototype system was designed and developed to demonstrate proof-of-concept for a high-speed Raman spectroscopy platform based on multiplex CRS. While spontaneous Raman scattering is highly specific and allows for single-cell measurements, the major disadvantage is that the signal is extremely weak and long averaging times are required to obtain high signal-to-noise ratio (SNR) spectra (e.g., 10 seconds per cell). This renders a spontaneous Raman scattering-based flow cytometer or cell sorter impractical. In CRS, the sample is excited with two laser beams with a difference frequency tuned to match a particular vibration of the sample. Such coherent excitation of a targeted vibration results in a large increase in signal, by >10,000× compared spontaneous Raman scattering.

Most implementations of CRS microscopy have been based on narrowband CRS using two narrowband lasers to target a particular Raman vibration; different Raman bands can be addressed by tuning the difference frequency. While ideal for beam-scanning microscopy to maximize sensitivity for desired vibrational frequencies, such an approach is impractical for cytometry due to the time required to re-tune the lasers. This example illustrates one of our approaches that is based on multiplex CRS, in which a Stokes beam is broadband and multiple vibrations are excited simultaneously.

The results of this example demonstrate the use of a high-speed Raman spectroscopy platform based on multiplex CRS. In particular, we have
(a) developed an optically synchronized dual-color multiplex CRS laser system with a narrowband pump beam (1070 nm center frequency and 1.2 nm bandwidth) and broadband Stokes beam (1530 nm to 1590 nm frequency range) to cover the high wavenumber region of Raman spectra (2800 cm-1 to 3050 cm-1) with >50 mW average power of in each beam at 8 MHz repetition rate;
(b) developed a 16-channel lock-in detector array interfaced with a trans-impedance amplified InGaAs photodiode array for high-frequency demodulation (>1 MHz), high-speed output (>100 kS/s), and high sensitivity (within 10 dB of theoretical shot noise) and demonstrate 16-channel PMT acquisition with single photon sensitivity; and
(c) developed a high-throughput flow cytometer based on multiplexed CARS and SRS with a 10 μm focal spot and demonstrate a spectral acquisition rate of 10,000 spectra/s in bead samples with a SNR of 10. Determine whether CARS or SRS achieves better detection sensitivity and specificity to distinguish the three chemical species with overlapping Raman spectra (polystyrene, melamine and PMMA).

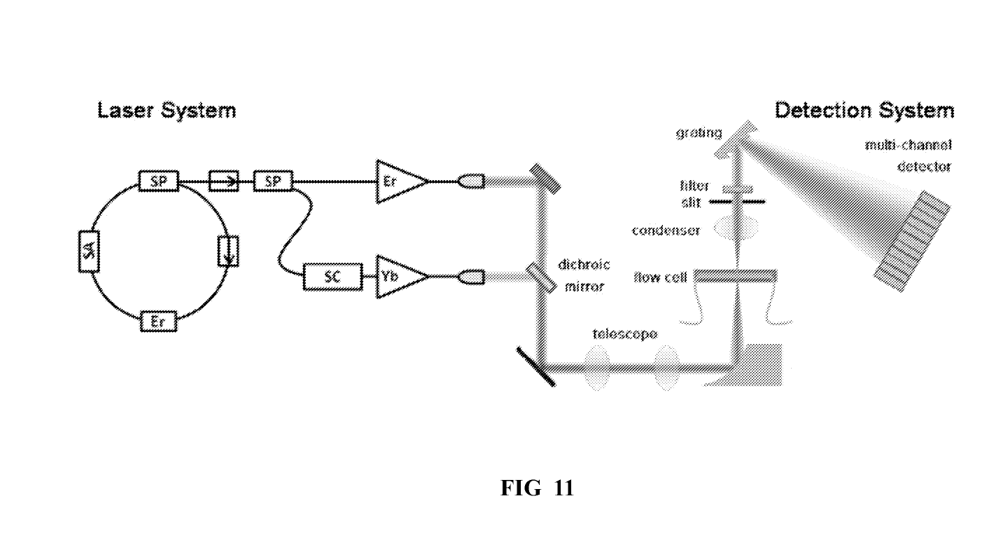

A schematic of the prototype CRS cytometer system developed for this experiment is shown in FIG. 11. It consists of a fiber laser specifically designed for multiplex CRS, the beam-routing system, and the detection spectrometer. Each of the elements are described and characterized in detail in the following sections.

### Laser System

A major challenge for developing a practical, high-speed CRS-based flow cytometer is to design a robust and low-cost laser system, as CRS requires two tightly synchronized ultra-short pulse trains at different wavelengths. The dual-wavelength laser platform developed for use in the prototype cytometer utilizes optical synchronization of Er- and Yb-doped fiber amplifiers. The difference frequency of these two common fiber gain media allows access to the high wavenumber region (2750 cm-1 to 3400 cm-1) of Raman spectra where most of CRS is performed. As illustrated, fiber components can be assembled into a complex laser system in a process called fusion splicing.

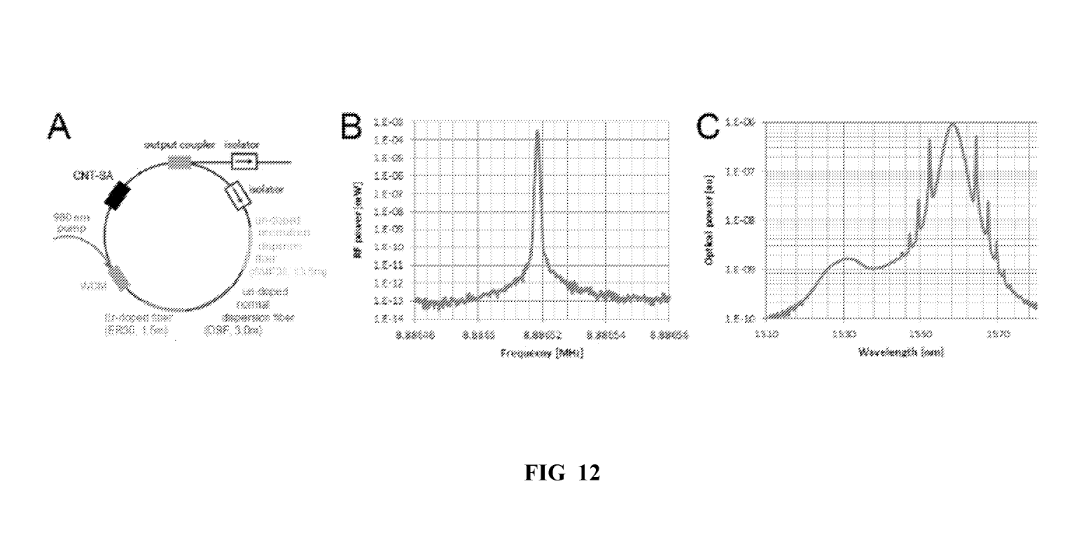

The low repetition-rate oscillator is based on a femtosecond (fs) fiber oscillator (FIG. 12A) that is mode-locked using a carbon nanotube saturable absorber (SA). The laser repetition rate was adjusted by varying the length of fiber in the ring cavity. Previous systems optimized for high-speed CRS microscopy with a high numerical aperture (NA) objective lens worked at ˜80 MHz. In order to increase power density we succeeded in assembling a fiber laser system at about 8 MHz repetition rate, which allowed an increase in the laser duty cycle factor and thus peak power of the amplified output by ˜10×. To achieve this reduction of the repetition rate, ˜16.5 m of un-doped single-mode fiber (SMF) was spliced into the laser cavity. Initially, the operation was unstable with a narrow spectral output, caused by the very high anomalous dispersion of the laser cavity. This problem was overcome by replacing 3 m of standard SMF with dispersion-shifted fiber (DSF).

FIG. 12B shows the RF spectrum of the laser repetition rate at 8.9 MHz. The oscillator is self-starting and the nine orders of magnitude difference from the repetition peak to the background are an indication of stable mode locking. In this configuration the average output power was 1.5 mW with a center wavelength of 1557 nm and optical bandwidth of 12.2 nm (FIG. 12C), consistent with a femtosecond pulse duration. The wings in the optical spectrum are a hallmark of soliton mode locking.

To provide the optical synchronization between the pump and Stokes beams for CRS, the output of the oscillator was split into two arms: The first arm was directly amplified to provide the Stokes beam; the second arm provided the pump beam by frequency-shifting into the Yb gain range using a broadband super continuum (SC). This enabled implementation of multiplex CRS for the high wavenumber region of Raman spectra (2800 cm-1 to 3050 cm-1) with a narrowband pump beam (1070 nm center frequency and 1.2 nm bandwidth) and broadband Stokes beam (1530 nm to 1590 nm frequency range).

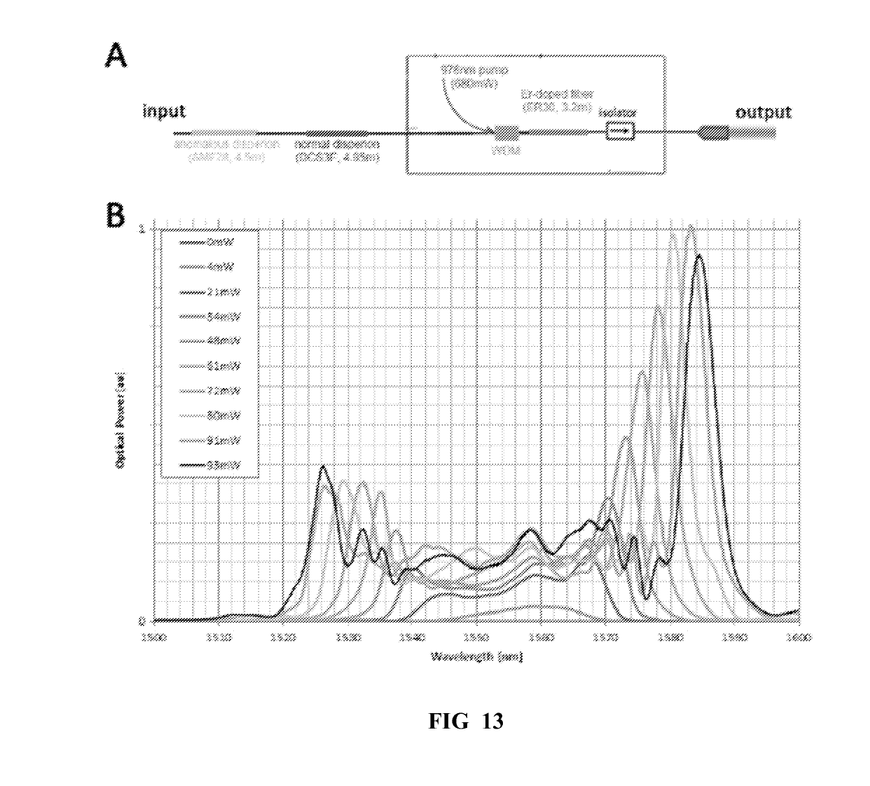

Er-doped amplifier for the broadband Stokes beam. A gain fiber with a small core and normal dispersion (Liekki, Er30-4) was used to implement the Er-doped power amplifier (FIG. 13A). This resulted in strong spectral broadening of the input pulse due to self-phase modulation (SPM). While SPM is usually an unwanted side effect in fiber lasers, it was used to advantage in this case to generate the bandwidth required for the broadband Stokes beam. FIG. 13B shows the output bandwidth as a function of output power (determined by pump power). When the seed from the oscillator was directly spliced onto the Er-doped amplifier, the bandwidth became too large for this specific application (data not shown). Addition of an un-doped normal dispersion fiber (DCF) before the amplifier was used to pre-chirp the input pulses and decrease the peak power. By carefully adjusting the length of the pre-chirp fibers, the targeted frequency range of 60 nm from 1525 nm to 1585 nm at the maximum output power of the amplifier of 93 mW was achieved (FIG. 13B). Given this bandwidth, a pump beam at 1062 nm was selected to achieve Raman coverage from 2850 to 3100 cm-1. In this case the anti-Stokes emission was from 798.5 to 814.5 nm.

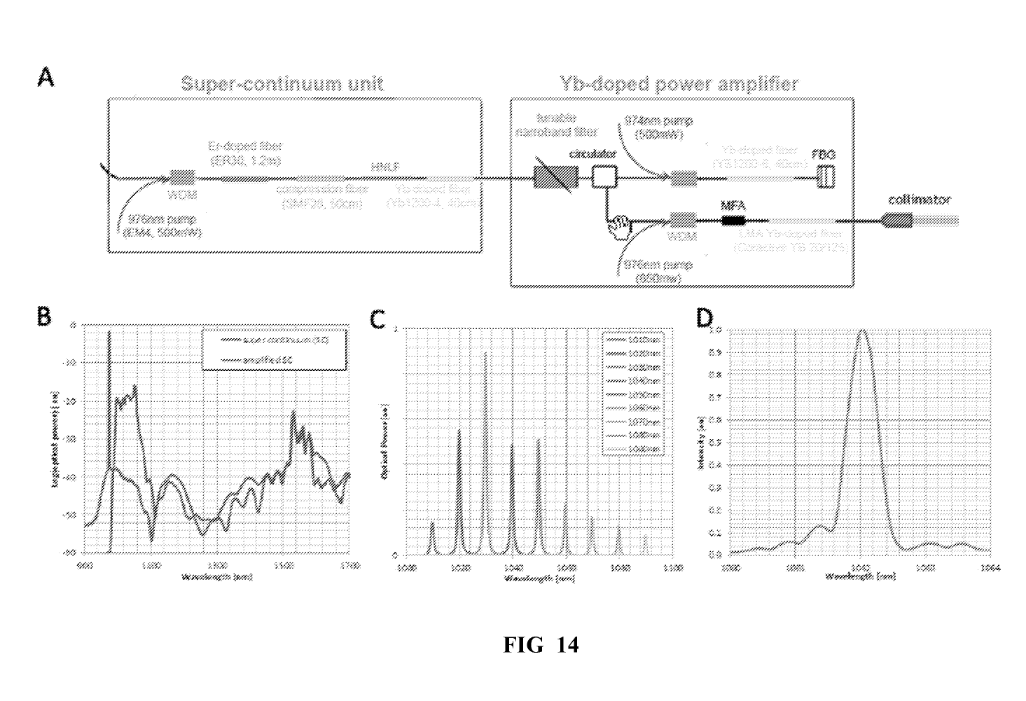

Super-continuum (SC) and Yb-doped amplifier for the narrowband pump beam. The all-fiber implementation of the SC unit followed designs that are known in the art for operation at higher repetition rates and was based on a highly-nonlinear fiber (HNLF) that was directly spliced onto the input fiber (FIG. 14A). Despite the large core-size mismatch between the input and the HLNF, a low loss splice (<1 dB) can be achieved. Further, low-noise SC can be achieved by the use of a short piece of HNLF (˜5 cm) to avoid pulse break-up. To achieve large spectral broadening, the seed from the splitter was first amplified with a normal dispersion Er-doped amplifier and then passed through an un-doped anomalous dispersion fiber to temporally compress the pulses at the input of the HNLF for maximum peak power. By carefully adjusting the length of the compression fiber, a spectral output from 950 nm to >1700 nm (FIG. 14B, blue) was achieved. By reducing the length of the Er-doped gain fiber, a significant proportion of the pump light at 980 nm leaked through the HNLF to further pump an Yb-doped pre-amplifier that is directly spliced to the HNLF and provided a synchronized, amplified and broadband output from 1010 nm to 1080 nm (FIG. 14B, red). Finally, a tunable narrowband filter (Agiltron Inc.) was used to provide narrowband output over this entire range (FIG. 14C).

The prototype system made use of a pump beam at 1062 nm. In order to exceed 50 mW of average power, the low-power seed had to be amplified after filtering. As shown in FIG. 14C, 1062 nm is at the red edge of the ytterbium gain bandwidth, and amplified spontaneous emission (ASE) at the gain peak (1020-1030 nm) becomes a considerable concern, especially at the low repetition rate of 8.9 MHz. To overcome this problem, we have designed and optimized a multi-stage amplifier system (FIG. 14A) that includes a fiber Bragg grating (FBG) to suppress ASE between gain stages.

Self-phase modulation (SPM) was used to broaden the Stokes spectrum. SPM has the limitation that it increases the spectral bandwidth for the narrowband amplifier and thus degrades the spectral resolution. To overcome this problem, the final stage of the amplifier is based on the use of a large mode area (LMA) gain fiber. Initial studies made use of core pumping of the LMA fiber, which was unsatisfactory (gain <5×). Therefore the design was modified to utilize cladding pumping with a double clad fiber and a high power (9 W) multimode pump diode.

FIG. 14D shows the 1062 nm output at 50 mW average output power. The bandwidth/resolution was ˜0.53 nm. There was minimal SPM broadening and ASE, and the average power could likely have been increased by another 4× if the pump diode was operated at full power and the length of the gain fiber was correspondingly adjusted. Such modifications can be done, especially if temperature feedback of the pump laser is provided to maintain the pump wavelength of ˜976 nm.

### Characterization of Pulse Duration and Timing Jitter:

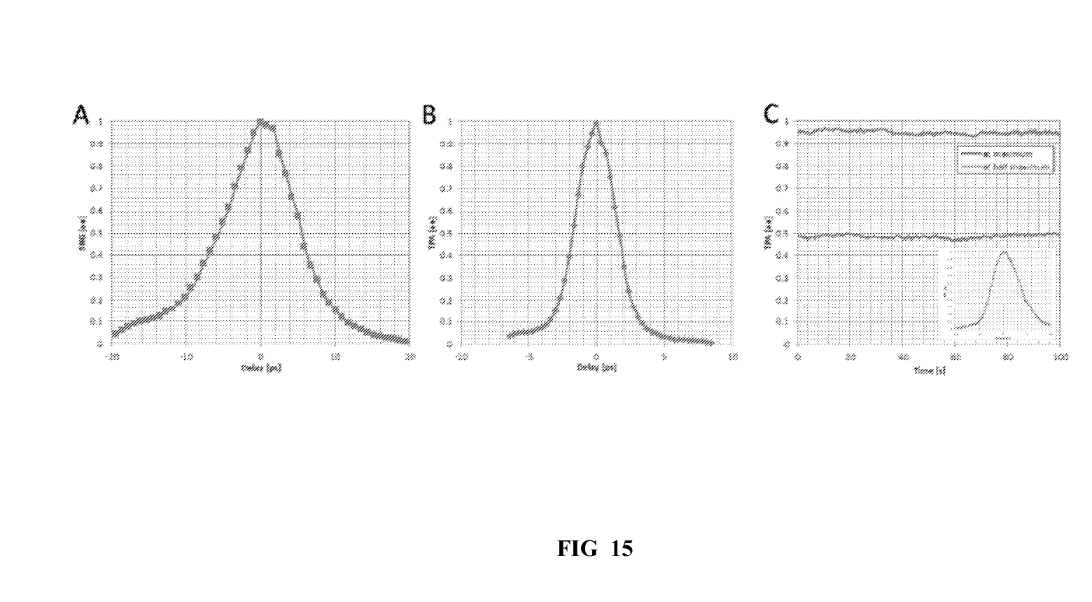

The output pulse properties were fully characterized (FIG. 15) using a home-built auto-correlator with a trans-impedance amplified GaAsP photodiode (Hamamatsu Inc.). The pulse durations of the pump and Stokes pulses were 8.1 ps and 2.4 ps, respectively (FIGS. 15A and 15B). For the broadband Stokes, this means that the output was highly chirped. Such chirping can be advantageous to minimize non-linear photo-damage without sacrificing signal. In this setting, it is, however, also desirable that the Stokes pulses are about 3× shorter than the pump pulses, so that all spectral components interact approximately evenly despite the Gaussian temporal profile.

The time-bandwidth product of the narrowband pump pulses was 1.1, which is ˜about 2.5× time the transform limit. Dispersion management can be implemented to achieve a transform-limited output of the pump pulses and increase signal by about the same factor.

FIG. 15C shows the sum-frequency signal of the two pulse trains at the full and half maximum of the cross-correction over a duration of 100 s. Based on the standard deviation and slope of the cross-correlation at the half maximum, the timing jitter is estimated to be <36 fs, which is much smaller than the pulse durations. Therefore, the dual-wavelength laser platform provided a highly synchronized pair of laser beams. Qualitatively, low jitter was witnessed by the fact that long-term experiments outlined below could be carried out without adjusting the time overlap of the pulses.

### Beam-Routing and Detection Systems

Beam-routing and spectrometer. FIG. 11 shows the rest of the optical setup. Fiber outputs were collimated with lenses to approximately equivalent diameters and spatially overlapped with a dichroic mirror. Time overlap was adjusted with a delay stage. A rough delay was produced by splicing additional un-doped fiber before the Er-doped power amplifier (FIG. 13A). Initially, an achromatic 40 mm lens (Thorlabs, AC254-040-C-ML) was used to focus the excitation beams into a basic flow cell. However, the chromatic focal shift from 1062 nm to 1550 nm is ˜270 μm, which is much longer than the focal extension of each beam. To mediate this problem, an off-axis parabolic mirror was used, which is intrinsically wavelength independent. Alternatively, custom-made chromatically corrected lenses at these wavelengths can be used. A telescope was used to adjust the input beam size and determine a lateral resolution of 7-8 μm (data not shown) by scanning the beams over a calibration target (Thorlabs Inc., R1L3S3P), which corresponded to an excitation numerical aperture (NA) of ˜0.12. Axial resolution, which increases with 1/NA², was measured to be 45-50 μm by recording the CRS signal over a z-profile of an oil film.

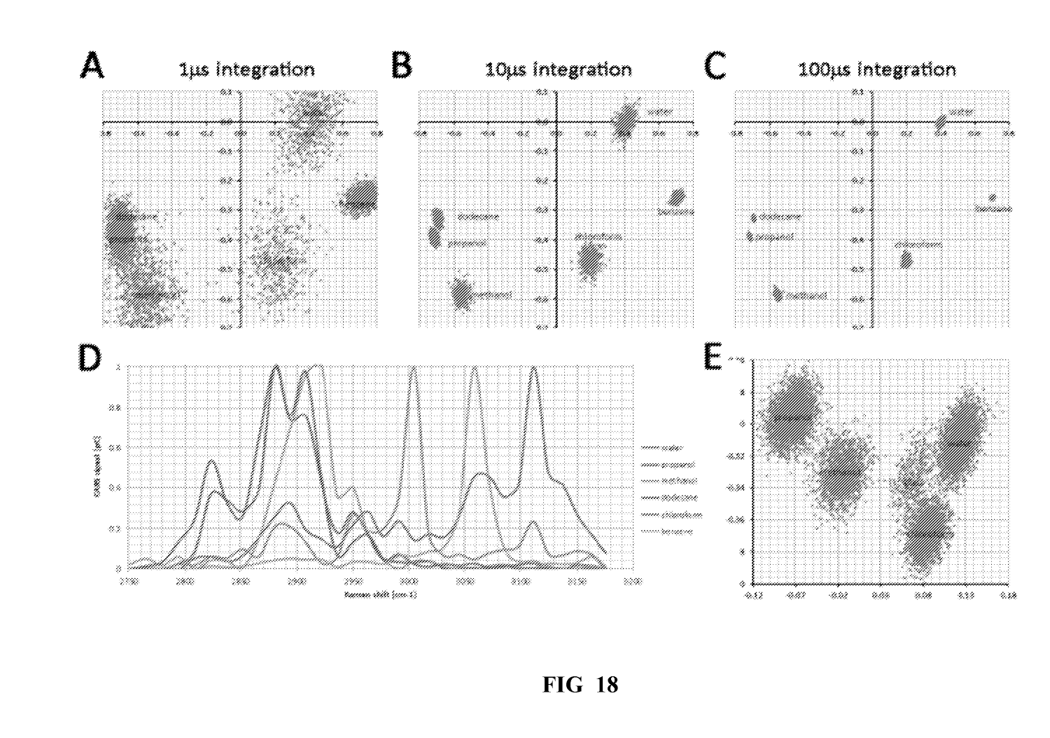

The transmitted signal was collected with a condenser, filtered with a high-OD optical filter and aligned into a home-built spectrometer consisting of a blazed grating, fold mirrors (to provide a focal length of up to ˜1 m), and a multi-channel detector (see below). Because the CARS signal is too weak to be detected by eye (or IR card/viewer), the second harmonic of the broadband 1550 nm beam (PPLN crystal, Covesion Ltd) was used for alignment, which happens to be close to the anti-Stokes range. The throughput of the spectrometer system was about 30-40%. The position of the condenser was adjusted to minimize the spot-size on the array detector and maximize resolution. Despite the minimalistic approach (no slit, 4-f imaging geometry, or stray light suppression), single pixel spectral resolution was demonstrated (see FIG. 18D). The complete system was housed in a light-tight box to eliminate room-light background.

### Detector:

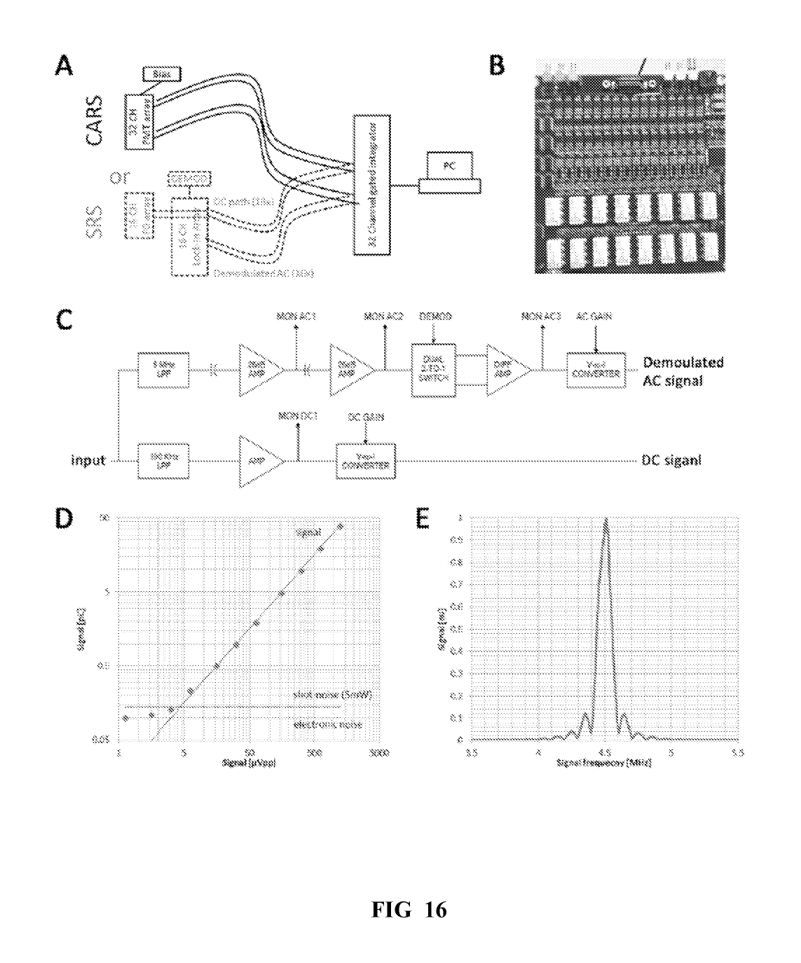

A recent advance in CRS microscopy was the development of stimulated Raman scattering (SRS) microscopy. SRS is excited under the same illumination conditions as coherent anti-Stokes Raman scattering (CARS), but differs in the means of detection. CARS is similar to fluorescence in that the emission is detected at a wavelength different from that of the excitation beams (the anti-Stokes wavelength). SRS resembles absorption in that the loss (gain) of intensity of the excitation pump beam (Stokes beam) is measured in the presence of the Stokes beam (pump beam) for stimulated Raman loss (stimulated Raman gain). While highly sensitive, SRS detection requires extracting the relatively small signal from the laser background with a high-frequency phase-sensitive detection scheme (lock-in detection). SRS provides advantages in microscopy: excitation spectra are identical to those of well-document spontaneous Raman spectra), the signal is linearly dependent on the concentration of the target species, and phase-matching is automatic. Thus, we developed both CARS and SRS detection systems and compared them (FIG. 16A), in particular with respect to sensitivity and specificity in flow-cytometry.

CARS detection was achieved by acquiring the fluorescence-like emission at the anti-Stokes frequency with a highly sensitive photo-multiplier tube (PMT) array (Hamamatsu, H7260-20). The prototype system made use of 32-channel PMT array to increase the spectral resolution of the laser/spectrometer. The cable at the acquisition system was switched when switching between CARS and SRS mode operation (FIG. 16A). The acquisition system was a 16-bit gated integrator with 100 ns resolution and a maximum trigger rate of 150 kHz, which can be increased to 390 kHz, if needed. The data presented below demonstrates that “shot-noise limited” sensitivity was demonstrated at this sampling speed.

For SRS detection, a multi-channel lock-in array was developed in collaboration with (FIG. 16B) that interfaced with a 16-channel InGaAs photo-diode (PD) array (Hamamatsu, G7150-16). The output of each PD element (FIG. 16A) was split into an AC (includes the modulated SRS signal) and a DC component, providing a real-time spectral calibration and scattering compensation, and the signal pairs were read simultaneously taking advantage of the 32-channel acquisition system. FIG. 16C shows a detailed schematic of a single channel. In the AC path, the input was filtered with a 4.7 MHz low-pass filter (Minicircuits, SCLF-4.7) to suppress the laser repetition rate (˜63 dB suppression at 8 MHz) and amplified in two 26 dB gain stages. The demodulation frequency was provided by an external reference (e.g., function generator). The maximum detection frequency was determined by the specific low-pass filter. Demodulation was achieved with two switches (Analog Devices Inc., ADG719) that were driven 180 degrees out-of-phase from the reference input and fed into the two arms of a differential amplifier, respectively. The output was then fed into a voltage-controllable voltage-to-current converter that interfaced with the gated integrator of the data acquisition system. The total gain of the system was designed such that the expected shot-noise from a 5 mW input (˜163 dBm/Hz) at long averaging times (1 kHz BW) was at about 6 dB of the lowest bit of the 16-bit (96 dB) acquisition system.

FIG. 16D shows the linearity of the system over a large input range of a 4.5 MHz electric signal (sine wave) at 10 μs integration time. As a reference, the shot-noise floor from a shot-noise limited laser source (APE Berlin, PicoEmereald) was measured at 925 nm. With 5 mW average power per PD element, the shot-noise to electric-noise ratio was 1.8 (i.e., −5 db as designed), demonstrating noise within 10 dB of theoretical shot noise. The channel cross-talk (data not shown) was 0.33%. The detection bandwidth around the demodulation frequency of 4.5 MHz was set by the integration time of the gated integrator. In FIG. 16E it was set to 10 μs and had bandwidth of 100 kHz.

Thus, the lock-in array developed demonstrated high-frequency demodulation (>1 MHz), high-speed output (>100 kS/s), and high sensitivity (within 10 dB of theoretical shot noise).

### Performance:

Raman scattering is well established as an analytical chemistry technique that provides label-free, chemically-specific detection. primary major motivation for switching to CRS from spontaneous Raman is sampling speed. The results described below are thus focused on characterization of sensitivity, specificity, and speed of the newly developed instrument using well characterized samples such as beads or simple fluids.

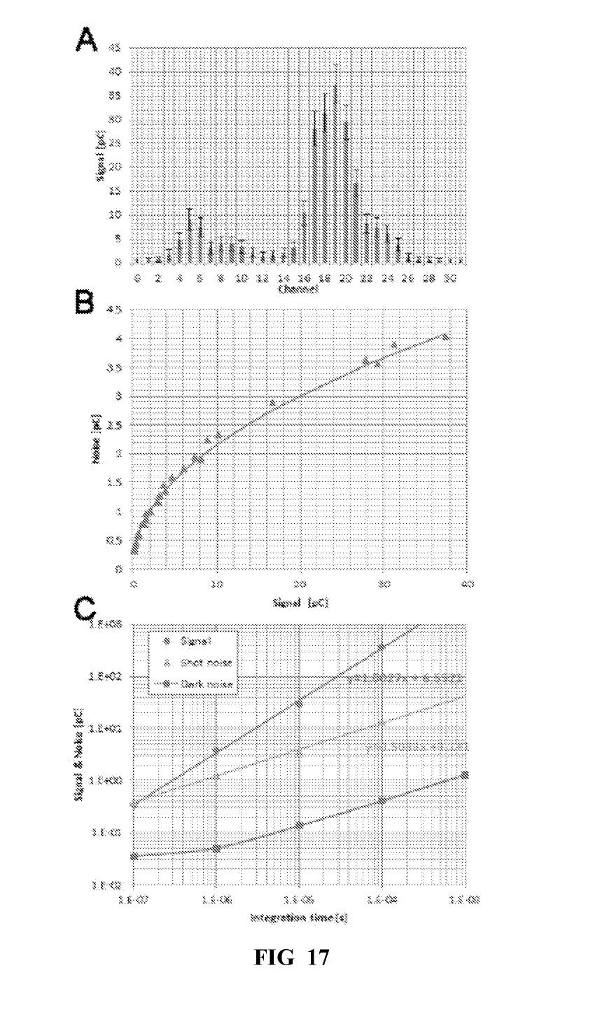

Measurements of single channel sensitivity (FIG. 17) were used to characterize the system at high acquisition speeds, and then extended to determine how this translates into capability for distinguishing different chemicals at high data acquisition speeds (FIG. 18).

### Sensitivity:

FIG. 17A shows a CARS spectrum of a 10 μm PMMA bead (Microsphere-Nanosphere Inc., C-PMMA-10.0) at an integration time of 10 μs, i.e. at an effective sampling rate of 100,000 spectra/s. The integrated signal over all 32 channels was 230 pC, which corresponds to an optical signal of 0.46 nW, assuming 50 mA/W sensitivity and 1,000,000 gain at −800 V bias. The error bars in FIG. 17A are ± the standard deviation over 1000 spectra.

FIG. 17B plots the noise of each channel as a function of average signal. A square-root dependence was shown, characteristic of a shot-noise limited signal. The signal-to-noise ratio (SNR) was about 8.3 at an integration time of 10 μS.

FIG. 17C plots the peak signal and its noise as a function of the integration time. As expected the signal had a linear dependence, and the noise a square-root dependence on the integration time. Overall this results in a square-root dependence of the SNR, with a crossing point of about 0.8 at 100 ns. At all times, the noise was more than an order of magnitude higher than the dark-noise of the system (no excitation beams), further confirming shot-noise as its origin.

In conclusion, the prototype CRS system demonstrated “shot-noise limited detection sensitivity” and demonstrated a spectral acquisition rate of 10,000 spectra/s in bead samples with a SNR of 10. In fact, this SNR was achieved at a 10× higher acquisition speed of 100,000 spectra/s and twice as many detection channels as originally proposed.

### Specificity:

To demonstrate chemical specificity, flow-cell experiments were performed that allowed quick exchange of different chemicals (water, methanol, propanol, dodecane, chloroform, and benzene), which have specific Raman spectra with overlapping bands in the high-wavenumber region (FIG. 18D).

In order to present the data in the conventional manner for flow cytometry, the 32-dimensional spectral information was compressed into a simple 2-dimensional population plot (FIGS. 18A-C and E), in which each point represents a spectrum. The compression uses a technique called phasor-analysis, wherein each spectral point is plotted in polar coordinates that represent the phase and magnitude of the Fourier transform of the spectral data at a frequency defined by the inverse of the number of pixels. Because the Fourier transform is normalized by the total signal, the phasor point is independent of the total signal and only represents spectral features. The phase angle represents the position of the peak, and the radius represents the peak width. Phasor plots have the additional feature that the point representing a mixture of two chemical species lies on a line between the points representing the two pure specimens.

FIG. 18A to C were acquired in a home-made flow cell made from two cover slides and a 110 μm thick spacer (Grace Biolabs, Inc.) at different integration times from 1 μs to 100 μs (i.e., effective spectral acquisition rates from 1,000,000 spectra/s to 10,000 spectra/s). Molecular species were separated at even the highest acquisition rates. The peaks narrow with longer integration times, thereby providing for better selectivity. It can be seen that species with stronger Raman cross-sections (e.g., propanol, dodecane, or benzene) form sharper peaks than species with weaker cross-sections (e.g. water, methanol, or chloroform). This was consistent with shot-noise limited detection sensitivity.

FIG. 18E was acquired with 100 μs integration time in a glass flow cell with a 14 μm channel height (Micronit Ltd.) to demonstrate performance with smaller sample volumes resembling the size of cells. Chemical species were well separated at acquisition rates of 10,000 spectra/s. In this case there was an additional peak formed by the glass of the flow cell, as a portion of the focal extension coincides with the material of the flow cell. Even though glass is not Raman active in the high wavenumber region, it generated a CARS signal due to the electronic response, which is known as non-resonant background. While usually unwanted, this can be used to advantage to provide continuous spectral calibration for increased long-term stability of the system. The chemical signal was then the coherent mixing terms of this non-resonant signal and the vibrationally resonant signal, which linearizes the concentration dependence. As a consequence it can be seen that the width of all peaks became similar independent of the Raman cross-section. By adjusting the axial and lateral resolution, it is possible to change the relative strength and further improve sensitivity.

In conclusion, a phasor-analysis routine was developed to analyze and display the flow cytometry data collected using the prototype CRS system, and the data clearly demonstrated system specificity sufficient to distinguish between three chemical species with overlapping Raman spectra at a spectral acquisition rate of 10,000 spectra/s.

### Additional Features:

Further additional features to the CRS system may be utilized. The 32-channel data acquisition system was further equipped with an external trigger input with variable gate length. It is possible to take advantage of this feature and use linear light scattering with a CW laser to generate a trigger signal for each particle. This would facilitate maximizing throughput and sensitivity of the system.

Similarly, the spectrometer used in the prototype system was of a very basic design. For improved performance with scattering samples moving at high rates, careful optical design, including incorporation of a slit and optics to image the slit onto the multi-channel detector, would improve system performance.

One anticipated limitation of the prototype system as implemented was relatively lower long-term and environmental stability due to the use of non-polarization maintaining (PM) components. The use of the non-polarization maintaining (PM) components necessitated adjustment of the polarization state 30 min to maintain maximum signal in this experimental set-up. Use of polarization maintaining (PM) components would improve stability further.

Although, the overall SRS performance was much worse than that for CARS detection because the broadband fiber laser source had significant high-frequency white noise (data not shown), this is not expected to be a fundamental problem, and should be circumvented by a combination of PM design, spectral broadening of the Stokes beam in a short piece of HNLF rather than several meters of Er-doped gain fiber, and/or by implementation of auto-balanced detection. Importantly, CARS is not affected by high-frequency laser noise per se, but only the integrated noise, which in general is much lower for fiber lasers than for free-space lasers.

Additionally, implementation of a user interface with built-in analysis routines and a database of Raman spectra (e.g. from Biolabs Inc) can be implemented for computerized operation and analysis. Such routines can include phase-retrieval algorithms to extract the exact spontaneous Raman spectra from the CARS information.

The sensitivity and speed demonstrated in the prototype CRS system were not at any fundamental limit. Removing the chirp of the pump beam would increase the signal by about 2.5×. Additionally, use of a PMT array based on a GaAs cathode would increase the responsiveness at 800 nm from 50 mA/W to 90 mA/W and increase signal by the same factor. Use of a cylindrical telescope to change the shape of the input beams (focal shaping) would generate a focus that is low-NA in the direction perpendicular to the flow (as desired for homogeneous sampling) but high-NA in the direction parallel to the flow. This would allow a reduction of the axial focal extension and thus an increase in signal and reduction in background by the same factor.

### Example 4

### Low-Resolution Imaging System

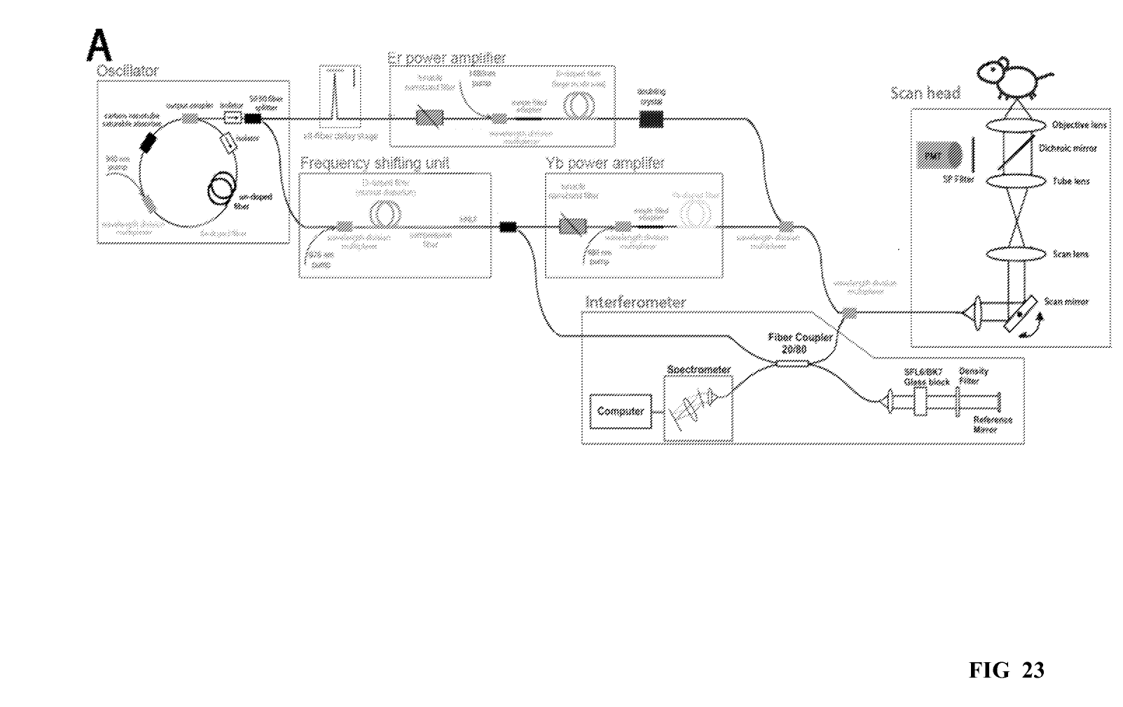

FIG. 23. is a schematic of a large field of view chemical imaging with a low-resolution CRS imaging system. The upper portion shows an all-fiber laser system based on optical synchronization of an Er power amplifier and Yb power amplifier using a frequency shifting unit. The system starts with an Er-doped fiber oscillator that is then split into a first and second input train of pulses. The first input train of pulses can be amplified and/or spectrally broadened (not shown) and is then filtered with a fixed or tunable filter. The power is then scaled in a power amplifier that consists of a Er-doped fiber gain medium that can be optically pumped (e.g. at 1480 nm). The output is then frequency doubled in a PPLN crystal to provide the first train of pulses. The second input train of pulses is used to generate a broadband super-continuum (SC) by pumping a short piece of highly nonlinear fiber (HNLF), which substituted, in the alternative, with a photonic crystal fiber (PCF) with high peak power pulses. Typically the output spans from at least 1000 nm to at least 2000 nm. This provides a broad-band optical clock that is locked to the fiber oscillator. A fixed or tunable filter can select a narrowband portion of the SC that can then be amplified in a Yb- or frequency-doubled Tm-doped fiber amplifier system to provide the second train of pulses. Both first and second train of pulses can be combined into a single output fiber and the time delay can be adjusted with a fiber-coupled delay stage such that the pulses overlap in time and space at the sample.

The laser system can be coupled to a scan head that includes a means for scanning the collinear excitation beams (e.g. using galvano scan mirror, MEMS scan mirror, or fiber-scanning endoscope) and means for detecting the CRS signal from the sample (e.g. mouse or human). Using drive electronics the laser beams can be raster-scanned through the sample and an image is displayed on a computer screen.

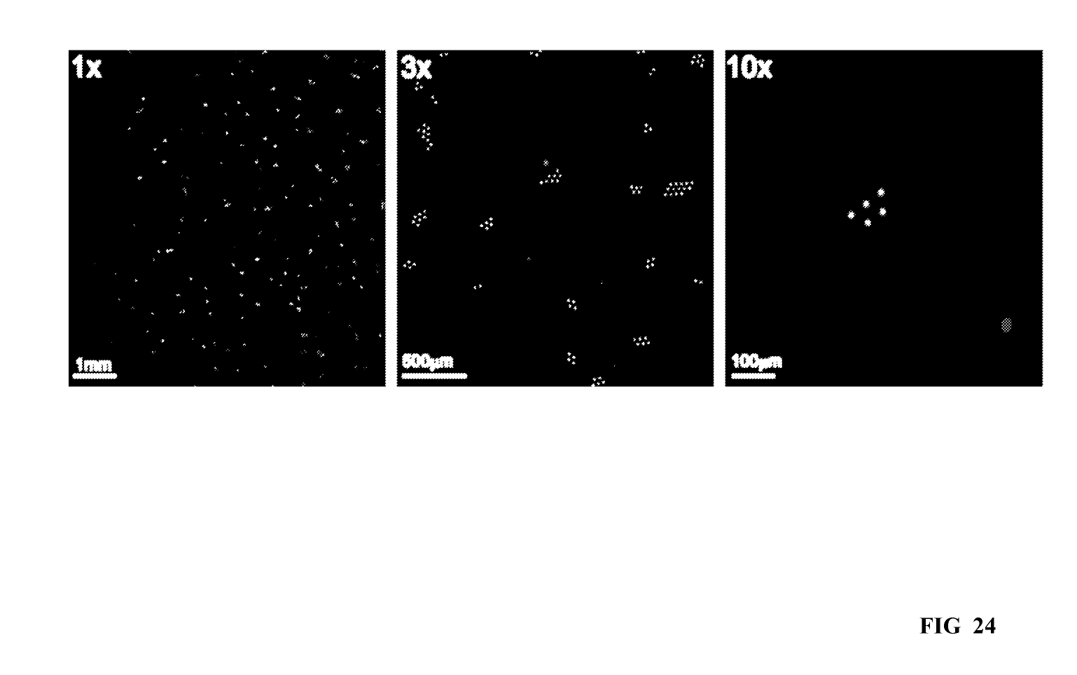

CRS microscopy was originally performed with a high numerical aperture (NA is typically 0.4 to 1.2) lens to achieve tight focusing with high peak powers for strong CRS signal. However high-NA lenses typically have a very limited field of view (FOV is typically 100-500 um) to achieve high resolution. However, CRS microscopy can be performed with a low NA lens to achieve a larger (FOV>1 mm). FIG. 24 shows our preliminary experimental images with a field of view of 7.5 mm×7.5 mm (Nikon, Plan Apo, 2×, 0.1NA). All three images (left, middle, right) were acquired with the same objective using a 1024×1024 raster scanning pattern, where the amplitude of the scanning pattern was varied from one image to the next. The S/N ratio of an image of 20-μm beads, acquired with moderate average excitation power at 1 frame per second is ˜10. The measured depth-of-field is ˜330 μm, which is of the same order-of-magnitude as the typical absorption and scattering mean free path of tissues (e.g. skin) and the phase-matching length in CARS.

Large FOV label-free imaging has multiple applications. In one example, it has clinical utility for pre-operative margin delineation of a non-melanoma skin cancer (NMSC), the most common cancer in the US with about 1.3 million cases per year. As most NMSC occurs in the head and neck (˜80%), tissue conserving surgery is required to avoid cosmetic or functional impairment and an ever increasing number of procedures are done with costly Mohs' surgery, in which stepwise excision is supplemented by frozen section histopathology. A pre-operative tumor margin delineation device can be used to allow dermatologists to perform excision as good or better than Mohs' surgery, reducing health care cost and discomfort to patients. In parts, FIG. 23 shows an example of a system based on CRS chemical imaging for pre-operative margin delineation. In another example, large-FOV high-speed chemical imaging with CRS can be used intra-operatively during tumor resection surgery (e.g. breast, prostate or brain cancer) to check the tumor cavity for residual tumor at the time of surgery. If residual tumor is identified and is safe to remove, it can be removed prior to the end of the surgery. This can improve surgery outcome and reduce the rate of costly repeat surgeries.

One approach to compensate for the lower power-density due to looser focusing is to scale the laser peak power by reducing the repetition rate. However, a challenge is to achieve the same duty factor as two-photon lasers but with ps rather than fs pulse width as required for CRS. FIG. 23 shows an example of such a laser system.

In some applications, CRS imaging is combined with other imaging techniques that are typically large-FOV and/or low-NA, such as optical coherent tomography (OCT). Multi-modal use can help to increase the accuracy. An example of such a system is shown in FIG. 23.

### Example 5

### Fiber-Sensing

In another example, a real-time detection system for improving the yield of needle biopsies of cancerous lesions is described. It has been recognized that diagnosis is increasingly performed with molecular diagnostic techniques that require biopsy specimens with a high fraction of malignant cells, and existing biopsy guidance techniques (such as ultrasound, MRI, PET, or CT) do not achieve the required accuracy. Additionally, exact knowledge of the biopsy site within a malignancy can provide an advantage in heterogeneous tumors. For example, specimens taken from the necrotic core of the tumor are often not diagnostic.

In breast cancer, ultrasonographically guided core needle biopsy is routinely used as a reliable alternative to surgical biopsy. It has an estimated repeat biopsy rate of 10% to acquire samples with malignant cell content high enough to perform meaningful histological analysis. Similarly, in brain cancer, the estimated diagnostic yield is 91%, and it was found that increasing the number of specimens, and thus, risk to the patient, results in a higher diagnostic yield. Molecular profiling techniques require a greater quantity of diagnostic tissue than traditional histologic analysis, and NCI predicts that the failure rate of acquiring highly malignant specimens is as high as 25-50%. There is an unmet need to provide better guidance toward highly malignant tissue, while minimizing risk to the patient. Improved biopsy guidance is applicable to most cancer biopsies but most urgent in breast, prostate and brain cancer.

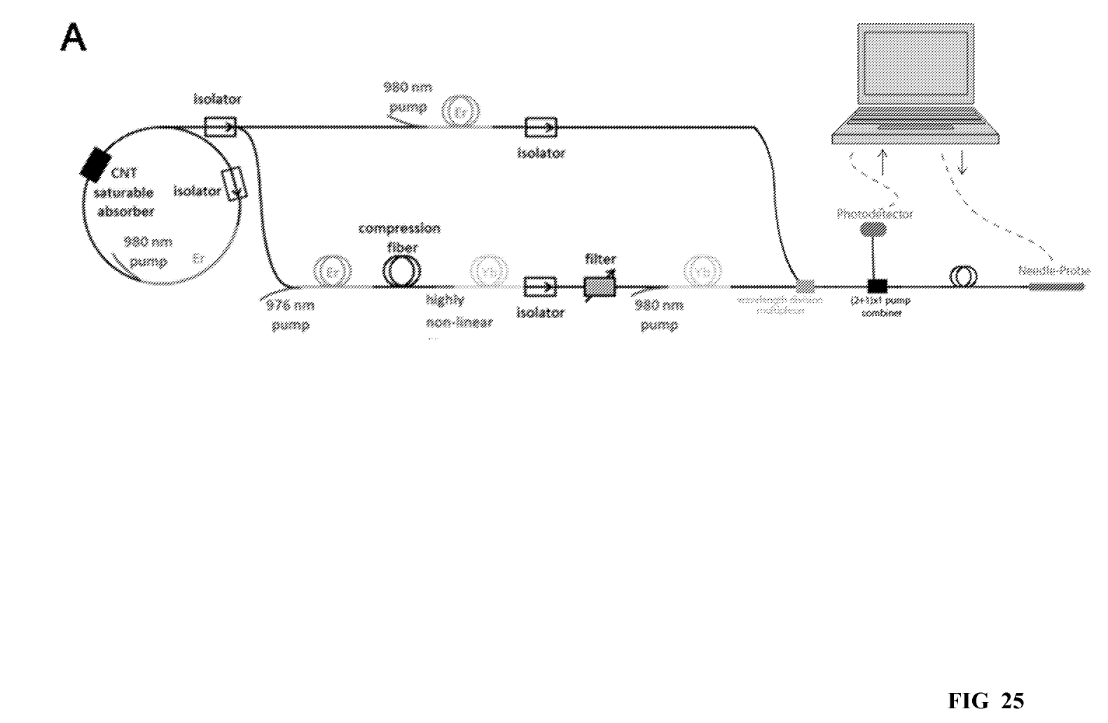

FIG. 25 shows a fiber-optic probe system for coherent Raman scattering (CRS) spectroscopy that can be inserted into a standard biopsy needle and provides a simple chemical measure of malignancy of the adjacent tissue in real-time. A major challenge for a clinical CRS system is a robust and low-cost laser system, as CRS requires two tightly synchronized ultra-short pulses at different wavelengths. In one example, the dual-wavelength laser platform uses optical synchronization of erbium- (Er-) and ytterbium- (Yb-) doped fiber amplifiers to access the high-wavenumber region of Raman spectra. In an exemplary setting, the Er output is broadband providing broadband Stokes pulses for CRS and the Yb out is narrowband providing narrowband pump pulse for CRS. This setting enables multiplex exaction of multiple Raman vibrations simultaneously. For example, emission spectra can be acquired with a 32-channel photomultiplier tube (PMT) array with a spectral coverage from 2850 cm⁻¹ to 3100 cm⁻¹, spectral resolution of 8 cm⁻¹ and acquisition rate of 100,000 spectra/s. In another example the Er output can be narrowband and is frequency doubled to provide narrowband pump pulses and the Yb output is broadband providing broadband pump pulses of multiplex CRS. In yet another example both Er and Yb outputs are narrowband and one of them may be quickly tunable to provide excitation spectroscopy.

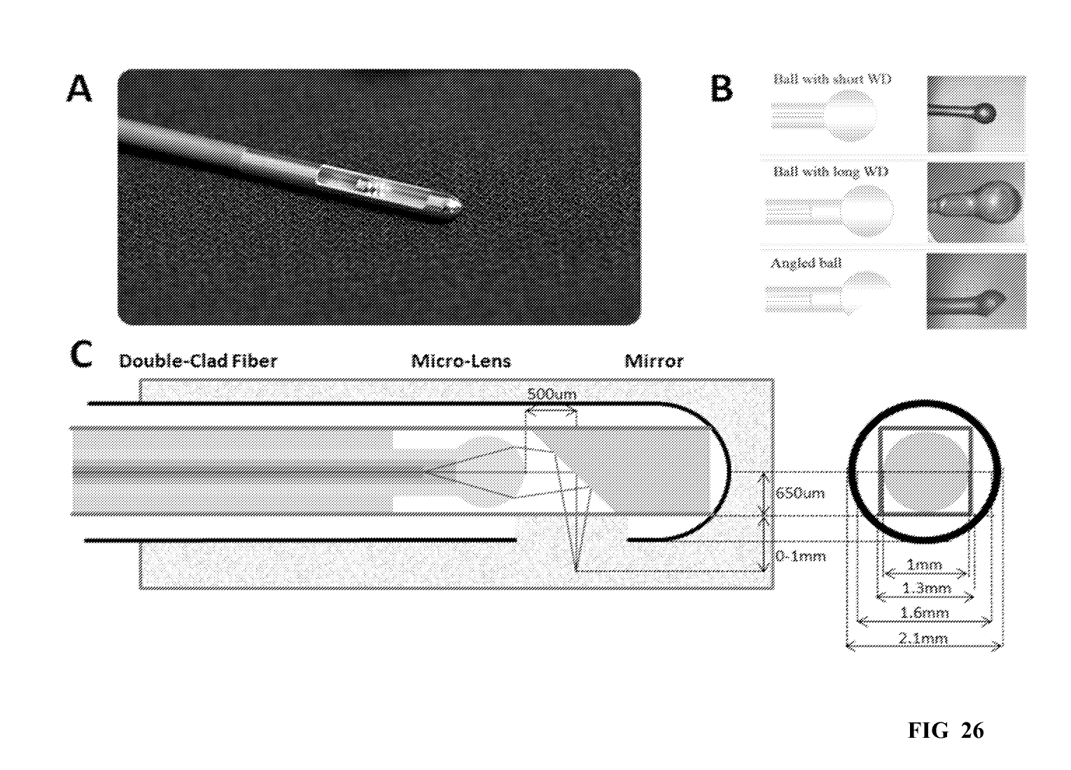

CRS microscopy is typically performed with a high magnification, high numerical aperture (NA) objective lens to achieve high peak power density for CRS signal. However, such high magnification objectives are typically very large. In an exemplary set-up, the system is used with a fiber-optic probe for sensing through a small biopsy needle (FIG. 26A). In the case of brain biopsies, gauge 14 needles with an inner diameter of 1.6 mm are typically used. This leaves limited room to position detectors inside the needle. Signal collection based on double-clad fibers' where the excitation light is propagated down the single-mode fiber core and the back-scattered emission is collected with the multimode inner cladding, can be implemented in a narrow space accommodating the biopsy uses. By choosing a large mode area (LMA) fiber and a large, high-NA inner cladding (such as Nufern PLMA-GDF-25/400 with 25 μm core diameter, 400 μm cladding, and 550 μm outer diameter), it is possible to minimize nonlinearities of the delivery fiber, such as spectral changes due to self-phase modulation or signal generation in the fiber, and maximize collection efficiency. In an example set-up, a (6+1)×1 pump-signal combiner is used in the reverse direction and help align the signal propagating in the inner cladding into the PMT-array spectrometer.

The focusing lens can be manufactured by melting the fiber tip into a ball-lens (FIG. 26B). Alternatively, a ball-lens, GRIN lens or micro-optic lens may be used. The size of the ball lens and thus the focusing properties can be controlled by the amount of fiber tip that is melted into the ball. For a given radius, working distance and numerical aperture can be controlled by adjusting the length of coreless fiber proximal to the ball lens, which allows the mode field to expand prior to entering the ball lens. A multimode fiber that is matched to the inner cladding of the double-clad fiber can be used and help allow signal collection at the interface of the ball-lens. This requires careful adjustment of the length of each of the fiber elements. A section of core-less or multi-mode fiber can be used for expanding a beam before a ball-lens, GRIN lens or micro-optic lens. The section of multi-mode fiber may be coupled to the inner cladding of a dual-clad fiber.

Different geometries can be used to implement side-viewing capabilities. A simple approach is to polish the fiber ball-lens at approximately 45°, such that total internal reflection redirects the excitation light to the side. In an example set-up, a forward viewing ball-lens and a 45° degree mirror (Edmund Optics, 47-628) are used to redirect it to the side (FIG. 26C). This approach allows adjustment of the working distance into the tissue by varying the distance from the fiber tip to the mirror. Once optimized, the distance can be fixed.

Aberrations are a concern, especially astigmatism if a rounded optical shield is used. In principle, compensation can be provided by changing the properties of the ball-lens. One can chose a geometry where the excitation fiber and the 45° mirror are held in place by a square glass tube (FD Glass, BST-1-15) that fits tightly into the needle probe (FIG. 26C).

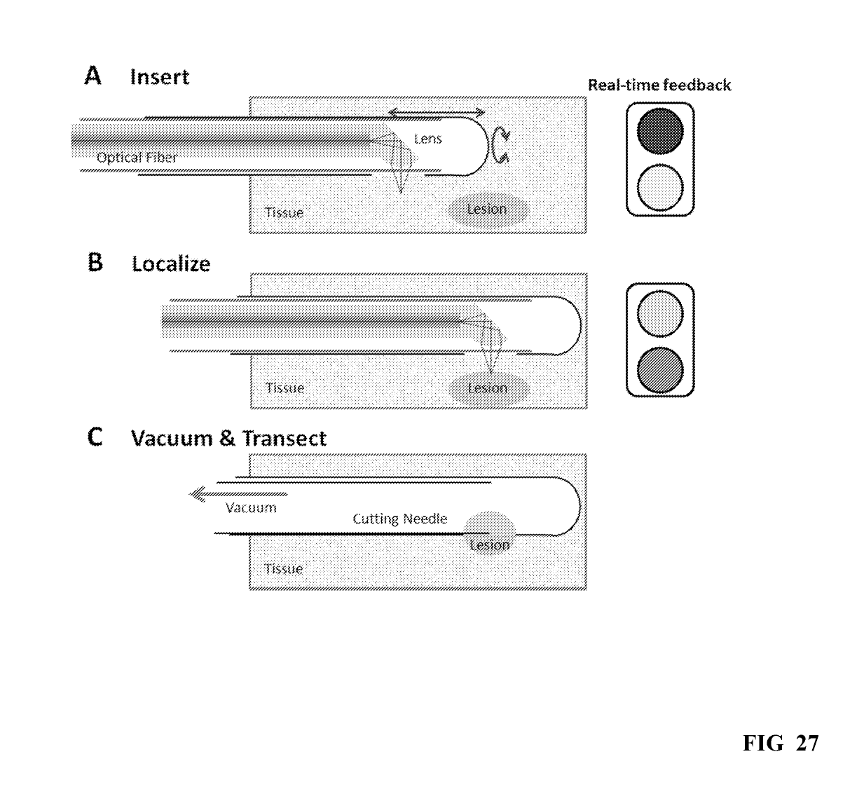

The typical clinical workflow of a frameless stereotactic brain biopsy is shown in FIG. 27. A trajectory stem is mounted to the skull and aligned based on a pre-operative MRI. A blunt biopsy needle is then inserted and directed to a pre-determined location. A syringe-induced vacuum is created to suck the tissue specimen into the transection aperture of the needle. This workflow can be modified by placing the side-looking fiber-optic CRS probe into the biopsy needle to provide the surgeon real-time feedback, alerting him when the transection aperture is within the lesion (FIGS. 27A-B). Once the needle is properly positioned, the fiber-optic probe is removed from the biopsy needle and vacuum-assisted transection can be performed as usual (FIG. 27C). This minor modification of the established workflow has the following advantages: (1) it avoids biopsy of uninvolved tissue, (2) reduces the number of repeat biopsies, and (3) enables advanced molecular diagnostics that require a substantial volume of the malignant tissue.

Other applications of the same or a similar fiber-probe outside biopsy guidance are also possible.

### Example 6

### CRS Imaging

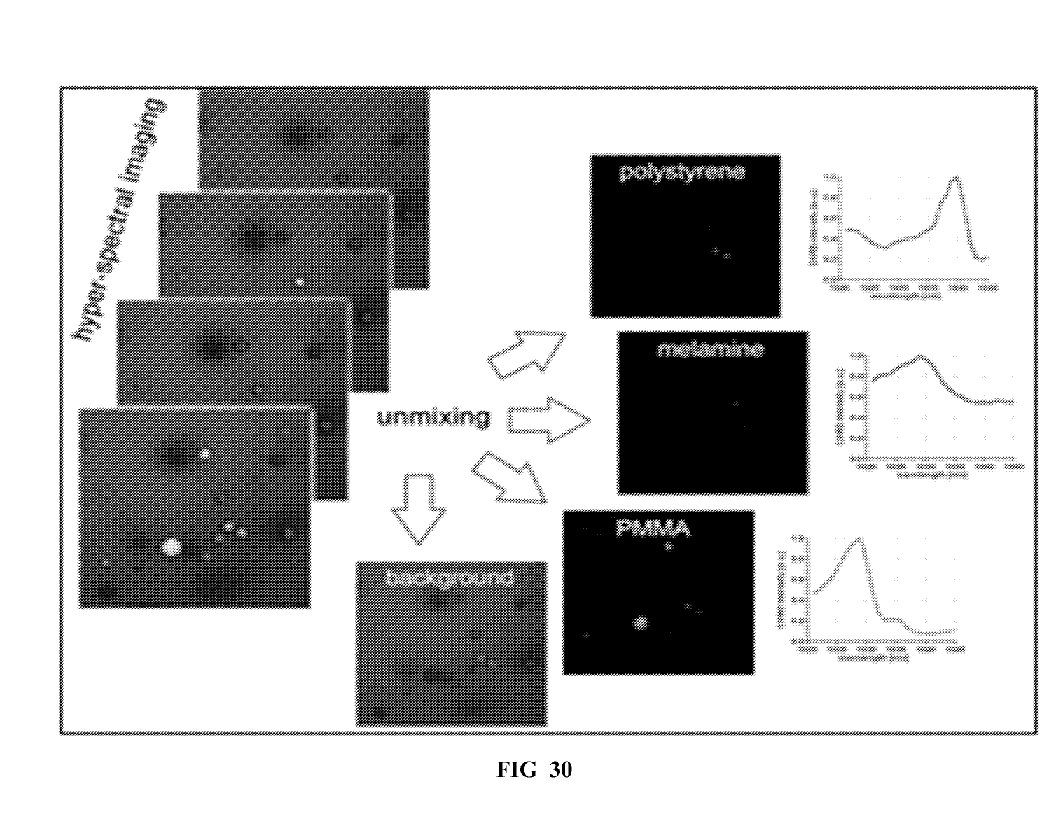

FIG. 30 shows an example of CARS spectroscopic imaging. Multi-spectral CARS images of a test sample consisting of polystyrene, melamine, and polymethyl methacrylate (PMMA) beads embedded in agarose gel were acquired in 1 nm (˜10 cm⁻¹) steps from 1021 nm (2880 cm⁻¹) to 1045 nm (3100 cm⁻¹). Each individual image was acquired at 1 frame/s with 500×500 sampling. Intensity of the non-resonant background in agarose gel was normalized to be identical in each image frame and spectral un-mixing was applied to separate different species based on their distinct CARS spectra. An xyλ image stack was acquired by tuning the laser in steps of 1 nm per image frame from 1021 nm to 1045 nm. Chemometric methods such as non-negative matrix factorization were used to unmix individual chemical species based on the distinct CARS point-spectra (FIG. 30).

What is claimed is:

1. A detection system comprising:
a fiber laser system configured to provide;
a first train of pulses at a laser repetition rate R₁ and having a first center optical frequency ω₁ and an optical bandwidth of Δω₁;
a second train of pulses at a laser repetition rate R₂ and having a second center optical frequency ω₂ and an optical bandwidth of Δω₂, wherein the second train of pulses is synchronized with the first train of pulses;
focusing optics configured to focus spectral elements from the first and the second trains of pulses toward at least one overlapping focal volume, wherein the at least one overlapping focal volume has at least two dimensions that are larger than 3 μm; and
a detector system configured to detect a non-linear optical signal from the at least one overlapping focal volume.

2. The detection system of claim 1, wherein the laser duty factor of the first and the second train of pulses is larger than 10,000, and at least one of Δω₁ and Δω₂ is smaller than 50 cm⁻¹.

3. The detection system of claim 1, wherein the non-linear optical signal comprises Coherent Raman Scattering (CRS), wherein the difference in frequency of a first spectral component within Δω₁ and a second spectral component within Δω₂ is resonant with a targeted vibrational frequency of a sample.

4-9. (canceled)

10. The detection system of claim 1, wherein the detector system comprises a detector array that is configured to detect signals from a plurality of vibration frequencies in the at least one overlapping focal volume.

11. The detection system of claim 1, wherein the ratio of the duration of pulses in the first and the second train of pulses is between 1-3.

12. The detection system of claim 1, wherein the second train of pulses is synchronized with the first train of pulses using optical synchronization, electronic feedback or feed forward synchronization.

13. The detection system of claim 1, wherein the first or the second trains of pulses is frequency shifted using a broadband supercontinuum (SC).

14. The detection system of claim 13, wherein the first or second train of pulses is amplified in a gain medium.

15. The detection system of claim 14, wherein the gain medium comprises an Erbium (Er)-, Ytterbium (Yb)-, Thulium (Tm)-, Holmium (Ho)-, or Neodymium (Nd)-doped medium.

16. The detection system of claim 2, further comprising an undoped fiber in a laser cavity of the laser fiber optics system such that the laser repetition rate of the laser cavity is reduced.

17. The detection system of claim 1, wherein the system is configured to broaden the first or the second train of pulses using self-phase modulation (SPM).

18. The detection system of claim 1, further comprising a flow system configured to generate a stream of particles through the at least one overlapping focal volume.

19-21. (canceled)

22. The detection system of claim 18, wherein the dimension of the at least one overlapping focal volume along the direction of the stream of particles is less than the dimensions that are perpendicular to the direction of the stream of particles.

23. The detection system of claim 1, wherein the detection system further comprises a scanner that is configured to spatially scan the at least one overlapping focal volume over a field of view larger than 500 μm.

24. The detection system of claim 1, wherein the focusing optics comprise a fiber-optic probe.

25. The detection system of claim 24, further comprising at least one of a ball-lens, a GRIN lens, or a micro-optic lens that is configured to focus a beam comprising the first or second train of pulses toward the at least one overlapping focal volume.

26. The detection system of claim 25, wherein the fiber-optic probe further comprises a section of core-less or multi-mode fiber that is configured to expand the beam comprising the first or second trains of pulses before the at least one of a ball-lens, GRIN lens or micro-optic lens.

27. The detection system of claim 24, wherein the fiber-optic probe further comprises a dual-clad fiber that is configured to deliver the first or the second trains of pulses through a fiber core and wherein the fiber-optic probe is configured to couple the non-linear optical signal into an inner cladding for delivery to the detector.

28. The detection system of claim 27, wherein the fiber-optic probe further comprises a section of core-less or multi-mode fiber for expanding the beam comprising the first or second trains of pulses before the at least one of a ball-lens, GRIN lens or micro-optic lens, and wherein the section of multi-mode fiber couples to the inner cladding of the dual-clad fiber.

29. The detection system of claim 24, further comprising a color filter in the fiber-optic probe, wherein the color filter is configured to reduce a background signal from the delivery fiber.
